(19) United States
(12) Patent Application Publication
(10) Pub. No.: US 2010/0037665 A1
(43) Pub. Date: Feb. 18, 2010

(54) SECURITY DEVICE FOR LOCK AND METHOD OF MANUFACTURE THEREOF

(76) Inventor: Wayne Lionel ACE-KIRKER, Hamilton (NZ)

Correspondence Address: YOUNG & THOMPSON, 209 Madison Street, Suite 500, Alexandria, VA, 22314, US

(21) Appl. No.: 12/604,956

(22) Filed: Oct. 23, 2009

Related U.S. Application Data
(62) Division of application No. 10/572,463, filed on Sep. 1, 2006.

(30) Foreign Application Priority Data
Sep. 19, 2003 (NZ) 528386
Sep. 24, 2003 (NZ) 528433
Dec. 23, 2003 (NZ) 530363
Jul. 8, 2004 (NZ) 534005
Jul. 8, 2004 (NZ) 534006
Sep. 20, 2004 (NZ) 535493
Sep. 20, 2004 (NZ) 535494
Sep. 20, 2004 (NZ) 535495

(51) Int. Cl. E05B 67/38; E05B 17/00; B22D 11/12

(52) U.S. Cl. 70/56; 70/431; 29/527.5

(57) ABSTRACT

A method of bracing a security container relative to the structural features of a building in a substantially tamper-proof manner wherein the security container including at least one container (2) having an interior (3) for storing valuables therein, the container (2) having at least one opening (7) thereinto, a closure (8) covering the at least one opening (7) into the container (2), and locking (16) to secure the closure (8) over the opening (7), the security container being configured to be fitted into a recess within a surface and the security container further including retention, the retention including bracing (30a), the bracing (30a) characterized by effecting a brace relative to one or more permanent structural features associated with the surface to impede forced removal of the security container from the recess.

### TECHNICAL FIELD

The present invention is directed to improvements in and relating to security means.

In particular, the invention relates to aspects of the features, manufacture and operation of the security means. The security means includes an adapted single pin locking system whether as either or both a single pin combination lock and a single pin key lock. The locking system is adapted for use in various applications of security means. In some embodiments, the security means includes a shackle locking system which can also be adapted to the use of a single pin option.

The security means as such has numerous applications, including security containers, such as safe-type devices for storing keys and valuables; container door latching systems as permanent and temporary options for trucks, trailers, shipping containers; vehicle key security and secured vehicle immobilising devices, vehicle anti-theft devices for application in association with the wheels of a vehicle, anti-theft devises for shipping containers, and improved security means as protectors or shields for standard shackles, pins and so forth of padlocks and similar locking apparata.

Whilst the invention is envisaged to have particular use in relation to the security applications described herein, it should be appreciated that this invention may have applications outside this field.

Accordingly, the security means includes its application with a security container able to be permanently fitted into a cavity within a surface of a building and be so fixed to impede its removal and thereby obviate problems of the security container being removed, or damaged, in unapproved attempts to access its contents.

It is envisaged the security container will be used to house building keys to allow entry to the building via approved individuals, such as the owner, service people, builders; or to hold vehicle keys to allow access to a vehicle by approved individuals and may be used by the owners of the vehicle, vehicle dealers, car rental businesses and repair providers. The approved individuals are provided with the means to open the security container and access the keys therein.

The security container includes an adapted single pin locking system whether as either or both a single pin combination lock and a single pin key lock which is enclosed within the container. The single pin combination lock option provides only coded and substantially tamper-proof access to the contents of the container. The coded access may only allow temporary access to the contents of the container for one individual, whilst another code may allow continual access to the contents of the container by other individuals. Access to the security container contents is therefore dictated by a code which is changeable.

The single pin combination lock option obviates the need to carry, cut or arrange access to separate keys for various individuals. The single pin key and combination lock option provides a means where a key may be used by one individual, but knowledge of the code enables the lock to still be opened by another individual, or should the key be lost. The single pin key option where the lock is housed within the security container obviates the need to remember a code, yet provides greater security to the container than would be available by simply having a padlock, with or without means to protect the double pins of the padlock from being tampered with.

Whilst the invention is envisaged to have particular application in relation to securing keys in the security container, it should be appreciated that this invention may be used in relation to containing any contents, valuable or otherwise, and be adapted for use where any permanently fitted security container system is required to be accessed by any varying number of individuals, but only as allowed.

Where the present invention is directed to improvements in and relating to permanent security means for latching apparatus, the invention relates to aspects of the manufacture and operation of an improved security locking system for container and/or truck door latches or handles.

The security means incorporates features to enable a locking means to be fitted into a substantially tamperproof receptacle fixedly positioned relative to the container or truck door latch. The receptacle is so fixed, and a portion of the latching apparatus of the truck/door latch and a portion of the locking means co-operate, to thereby obviate problems of the lock or latch being removed, opened, or damaged, in unapproved attempts to access the contents of the container or truck.

It is envisaged the locking means will include an adapted single pin locking system whether as either or both a single pin combination lock and a single pin key lock which is enclosed within the receptacle. The single pin lock option provides access to the contents of the container via approved individuals. The approved individuals are provided with the means to open the lock and gain access to the contents of the container.

Where the lock is a single pin key option individuals may only open the latching means on a container/truck door via use of the key. The receptacle enclosing the lock provides greater security to the container/door than would be available by simply having a padlock, with or without means to protect the double pins of the padlock from being tampered with.

The single pin combination lock option obviates the need to carry, cut or arrange access to separate keys for various individuals. Access to the container/truck contents is therefore dictated by opening the lock via a code which is changeable.

The single pin key and combination lock option alternatively provides a means where a key may be used by one individual, but knowledge of the code enables the lock to still be opened by another individual, or should the key be lost.

Whilst the invention is envisaged to have particular application in relation to securing means for the latching systems of containers, trucks and the like, it should be appreciated that this invention may be used in relation to securing the closure of any opening via use of this securing means. For example, this security mean for latching apparatus may be used or adapted for use with any type of door, latched gates or any other options where areas are required to be accessed by any varying number of individuals but only as allowed.

Where the present invention is directed to improvements in and relating to removable security means for latching apparatus, the invention relates to aspects of the manufacture and operation of an improved security locking system for use anywhere where there is at least two surfaces which come together for the purpose of operating as a fastening/latching means. In addition, the security means is removable, to enable it to be used in various locations only as required.

It is envisaged the present application will be adaptable for use with container and/or truck door latches or handles, for door or gate latches, for hasp and staple fastening means, for abutting plates through which a locking means may be secured, and so forth.

The security means is also envisaged to have application where a fastening or latching means may be secured by a pin, a bolt, or a padlock. In addition, it is envisaged the security means will also have application in securing seal means which are often used to monitor whether the contents of an enclosure have been accessed. If the seal has been tampered with it is implied the contents of the enclosure may have been accessed.

The security means incorporates features to enable locking means to be fitted within a substantially tamperproof receptacle positioned relative to the latching means. The security means is not permanently fitted either to the haulage container, truck, door, gate, surface or latch associated therewith. Rather, a locking pin of the lock co-operates with a portion of the latching apparatus of the truck/door/latch and the locking means, tamper seals and locking pin are enclosed within the security means, to thereby obviate problems of the lock, latch or seal being removed, opened, or damaged, in unauthorised attempts to access the contents of the container, truck, enclosure (including building, courtyard, farm, and so forth).

It is envisaged the locking means will include an adapted single pin locking system whether as either or both a single pin changeable combination lock and a single pin key lock which is enclosed within the receptacle. The single pin lock option provides access to the contents of the container/enclosure via approved individuals. The approved individuals are provided with the means to open the lock and gain access to the contents of the container/enclosure.

Where the lock is a single pin key option individuals may only open the latching means on a container/truck/enclosure entry via use of the key. The receptacle enclosing the lock provides greater security to the container/door/entry means than would be available by simply having a padlock, with or without means to protect the double pins of the padlock from being tampered with. The single pin lock may be either an adapted single pin padlock arrangement, or be a single pin through bolt system.

The single pin changeable combination lock option obviates the need to carry cut or arrange access to separate keys for various individuals. Access to the container/truck/enclosure contents is therefore dictated by opening the lock via a code which is changeable.

The combined single pin key and changeable combination lock option alternatively provides a means where a key may be used by one individual, but knowledge of the code enables the lock to still be opened by another individual, or should the key be lost.

Whilst the invention is envisaged to have particular application in relation to securing means for the latching systems of containers, trucks/enclosures and the like, it should be appreciated that this invention may be used in relation to securing the closure of any opening via use of this securing means.

For example, as previously alluded to, this security means for latching apparatus may be used with, or adapted for use with, any types of doors, latched gates, barriers or any other options where areas are required to be accessed by any varying number of individuals but only as allowed.

Where the present invention is directed to improvements in and relating to a security container, the invention relates to aspects of the manufacture and operation of an improved security container incorporating features to enable the security container to be permanently fitted to a vehicle, or the like and be so fixed to impede its removal and thereby obviate problems of the security container being removed, or damaged, in unapproved attempts to access its contents.

It is envisaged the security container will be used to house vehicle keys to allow access to the keys and thus the vehicle by specifically authorised or approved individuals, such as the owner, service people, a change of driver or, vehicle dealers, car rental businesses and repair providers. The approved individuals are provided with the means to open the security container and access the keys therein.

Accordingly, the security container includes a fixed single pin changeable combination lock. The single pin changeable combination lock provides only coded and substantially tamper-proof access to the contents of the container. The coded access may only allow temporary access to the contents of the container for one individual, whilst another code may allow continual access to the contents of the container by other individuals. Access to the security container contents is therefore dictated by a code which is changeable. The single pin changeable combination lock option obviates the need to carry, cut or arrange access to separate keys for various individuals.

Whilst the invention is envisaged to have particular application in relation to securing vehicle keys in the security container, it should be appreciated that this invention may be used, or be adapted for use, where any permanently fitted security container system is required to be accessed by any varying number of individuals, but only as allowed.

Where the present invention is directed to additional improvements in and relating to a vehicle security container, the invention relates to aspects of the manufacture and operation of an improved security where, to minimise the vehicle being broken into and started without the vehicle keys, the security container also includes provision for at least one of a vehicle immobiliser system/switch, an on-off battery switch, an alarm deactivator/activator switch. Where power sources are required to power the immobilizing or alarm systems the power may be provided by battery(s).

Accordingly, the security container includes a fixed single pin changeable combination lock. The single pin changeable combination lock provides only coded and substantially tamper-proof access to the contents of the container. The coded access may only allow temporary access to the contents of the container for one individual, whilst another code may allow continual access to the contents of the container by other individuals. Access to the security container contents is therefore dictated by a code which is changeable. The single pin changeable combination lock option obviates the need to carry, cut or arrange access to separate keys for various individuals.

Whilst the invention is envisaged to have particular application in relation to securing vehicle keys in the security container, it should be appreciated that this invention may be used, or be adapted for use, where any permanently fitted security container system is required to be accessed by any varying number of individuals, but only as allowed.

Where the present invention is directed to improvements in and relating to security means and in particular relates to aspects of features, the manufacture and operation of a padlock shank or shackle protector. The is invention is directed to impeding removal or damage to a padlock shackle and hence to impeding unapproved attempts to access the contents or area to which the padlock is serving to limit access by strengthening and protecting against the potential vulnerability of the shackle of padlocks and the like.

It is envisaged the security means will be applicable to any padlock. In particular it envisaged the security means will enhance security over the use of a standard padlock alone and enable the security of cheaper padlocks to be enhanced when the security means is employed.

Whilst the invention is herein described with reference to a padlock, it should be appreciated that this invention may be used, or be adapted for use with any shackle, pin, staple, scenario.

Where the present invention is directed to improvements in and relating to a single pin telescopic lock system, the invention is adapted for use with a vehicle to impede unauthorized personnel taking the vehicle. In some uses it may be applied to vehicles which are required to be detained and not released to the owner.

The security means is adapted to co-operate with the wheels of the vehicle, in particular—trailers—and may be adapted to fit either or both single or tandem wheel vehicles.

The security means is adapted to include locking apparatus. The locking apparatus may be a changeable combination padlock, or a keyed padlock system providing substantially tamper-proof access to effecting removal of the security means from the vehicle once fitted.

Whilst the invention is envisaged to have particular application in relation to securing vehicles, such as cars, bikes, trailers, trucks and so forth, it should be appreciated that this invention may be used, or be adapted for use, where any item is required to be secured against removal by unauthorized individuals or as required.

Where the present invention is directed to improvements in and relating to security means which is an adapted locking system, the locking system is particularly adapted for use with objects such as a cartage/shipping container to impede unauthorized removal of the container from wharves, railway yards, storage areas and so forth, in unapproved attempts to access its contents.

The security means may be adapted to fit relative to an access aperture located at an upper corner(s) of the container where lifting hooks are inserted to lift the container off a surface. By blocking the ability to lift the container, unauthorised access to the container and the contents thereof is limited.

The adapted locking system of the security means includes locking apparatus which may be a changeable combination padlock, or a keyed padlock system providing substantially tamper-proof access to effecting transportation of the container. Single pin locking systems may also be used with the invention.

Whilst the locking system of the present invention is envisaged to have particular application in relation to securing cartage containers, it should be appreciated that this invention may be used, or be adapted for use, where any containing system is required to be secured against removal by unauthorised individuals, such as safes, home security containers, trucks/trailers, enclosed areas (such as car yards, workshops) and so forth.

In addition, the invention may have applications outside these fields.

### BACKGROUND ART

As far as security containers are concerned, a range of security containers are available on the market. The generic safe is such an example. Typically such products include thickened, strong, durable enclosures, combination or key locks for access to the container, and may be fitted into walls, under floors and so forth. The deterrent nature of such safes lies in the difficulty of damaging the exterior surface of the safe, and/or in the complex combination or keyed mechanisms used to lock the safe that has to be overcome to illegally access the contents of the safe. However, unless the safe is extremely large, it is not uncommon for safes in their entirety to be stolen and the contents accessed by some means. Further, safes typically are used and designed for use in the interior of a building.

There are also a number of security containers available for use in housing smaller items, but which do not conform to the particulars of a safe. Such devices may be used within a building, a piece of furniture and such like to retain keys, jewellery, or small quantities of money. These devices may be attached to a surface via a number of means such as adhesive means, or be attached using screws or similar which may be accessible from either or both the exterior of the container and the container's interior. The deterrent nature of these types of security containers lies in their smaller size, their hidden placement and their attachment to a surface. They may also include some locking mechanism as a further deterrent.

However, such devices may typically protrude from the surface to which they are attached. This mode of attachment along with the small size of such devices means that it may not be difficult to prise the security container from the surface and/or damage it to gain access to the contents of the container.

The above discussion has related to the provision of a security container to house contents securely, but within a building. However, there are a number of instances where having access to the contents of a security container is not limited to situations once inside the building. One of the most common situations faced by occupants of a building is being able to arrange access to the building by selected individuals, yet without the security of the building being compromised.

One such example is the need to arrange access to the building by approved trades people, service providers, employees, family members, or visitors, when there is no-one in the building. A number of businesses rely on the use of swipe/security cards and/or the knowledge of an alarm code to deactivate an alarm. Others may use a simple key method which may also be in conjunction with the use of an alarm—the code of which is required to be known. Similar methods may be used for residences, where several family members have keys to the house and know the relevant alarm code.

The problem with these systems is that keys or cards get lost, employees leave, home owners sell their homes and within a very short time there is the potential for a large number of access keys/cards to be lost, or be retained by people who no longer have legitimate access to the building, yard and so forth, which threatens the security of any such building, property and its contents. Further, there is a cost involved not only in providing a large number of people with an access key or card, but also in replacing lost ones, maintaining a record of who has what access key/card and in changing locks or similar to maintain security of the building/property when it becomes apparent that security is compromised because of the number of access keys/cards which can not be found.

A very common alternative, particularly for residential properties is that there are a limited number of keys available for use, so a key is hidden outside of the building to enable access to the building by selected individuals. The problems with this method are at least that people tend to hide the key in predictable places, or someone may take the key away from its hiding place and forget to replace it. In the former instance the security of the building and its contents are compromised because those wanting to illegally enter the building may easily find the key. In the second situation there is no way of knowing who was the last person to use the key and who therefore has forgotten to put it back, or who has lost it.

Another situation is where there is a requirement for customers to have access to an item. For example in the motor industry there are several situations where an individual may need to access an area and/or access an item. Motor vehicle dealers, car rental providers, vehicle repairs and maintenance providers all face situations where cars are to be dropped off or picked up. Often the drop off or pick up is outside normal trading hours. Therefore, arrangements need to be made to have someone issue vehicle keys or collect vehicle keys. Boating or trailer maintenance or purchase is a similar situation. In any situation where access to an area to collect or drop off the vehicle is prevented outside of normal trading hours, the owner of the vehicle is limited to ensuring they are at the business when it is open, or employees may have to attend the site outside of work hours. Safes and existing lock boxes do not offer a flexible option to enable repeated use without potentially compromising the security of the clients', or the business' property.

Whilst devices such as safes and the security containers previously described are more advantageous means of securing keys and thereby limiting access to a building, nevertheless those system have the same disadvantages and are not readily adaptable for use on the exterior of a building.

For example, safes are quite cumbersome and are likely to require significant adaptation of an existing building, or inclusion of special means to accommodate a safe when fitted to a new building. The smaller security container attached to the outer surface of a building is an obvious structure and its attachment may not be strong enough to prevent its removal or damage to it.

Another system has therefore been used as a security container for accessing keys from outside a building. The system operates to provide access to building keys, but is only a temporary fixture and can be removed when the facility is not required. Typically the container includes a hook configuration or a means by which a portion of the overall device is able to co-operate with a part of a door/window jam. The pressure of the closed door/window retains the security container in place. A combination lock or pad is available to key in a code to open the container, or a separate key may be available.

The disadvantage of such a temporary system is that it alerts people to the fact that the building is empty.

While the present invention has a number of potentially realisable applications, it is in relation to problems associated with existing systems that the present invention was developed. More specifically, it was with the problems associated with the lack of a readily available alternative system for achieving access to a building or property by a range of unrelated individuals without having to supply a number of access keys, without having to hide the access key which potentially undermines the building's security, without the use of an obvious security container to house the building access keys, as well as a system that could be easily installed in existing and new buildings having a range of cladding materials, and could maintain the building's security when a particular individual no longer has approved access to the building by a change to a code, that the present invention was developed.

Having a simple system, capable of being easily installed would benefit those with pre-existing buildings. It would further benefit those wishing to install such a system as part of a new design. In addition, it would enable a security container to be fitted both internally and/or externally of a building, new or preexisting. However, at times it would be useful to have the ability to limit access to the security container when desired.

It would be useful therefore, to have a system for a security container that:
a) Could have the benefits of being permanently fitted to either or both the interior and exterior of a building as required; yet
b) Could be accommodated into existing or new exterior claddings of the building in a manner that was substantially less conspicuous than previous systems; and
c) Could enable access to retrieve the contents of the container—by separate individuals who have approval and instructions as to how to do so; and yet
d) As soon as access to access was no longer available to an individual the means of accessing the security container could be altered, yet access by approved individuals would be still available; and
e) Was relatively securely configured and securely installed to reduce the likelihood of successful attempts to force open the container and/or removal of the container;
f) Could be linked to a building's alarm system as a further deterrent against attempts to force open the container or remove the container.

It would therefore be advantageous to have an invention that offered at least some if not all of the advantages of the above proposed security container.

It is therefore an object of the present invention to consider the above problems and provide at least one solution which addresses a plurality of these problems.

Ideally the present invention will also provide a system which allows for a substantially trouble free installation system.

Ideally the system is suitable for use or is suitable to being adapted for use in situations where existing or new buildings, as well as providing a range of other possible locations not previously considered to be practical.

It is therefore a further object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

When one considers the security of transportation vehicles and looks to the transport and carrier industry, there are numerous ways that openings, such as doors, or areas where articles are stored, are latched closed.

The latching apparatus for cargo doors of cargo carrying vehicles and shipping containers usually includes a handle which cooperates with a configured latch that maintains the handle in a closed position whereby the doors to which they are attached also remain closed. To secure the cargo against theft or interference a locking system may be employed to prevent the handle being lifted and the door being opened. Additionally, a seal or the like may be included as a tamperproof alert means. It may be seen at a glance that damage to the seal indicates there has been an unapproved attempt to access the contents of the container. Prior art seal system have developed to costly options which are structurally strong, but if broken have to be replaced. Such seal systems may be employed in the vicinity of the locking/latching system, others at the point of pivoting of the latching handle, door, and so forth. Seals however, do little to actually prevent unauthorised access to the cargo. Sometimes, also, if the seal is damaged, the entire contents of the container or truck may be rejected, even though access to the contents may not have occurred.

Typically the locking means most commonly used include padlocks, or padlock and chain combinations. However, it is not difficult to cut through a padlock pin or a chain in order to gain access to the cargo.

To provide increased security for storage containers and the like, locking mechanisms may be adapted to limit the exposure of the lock. These are designed to minimise the likelihood of vandals or thieves being able to pry or break the lock open. Additional components of the locking mechanism—such as the handle of the door itself may also be encased within a protective framework to prohibit tampering of the various components of the locking mechanism.

The above discussion has related to the provision of a security means for cargo containers and the like. However, there are a number of instances where having a security means to limit access to authorised personnel alone would be beneficial. For example, access through gates on farms, or on residential, commercial, educational, recreational or industrial properties are other such situations. One of the most common situations faced by occupants/owners of a building or business premises is being able to arrange access to the building/premises by selected individuals, yet without the security of the building/premises being compromised. Having a substantially tamperproof security means for an associated latching system which allowed restricted access to a selected area by selected individuals may be substantially beneficial.

For example in the motor industry there are several situations where an individual may need to access an area and/or access an item. Motor vehicle dealers, car rental providers, vehicle repairs and maintenance providers all face situations where cars are to be dropped off or picked up. Often the drop off or pick up is outside normal trading hours. Therefore, arrangements need to be made to enable the vehicle to be secured in an area until it is collected or worked on. Boating or trailer maintenance or purchase is a similar situation. In any situation where access to an area to collect or drop off the vehicle is prevented outside of normal trading hours, the owner of the vehicle is limited to ensuring they are at the business when it is open, or employees may have to attend the site outside of work hours. Existing systems do not offer a flexible option to enable repeated use by a range of individuals without potentially compromising the security of the clients', or the business' property.

Deliveries of articles to businesses are also often undertaken outside normal trading hours. Such deliveries (or pick-ups) again require access to an area which is generally restricted at those times.

Other prior art systems include anti-theft plates which are bolted to the doors. These may be attached one to each door and lie adjacent to each other when the doors are closed. Each plate has a complementary aperture which can be aligned and through which a padlock shackle may be fed. The padlock thereby secures the two plates in a fixed/locked position, until the padlock is opened. This system whilst adding a level of security over and above a normal latching system, does little to protect the padlock or the plates from damage.

Yet another option available includes a hasp and staple arrangement. The hasp is in the form of a rigid bracket attached to one door, the staple is formed to include a back plate which is attached to the adjacent door. As the doors are closed, the hasp aperture receives the staple and a padlock is typically used to secure the hasp/staple system in a locked position. Again, this system whilst adding a level of security over and above a normal latching system, does little to protect the padlock or the hasp/staple bracket from damage.

The above discussion has related to the provision of a security means for cargo containers and the like. However, there are a number of instances where having a security means to limit access to authorised personnel alone would be beneficial. For example, access through gates on farms, or on residential, commercial, educational, recreational or industrial properties are other such situations. One of the most common situations faced by occupants/owners of a building or business premises is being able to arrange access to the building/premises by selected individuals, yet without the security of the building/premises being compromised. Having a substantially tamperproof security means for an associated latching system which allowed restricted access to a selected area by selected individuals may be substantially beneficial.

Having an opportunity to access the particular building or enclosure/yard to pick up or drop off a vehicle is typically not available, because of the security implications. Having a locking system for the latching means (of the doors or gates to the enclosure or building), which protected the latching means, yet was configured to include a locking means that enabled authorised individuals to open the lock (such as by having a changeable combination lock) would enable the security aspects to be maintained, yet also would provide flexibility for access to the enclosure as required.

While the present invention has a number of potentially realisable applications, it is in relation to problems associated with existing systems that the present invention was developed. More specifically, it was with the problems associated with:
a) the lack of a readily available alternative securing system for achieving security of an enclosed area which includes latching means, such as chains, hasp and staple systems, secured with pins, padlocks, or through bolts, to be operated to gain entry, yet
b) enabling access to that area, or the contents therein, by a range of unrelated individuals; and
c) otherwise having to supply a number of access keys, having to use locking systems that are vulnerable to being tampered with, or having to hide the access key which potentially undermines the area's security; and
d) being able to maintain the integrity of seal means which are used to demonstrate that the integrity of secure contents of an enclosed area has been maintained; and at the same time
e) obviating against the problem of nuisance seal tampering which may not accompany access to the enclosure contents, but does have a significant impact on the acceptability of the enclosure contents.

It was also with the problems of having existing systems that required an increasing number of parts, or labour intensive installation, in mind that the present invention was devised.

Having a simple system, capable of being easily installed would benefit those with preexisting latching systems requiring improved security means therefor. It would further benefit those wishing to install such a system as part of a container, truck, enclosure and so forth.

It would be useful therefore, to have a security means for latching apparatus that fulfilled the above requirements and, in addition:
a) Could enable access to the contents of the container, truck, enclosure, area and so forth, by separate individuals who have approval and instructions as to how to do so; and yet
b) If the security means for the latching apparatus includes a changeable combination lock then as soon as access was no longer to be made available to an individual the means of accessing the area, contents and so forth could be altered, yet access by approved individuals would be still available; and
c) Was relatively securely configured and securely installed to reduce the likelihood of successful attempts to force open the container and/or removal of property from an area;
d) Could be linked to an alarm system as a further deterrent against unapproved attempts to access the area; and yet,
e) Could be used only as required, without permanently fitting the security means to the truck, container or latching system; and
f) Protected seals as well as latching apparatus.
g) Could be used or adapted for use wherever two or more surfaces co-operate to provide a latching or fastening system to which pins, bolts, padlocks and the like are applied to secure the associated structure against unauthorised entry.

Ideally the present invention will also provide security means for a latching system which allows for substantially trouble free operation.

It would therefore be useful to have an invention that offered at least some if not all of the advantages of the above proposed security means for latching apparatus. It is therefore an object of the present invention to consider the above problems and provide at least one solution which addresses a plurality of these problems.

It is therefore a further object of the present invention to at least provide the public with a useful choice, or an alternative system.

In the vehicle industry there are several situations where an individual may need to access to a locked vehicle. Motor vehicle dealers, car rental providers, vehicle repairs and maintenance providers and long-haul transport companies all face situations where vehicles are to be dropped off, or picked up. Often the drop off or pick up is outside normal business hours. Therefore, arrangements need to be made to have someone issue vehicle keys or collect vehicle keys.

Where security containers for keys for vehicles are concerned there is a limited choice available in the prior art which may be fixed to a vehicle. There are even fewer available that are specifically designed to be affixed to the exterior of a vehicle and to allow access to the container to be limited to specifically authorised or approved individuals at predetermined times and places, without the need for those individuals to have to carry a key to gain access to the contents of the security container. Many existing lock boxes do not offer a flexible option to enable repeated use without potentially compromising the security of the vehicle at the level of the present invention.

A range of security containers are available on the market, some which it may be argued may be adapted for fixing to the exterior of a vehicle. However, their design, construction and operation may not be ideally suited for such use.

For example, New Zealand Patent No 220556 relates to a portable safe which is securable to a surface and which has a lid adapted to resist its removal by force. The safe is secured to a shaft through an aperture in the base of the safe using a securing nut attached to a portion of the shaft extending into the safe. This means of attachment may be suitable for a fixed surface, such as a floor or wall, but may not be an ideal attachment option for use with a vehicle where vibrations of the traveling vehicle may loosen the shaft/nut attachment. Further, the safe design does not provide a means whereby dirt or grime from the vehicle, or the road surface, is prevented from entering the locking mechanism or even the safe interior. In addition, the bulky configuration of the portable safe is not suited to a discrete attachment to a vehicle. It is not uncommon for security containers in their entirety to be stolen and the contents accessed by some means. Therefore, it is preferable, where the security container is designed to hold something of value, that it is a practical consideration to make the container as inconspicuous as possible, thereby contributing to the overall security concept.

U.S. Pat. Nos. 5,979,339 and 5,947,038, both relate to a lock box adapted for use with a vehicle's license plate. The lock box body is mounted to the vehicle. The lock box includes a door which is attached to the license plate. Thus, to access the box, the lock box door and the license plate together move to an opened position. The lock box also includes a locking structure.

However, the deterrent nature of security containers also lies in the difficulty of damaging the exterior surface of the lock box, and/or in the complex combination or keyed mechanisms used to lock the container that has to be overcome to illegally access the contents of the container.

Small security containers attached to the outer surface of a vehicle may be an obvious structure. Its attachment or the materials from which it is manufactured may not be strong enough to prevent its removal, or damage to it. The attachment and construction of the security container is therefore important.

The locking systems applied to security containers are also a crucial component to effecting the degree of security of the container and its contents Many systems rely on a keyed lock as the locking means for the security containers, such as U.S. Pat. Nos. 3,084,008 and 5,878,613. Others may rely on a padlock. Yet others may incorporate an electronic locking means, such as U.S. Pat. Nos. 5,778,805, 5,794,466 and 4,651,544 which include one or more keypads operable to provide a security code to a programmable electronic circuit to gain access to the contents of the security container.

The problem with keyed systems is that keys can get lost, or there is the potential for access keys to be retained by people who no longer have legitimate access to the container and its contents. Further, there is a cost involved in providing people with an access key and maintaining a record of who has an access key and in changing locks or similar to maintain security when it becomes apparent that security is compromised because of the number of access keys which can not be found.

In addition, if the idea of the security container is to house keys for access to a vehicle by approved individuals then the use of a key to access a key means that the individual who will be opening the container needs to be provided with a key. This begs the question of why not provide the individual with a set of the vehicle keys in the first instance.

Where electronic keyed systems are used externally of a vehicle, there are problems of preventing road dirt and grime from affecting the electronic components of such locking systems.

Where padlocks are used, there is the potential for the padlock to be damaged with a hacksaw and the like, and similarly for dirt to enter the padlock and interfere with the locking mechanism.

However, sometimes, irrespective of the security of the keys, the vehicles may still be stolen if they are able to be hot-wired. To reduce the likelihood of this situation arising, there is a need to further immobilise the vehicle. Systems typically designed for securing keys, do not further consider inclusion of an immobilising switch means for the vehicle as well. In addition, the inclusion of battery on-off systems for isolating vehicles such as ground-working equipment or boats, are often overlooked, as are motion detecting alarm activation/deactivation systems which all combine or may be used individually to prevent a vehicle being stolen.

While the present invention has a number of potentially realisable applications, it is in relation to problems associated with existing systems that the present invention was developed. More specifically, it was with the problems associated with the lack of a readily available alternative system for achieving access to vehicle keys by a range of unrelated individuals without having to supply a number of access keys, without having to hide the access key which potentially undermines the vehicle's security, without the use of an obvious security container to house the keys, as well as a system that could be easily installed and could also maintain vehicle security when a particular individual no longer has approved access to the vehicle, that the present invention was developed.

It would be useful therefore, to have a system for a vehicle security container that:
a) Could have the benefits of being permanently fitted to a vehicle as required; yet
b) Could be accommodated in a manner that was substantially inconspicuous; and
c) Could enable access to retrieve the contents of the container—by separate individuals who have approval and instructions as to how to do so; and yet
d) As soon as access to access was no longer available to an individual the means of accessing the security container could be altered, yet access by approved individuals would be still available; and
e) Was relatively securely configured and securely installed to reduce the likelihood of successful attempts to force open the container and/or to remove of the container; and
f) Could be linked to a vehicle's alarm system as a further deterrent against attempts to force open the container, or remove the container, or it could be activated in unauthorised attempts to tow or move the vehicle; and/or
g) Could include a vehicle immobilising system/switch to prevent the vehicle being hot-wired and driven away; and/or
h) Include a battery on-off isolating switch as a further deterrent.

It would therefore be advantageous to have an invention that offered at least some if not all of the advantages of the above proposed security container. It is therefore an object of the present invention to consider the above problems and provide at least one solution which addresses a plurality of these problems.

Ideally the present invention will also provide a system which allows for a substantially trouble free installation system.

It is therefore a farther object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

Where padlock security is concerned, padlocks are used and have been used for many years to secure a door, gate, lid, and so forth against unauthorized access. Principally, use of the padlock to afford security has been the focus. The security of the padlock itself to unwanted interference has focused on the use of thicker shackles, stronger metals, improved locking mechanisms and the like.

Padlocks are a detachable lock having a hinged or sliding shackle. The padlock operates to secure the access point against unauthorized entry by means of a portion of the shackle being fed through rings, chain links, staples and the like on the structure which is being secured by the padlock. The locking system of the padlock retains that same portion of the shackle of in a closed, secured orientation within the lock body when the padlock is locked. The shackle is released by operation of a key, combination and so forth. However, in use, a portion of the shackle adjacent the rings, chain links or staple, etc remains exposed. This provides a potential point of weakness of the padlock, depending on the strength of the metal from which the padlock shackle is made, the thickness of the shackle and so forth. It is with a range of padlocks, possible to cut through the shackle with bolt cutters, hacksaw blades and the like. Such weaknesses in the padlock in turn compromises the security of the contents of the are which the padlock is operating to limit access to.

Where padlocks are concerned there is a wide range available in the prior art providing varying degrees of security. Some manufacturers of padlocks have attempted to provide options to secure the shackle from interference by providing protective structures which are bolted to the surface prior to attachment of the padlock. The structures may include substantially U-shaped brackets, which accommodate the padlock as a whole and rely on the height of the sides to minimize access to the shackle. However, in some situations it is not feasible, nor appropriate, to attach a bracket as such to the surface. In addition, whilst the sides of the padlock shackle may be protected by the sides of the bracket, the shackle as a whole is still accessible within the bracket space.

Other systems may have a detachable cap, which may be attached to the padlock by a chain or the like. The cap is placed over the shackle after the padlock is locked. However, the cap is not necessarily affixed to the shackle or the lock body and as such may be prised off. If the chain attaching the cap to the padlock is cut, the cap may be lost and the protection no longer available.

Other attempts to protect the shackle from tampering may be to provide thicker shackles or shackles made of stronger metal. The most secure padlocks however, tend to also be the most expensive. Nevertheless, many existing alternative locking systems do not offer the flexibility that the use of a padlock offers.

While the present invention has a number of potentially realisable applications, it is in relation to problems associated with existing padlocks and alternative systems that the present invention was developed. More specifically, it was with the problems associated with the lack of a readily available alternative system for achieving security of an area without potentially undermining the use of a padlock as an easily installed security device, yet at the same time enhancing the security offered, that the present invention was developed.

It would be useful therefore, to have a security means that:
a) Could have the benefits of being retro-fitted to existing padlocks, or made available in conjunction with new padlocks as required; yet
b) Would not impact negatively on the ease of use of the padlock; and yet
c) Could enhance the security afforded by the padlock; and
d) Was relatively securely configured and securely installed to reduce the likelihood of successful attempts to either or both damage the security means to enable the padlock shackle to be forced open and/or damaged; and
e) Could increase the security offered by cheaper versions of a padlock, as a more cost effective option to buying very expensive padlocks.

It would therefore be advantageous to have an invention that offered at least some if not all of the advantages of the above proposed security means. It is therefore an object of the present invention to consider the above problems and provide at least one solution which addresses a plurality of these problems.

Ideally the present invention will also provide a system which allows for a substantially trouble free installation system.

It is therefore a further object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

A number of locking systems are available in the prior art to either secure a vehicle against theft or to prevent removal of a vehicle which has been detained. Such systems include steering wheel or wheel locks and braces. However, there are a number of disadvantages associated with the various prior art systems available. For example, often such systems can be extremely cumbersome and heavy. They are not typically designed for the average person to retain in the vehicle and to apply it to the vehicle as required. Such examples include wheel clams attached to the wheels of vehicles parked illegally, and requiring the owner of the vehicle to pay a fine before the vehicle can be released.

Other systems such as wheel braces for attaching to wheels, may have limitations in the locking mechanisms, which may be compromised by the used of bolt cutters or hacksaws. This is also the case with many versions of the steering wheel locking/bracing systems.

Yet other systems may include features, such as spikes designed to puncture and deflate the tyre if the vehicle is moved. Whilst this is a deterrent to stealing the vehicle, it is counterproductive to the owner of the vehicle, who would prefer the security of the vehicle to be maintained without damage being inflicted by the very apparatus the owner is using to protect the vehicle.

While the present invention has a number of potentially realisable applications, it is in relation to problems associated with existing systems that the present invention was developed. More specifically, it was with the problems associated with the lack of a readily available alternative system for effecting improved security for vehicles as a whole, as well as a system that could be easily installed, that the present invention was developed.

It would be useful therefore, to have security means providing a system for securing containers that:
a) Could have the benefits of being fitted to a vehicle as required; yet
b) Could be used with any appropriate single or tandem wheeled vehicles, including cars, trailers, bikes, trucks and the like, having wheels of varying diameters; yet
c) Included a locking system that provided a substantially tamperproof alternative to existing locking systems; and
d) Was a less cumbersome security means; and yet
e) Could include a locking system which enabled only authorised personnel to remove the security means.

It would therefore be advantageous to have an invention that offered at least some if not all of the advantages of the above proposed security container. It is therefore an object of the present invention to consider the above problems and provide at least one solution which addresses a plurality of these problems.

Ideally the present invention will also provide a system which allows for a substantially trouble free installation system.

It is therefore a further object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

A problem with any locking system used to secure and object or an area against unauthorized removal or entry, is the limitations of the locking system to tampering, damage and forced opening. Padlocks may often be used, but the shackles of the padlocks may be cut with bolt cutters or hacksaws, or the like. What this leads to therefore, is the use of heavier surrounding apparatus—such as is the case with safes—or various means to protect the locking system.

In the present application, the emphasis is on the use of an adapted locking system for use with cartage or shipping containers. However, as can be appreciated the application of the locking system extend beyond this exampled application.

Cartage or shipping containers play a significant role in the transportation of goods globally. It is a substantial problem where the containers are stolen from storage or freight-in locations. Not only is there a cost of the stolen contents of the containers, but also the loss of the container itself. Whilst a range of security means are available to minimise access to the contents of the container, or policing of the storage areas where containers are located is undertaken, these options are not necessarily effective in preventing removal of the entire container by well-organised individuals or groups of individuals.

While the present invention has a number of potentially realisable applications, it is in relation to problems associated with existing systems that the present invention was developed. More specifically, it was with the problems associated with the lack of a readily available alternative system for effecting improved security for containers as a whole, as well as a system that could be easily installed, that the present invention was developed.

It would be useful therefore, to have security means providing a system for securing containers that included a locking system which:
a) Could have the benefits of being fitted to any object, area entry point or container and as required during storage or transportation; yet
b) Could be removed when the object, area entry point or container is required to be accessed, or loaded on to transport vehicles; and
c) Could limit loss of a objects, such as a shipping container and its contents; and yet
d) Could include a locking system which enables only authorised personnel to remove the security means; and
e) Was relatively securely configured and securely installed to reduce the likelihood of successful attempts not only to remove the container, but to access the contents thereof, or of any enclosed area.

It would therefore be advantageous to have an invention that offered at least some if not all of the advantages of the above proposed security container. It is therefore an object of the present invention to consider the above problems and provide at least one solution which addresses a plurality of these problems.

Ideally the present invention will also provide a system which allows for a substantially trouble free installation system.

It is therefore a further object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

### DISCLOSURE OF INVENTION

A security container may be defined as container provided with a locking means for storing valuables. A security container is a precaution taken to ensure against theft of the articles contained within the security container.

Safes are one example of a security container which are particularly strong containers made of metal. However, there is a range of security containers of varying strengths, sizes and made from a wide selection of materials. The security container may be used in a number of applications for securely storing money, important documents, jewellery, keys, memorabilia and other things of value to the owner. Whilst many security containers are designed for use inside an building, the security container of the present invention is primarily designed for exterior use, but has the adaptability to be used in the interior of a building. Accordingly, the term security container used in this specification is directed to include the use of security containers both inside and externally of the building and should not be seen as limiting this specification.

Where such security containers are used outside, there is often a specific purpose more than generally storing valuables typically associated with security containers. For the purpose of describing the present invention the security container is a lock container for keys to provide access to the inside of the building or to provide access to an area to collect some property, or to provide a place to hold vehicle keys, such as in businesses involved in the motor industry. However, other articles, such as money may also be placed in the security container.

In such circumstances as described above and as also explained in the previous background art section, it may be necessary for an individual to have access to the building at a time when the building is otherwise unoccupied. This may occur in residential buildings where trades people require access to do work to the property, where real estate agents require access to show potential buyers the property, where family members such as children or visitors need access when others have not yet arrived home. In commercial or industrial buildings some of the same situations may arise as suggested above, but general access by specific employees or management at a particular time may also be facilitated by the provision of a key within the security container as presented by this invention.

Alternatively, keys for sheds, garages, vehicles and so forth may also be safely retained in the security container to provide access to them as required by the relevant individual.

Further, payment for tradesmen, goods' suppliers and so forth may also be placed in to the security container for collection by the relevant individual.

While the present invention has a number of potentially realisable applications, it is in relation to problems associated with existing systems that the present invention was developed. More specifically, it was with the problems associated with the lack of a readily available alternative system for achieving a system that could be permanently fitted, would be substantially tamper-proof (particularly when compared to other systems which may be damaged to gain entry or be removed completely), that allowed entry to the security container by specific individuals only to enable them to access the contents specific to their requirement, which limited that access only to a particular period after which they could not gain entry, that the present invention was developed.

Having a simple system, capable of being easily installed would benefit those with pre-existing buildings, or those effecting alterations to the building, or the like. It would further benefit those wishing to install such a system as part of a new building. In addition, it would enable a security container to be fitted permanently within the exterior structure of buildings having different types of cladding. However, at times it would be useful to have the ability to have access to the security container from the inside of the building, or have a separate security container for use internally, or even a double-entry security container that allowed access to the contents of the security container from both the interior and exterior of the building if, or as required.

Alternative security containers are available which may be attached to the exterior of a building. In some of these systems the security container may protrude some distance from the external face of the building. Other systems may imbed the security container into the exterior wall of the building. The security containers may be attached via the use of screws to the building exterior via the use of external flanges on the security container and thereby be accessible, or be hidden by being within the container and inaccessible. A security container if imbedded into the exterior wall may be attached—via screws or similar—to the wall's structural features such as to the horizontal dwangs/nogs, or to the vertical studs of a wooden framed building, or into adjacent bricks or bricks of the interior wall in brick or stone buildings of a single or double-sleeved brick construction. In an attempt to improve security any exposed screws may be adapted to be removed only with a specific tool.

Whilst such devices may be relatively easy to install, nevertheless these systems have their disadvantages as both types are afforded minimal protection against the use of a pry bar, screwdriver, or similar, that could apply leverage to prise the container off, or out of the external surface of the building. Such leverage force may strip the screws of their thread, bend them and cause them to break, or may damage the integrity of the security container itself allowing it to be opened or removed.

Whilst designed to be a somewhat permanent fixture, the design limitations of these various prior art devices, do not in effect afford optimum security, nor do they provided for an effective, permanent, substantially tamper-proof security container for use on the exterior of buildings.

Therefore, additional means for securely affixing the security container permanently and in an improved substantially tamper-proof manner, is desirable. It is with the above mentioned problems of prior art systems that the present invention has been designed.

According to one aspect of the present invention there is provided a security container, said security container including at least one container means having an interior for storing valuables therein, said container means having at least one opening thereinto, a closure means covering said at least one opening into the container means, and locking means to secure the closure means over the opening, said security container being configured to be fitted into a recess within a surface and the security container further including retention means, said retention means including bracing means, said bracing means characterised by effecting a brace relative to one or more permanent structural features associated with the surface to impede forced removal of the security container from said recess.

According to another aspect of the present invention there is provided a security container substantially as described above wherein the at least one container means includes two opposed and spaced apart parallel planar surfaces for defining a top and a bottom surface, at least two permanent surfaces substantially at right angles to the top and bottom surfaces forming the enclosing sides of the container means, and at least one exposed surface comprising an opening and being configured to provide access to the interior of the container means.

According to another aspect of the present invention there is provided a security container substantially as described above wherein the at least one container means includes a substantially cylindrical body forming the enclosing sides of the container means, and at least one exposed surface comprising an opening and being configured to provide access to the interior of the container means.

According to another aspect of the present invention there is provided a security container substantially as described above wherein the valuables include keys, money, access codes and so forth.

According to another aspect of the present invention there is provided a security container substantially as described above wherein more than one opening with its associated closure means is provided to enable access to the contents of the security container from either or both the exterior and the interior of a building.

According to another aspect of the present invention there is provided a security container substantially as described above wherein access to the contents of the security container from both the exterior and the interior of a building is restrictable via the inclusion of a dividing wall within the container means to effect substantially isolated interiors for storing valuables therein and accessible only via the relevant opening.

According to another aspect of the present invention there is provided a security container substantially as described above wherein the closure means is configured to engage with the edges of the container means adjacent to the opening, said closure means capable of operating between an opened and a closed orientation.

According to another aspect of the present invention there is provided a security container substantially as described above wherein the locking means used to secure the closure means over the opening includes a single pin lock.

According to another aspect of the present invention there is provided a security container substantially as described above wherein the single pin lock is either or both a single pin combination lock and a single pin key lock.

According to another aspect of the present invention there is provided a security container substantially as described above wherein the locking means is enclosed in the container, or compartment therein.

According to another aspect of the present invention there is provided a single pin lock wherein the single pin lock is either or both a single pin combination lock and a single pin key lock.

According to another aspect of the present invention there is provided a single pin lock wherein the single pin lock is adapted for use with the container by being enclosed in the container or compartment therein.

According to another aspect of the present invention there is provided a single pin lock wherein the single pin lock is adapted for use as locking means for other closure systems whether enclosed in a container, compartment, or not.

According to another aspect of the present invention there is provided a security container substantially as described above wherein the combination of the single pin combination lock is selectable and changeable to enable access to the interior of the container means and the valuables therein, only by selected individuals for a preferred time duration.

According to another aspect of the present invention there is provided a security container substantially as described above wherein the retention means, also includes fixing means, such as screws, bolts, nails.

According to another aspect of the present invention there is provided a security container substantially as described above wherein the bracing means is optionally moveable. According to another aspect of the present invention there is provided a security container substantially as described above wherein the bracing means operates between a storage position to enable insertion of the security container into the recess, and a bracing position after insertion of the security container into the recess for effecting a brace against one or more permanent structural features associated with the surface.

According to another aspect of the present invention there is provided a security container substantially as described above wherein the bracing means cooperates with at least one or more of a member of the building frame, at least a portion of the building cladding, or specifically installed engaging members, to impede forced removal of the installed security container from said recess.

According to another aspect of the present invention there is provided a security container substantially as described above wherein when said security container is fitted into a recess within a surface, a minimal portion of the security container extends from the surface.

According to another aspect of the present invention, there is provided a security container substantially as described above, wherein the security container is configured to complement the features of the surface.

Whilst the present invention is described herein with particular reference to the features and use of an external substantially tamper-proof security container for keys and the like, it should be appreciated that the invention may also be applicable to and/or be adapted for use in other situations where items are required to be made available only to certain people at certain times, or security of valuables for particular periods is desirable in particular circumstances such as when property owners are absent from a property.

In one preferred embodiment of the present invention, the security container includes at least one container means having an interior for storing valuables therein. Preferably, the security container is configured to be installed into an exterior of a building and used for the temporary storage of the valuables. For example, the valuables may be house or garage keys that may be placed inside the container of the security container. Various circumstances may predicate the storage of the keys in this manner. A range of such situations with be readily appreciated. However, a few situations used for the purposes of examples only include:
a) House keys for use by family members, such as children, who return to the home before an adult might and require keys to access the house after school, or some other situation. It is often not desirable to provide children with copies of the house key on the off-chance the key may be lost. It is also not desirable for the purposes of house security to hide the key around the property, as people skilled in breaking into homes generally have a reasonable grasp of the usual hiding places for house keys and the like.
b) Building keys for employees, or friends and so forth that may require access to a building on a specific day, but are not available to collect, nor have a set of keys to enable access when the building is locked.
c) Real estate agents who may be showing the property to prospective buyers. Rather than permanently providing a complete set of keys to the agent which the agent may use at any time to access the property, the property owner may prefer to restrict access only on certain days and at certain times. The present invention allows for a greater degree of control over access to the building.
d) Trades people who may need access at a prearranged time to complete work contracted to be done—whether by the property owner for an existing building; or by a supervising builder for a building being constructed, who may employ a number of sub-contractors; or providing keys to a meter reader where meters are inside a building.
e) To provide payments to trades people or the like, such as gardeners, rubbish collectors and so forth who may attend the property at regular intervals and have an arrangement to collect payment for their services on the day.
f) Use of the container to secure keys used in the motor industry, such as for car rental companies, car sales or car repair and maintenance businesses, and so forth as previously discussed.

As can be appreciated the situations in which the security container may be used and the range of valuables it may be used for, are many and varied. Further, whilst the use of the invention has been described with reference to accessing the contents of the security container externally of the building, it should also be appreciated that variations to the invention would enable the contents of the container to be also accessible from the interior of the building.

In some embodiments, the security container may have two openings, one on the exterior of the building, one on the interior of the building, with the contents of the container being accessible through either opening.

Alternatively, the configuration of the security container may be such that the container is divided so that two (or more) permanent, but separate interior compartments are created—one being accessible from the interior of the building, the other to be accessible from the exterior of the building. Another embodiment may provide for two or more separate compartments to be accessible from only the exterior (or alternatively, the interior) of the building. Such an embodiment may be useful where house keys are to be made available on a daily basis to family and are therefore held in one compartment, whilst periodic access to the contents of the security container may be satisfied by use of the second compartment. Each compartment would have its own access.

Yet another alternative embodiment may preferably include a moveable interior divider, such as a sliding hatch, which effectively divides the security container into two separate interior compartments. The interior divider may be unlatched to enable ready sliding or opening of the hatch to access the contents from either compartment of the security container, or may be latched so that the contents of each compartment are only accessible by unlatching the moveable interior divider.

Another option would include the use of two separate security containers mounted in a wall cavity back-to-back, with each separately accessible from the relevant side of the wall.

In preferred embodiments the container means of the security container is substantially a compartment created by and/or including two opposed and spaced apart parallel planar surfaces for defining a top and a bottom surface, at least two permanent surfaces substantially at right angles to the top and bottom surfaces forming the enclosing sides of the container means, and at least one exposed surface comprising an opening and being configured to provide access to the interior of the container means.

As can be appreciated the dimensions of the container means is variable, but preferably dictated by the preferred placement of the security container in use.

Whilst the container means of preferred embodiments is substantially a square or rectangular compartment, it should also be appreciated that the container means may take other configurations, including a substantially cylindrical body forming the enclosing sides, top and bottom of the container means, and at least one exposed surface comprising an opening and being configured to provide access to the interior of the container means.

The configuration of the container means is preferably dictated by the surface structure into which the security container is installed. Preferably, it is desirable that the security container be as inconspicuous as possible, or be aesthetically compatible with the surface.

In preferred embodiments the security container is configured to be fitted into a recess within a surface. Where the security container is to be accessible from the exterior of a building or the like, the recess is created within the external structure of the building. For buildings under construction, the dimensions of the recess can be such as to accommodate the security container.

However, preferably, the security container is configured to be fitted into new and existing building by creating a recess equivalent to the height dimensions of the exterior cladding and the depth dimensions of the building's structural walls. For example, the security container may be the dimensions of a standard brick and be installed into the building's exterior by removal of a brick from the wall of the building, which is replaced by the security container in a snug fit. Where the exterior cladding is comprised of wooden or artificial weather boards, the security container may be the dimensions of height of the weatherboard and be installed into the building's exterior by cutting out a piece of weatherboard to the required dimensions and installing the security container into the recess created.

To more particularly ensure the security container complements the features of the surface into which the security container is installed, the external configuration of the security container may be designed to reflect the features of the surface. As mentioned previously, the container may take the dimensions of a standard brick, or the height of a piece of weatherboard and so forth. Alternatively, for example, the structural shape of the exterior features may be made to actually look like a brick, a piece of weatherboard, a stucco surface effect, or whatever may be required. Whilst the cost of physically configuring the external surfaces of the security container is an option, a cheaper alternative may be the use of painted features which mimic the surrounding surface features in terms of pattern, colour, finish, effect.

In preferred embodiments, when the security container is fitted into a recess within a surface, a minimal portion of the security container may extend from the surface. This feature is designed to accommodate the locking/access means of the security container. The locking/access means shall be described later. Alternatively, in other embodiments, the security container may be installed in to the recess in such a manner as to be flush with the surface level.

Preferably, the security container is retained in position within the recess by retention means. The retention means in preferred embodiments includes at least one bracing means. The bracing means may be moveable. The bracing means is characterised by effecting a brace relative to one or more permanent structural features associated with the surface to impede forced removal of the security container from said recess. The retention means, may also include additional fixing means in the form of screws, bolts, nails and the like.

In preferred embodiments of the present invention the bracing mans may be attached to one or more of the sides, top, rear or bottom surfaces of the security container means.

Further, the bracing means preferably operates between a storage position to enable insertion of the security container into the recess; and a bracing position following insertion of the security container into the recess for effecting a brace against one or more permanent structural features associated with the surface.

The bracing means also preferably includes at least one of:
a) a pivoting tyne; and/or
b) an laterally moving tyne; and/or
c) a telescopically extendable tyne; and/or
d) an expandable tyne and/or
e) a plate means.

Whilst the above options have been listed it should be appreciated that the list is not definitive and other variations to the bracing means that may be available in the prior art, or may be adapted for use with the present invention, are also included.

To further describe the operation of the bracing means, each option will be discussed in turn.

In preferred embodiments which may incorporate a pivoting tyne arrangement, the tyne may be attached to any external surface of the container means in such a manner that on insertion of the security container into the recess, the tyne lies substantially adjacent and parallel to the surface to which it is affixed. The dimensions of the tyne may be longer than, shorter than, or the same length as, the surface to which it is attached, depending on the type, dimensions, and location of the structural features of the building it is required to co-operate with. When the security container is positioned within the recess, the tyne is pivoted clockwise or anti-clockwise, through an arc of up to 90 degrees, such that the distal ends of the tyne extend beyond the surface of the container means to which it is attached. The degree of pivoting required is dependent on the structural features surrounding the security container.

For example, the wooden framing of houses includes horizontal nogs or dwangs, along with vertical studs. Brick, iron or stucco cladding similarly may provide sufficient gap to enable the tynes to brace against such structural features of the buildings. The bracing tynes are designed to slide behind such structures and brace against these structures to impeded removal of the security container from the recess, when the container is locked.

With the laterally moving and/or telescopically extendable tyne options, the tynes are pushed, slid, ratcheted, screwed open, or similar, from an installing position where the tynes do not extend from the surfaces of the container means, to an installed, retaining position where the tynes do extend from the container surfaces. To example an expandable tyne option, the tynes are closed in on themselves in the manner of an umbrella and after installation of the container in the recess, a central shaft is pushed or screwed to effect opening of the tynes which engaged with potentially multiple surfaces to effect the required brace. For an laterally moving tyne, there may be provision to drill holes in adjacent bricks or wooden framing into which a sliding bolt-type tyne may be inserted and locked in place. Telescopic tynes may have value where there is limited free space to effect operation of pivoting tynes.

In addition, gripping means may be included at either or both the distal ends of any of the tynes as required to effect a more secure attachment of the security container within the recess. An example of such gripping means may be serrated edges which bind in to wooden framing. Angular distal ends, or threaded screw-type, or bayonet-type configurations at the ends of the tynes may further be used.

Pivoting or extension of the tynes may be controlled from within the container means and such control is preferably only available when the security container is open. The security of the retention may require that the tynes may only be operated via the use of a special attachment which is removable after the security container is installed; or alternatively, a less security conscious option may include the use of tool such as a screw driver, allen key or the like. Yet another option may include the use of a permanent handle or protrusion inside the container which may be gripped by the fingers and operated as required to move the tynes into position.

The plate means is preferably a contoured plate attached to one external face of a wall of the container. The plate means may be used in conjunction with any of the above other bracing means options. However, more particularly, the plate bracing means is configured for use with existing buildings having wood cladding or the like.

The plate bracing means is substantially angled as a right angled plate bracing means. One portion of the right angled plate is configured to co-operate with the means for attaching the plate to the container. Accordingly, at least one aperture is included in the plate through which a shaft of a bolt may pass. The threaded end of the bolt is located inside the container and a wing nut is used to tighten the plate against movement relative to the container.

The opposite portion of the right angled plate is contoured to include a raised portion. Included in the raised portion is at least one aperture to enable the shaft of retaining means such as an anchor pin to pass through the plate aperture. The bracing plate is also configured to include gripping anchor portions on the face of the plate adjacent to the structural framework on which the bracing means is positioned. The bracing plate also may include sections which when hit by a hammer or the like enables the gripping anchor portions and/or the anchor pins to be driven into the framework (of the wall) against which it is sitting. The gripping anchor portions bind into the structural framework and negate the ability for free movement of the plate and the container to which it is attached.

The anchor pin may be any suitable pinning or retaining means. However the attachment of the bracing means to the container and to the framework of the building provides a brace against attempts to pry the container out of the wall.

Preferably, the bracing means co-operates with the building frame, or portions of the building cladding, to impede forced removal of the installed security container from said recess. In some instances there may be a need to drill or cut grooves or channels into the framing and such like to receive the tynes of that version of the bracing means. Alternatively, engaging members may be specifically installed to ensure there are appropriate bracing surfaces available. This may be a preferred option where the structural frameworks of the building does not provide adequate or enough, or available bracing surfaces. It is such a bracing feature that serves to provide improved retention of the security container in the recess, over prior art security container systems.

In various preferred embodiments of the present invention however, the retention means may also include fixing means, such as screws, bolts, nails, such as are used in the prior art. Provision may be made for the surfaces of the container means to include apertures through which such additional fixing means can threaded and secured into adjacent structural features, such as the wooden framing members of the building, or adjacent bricks, and the like. To rely on such fixing means alone however, may compromise the security of the container and attempts to pry the container from the recess may result in damage to, or weakening of, these types of fixing means, or, in a worse case scenario, may cause them to break and release the security container from the recess.

The present invention is designed to provide a permanently fitted, substantially tamper-proof, security container, primarily for storing valuables such as keys, externally of a building, and which is accessible only by selected individuals. The use of the security container is however, as previously discussed, not limited solely to external use. Sets of house keys, or other valuables may be stored in an internal security container, to prevent access to those valuables by intruders, or the like.

Once the container means is installed into the recess, the opening(s) of the security container is preferably closed by the use of closure means. The closure means is a cover/door which is operable to be opened and closed as required to access the contents of the security container.

The closure means is configured to engage with the exposed front edges of the container means adjacent to the opening. Preferably, the closure means is a sliding door. The door is configured to be substantially planar and include around at least two of its sides a U-shaped bend into which a portion of the exposed edges of the container means slides. The front leading end of the door (as it is closing the opening) is substantially flat, but slides into a U-shaped track created by a portion of a side wall of the container means. The fit of the door relative to the container means is substantially tight enough to allow the door to slide opened and closed, but allows little leeway for a tool or pry bar to pry the doors from the container means.

Whilst hinged door systems, or other closure systems are not discussed in details herein, it should be appreciated that other means for securing and operating a door of the security container may be used, or adapted for use, with the invention. However, the emphasis is at all times on creating a substantially tamper-proof system. Hence, the need is to ensure the door fits snugly and tightly and can not be removed by simply interfering with hinges or the like.

To further secure the security container in a closed mode the security container includes locking means. The locking means is used to secure the closure means over the opening and prevent access to the contents of the security container.

In preferred embodiments of the present invention, the locking means includes a single pin lock and more preferably a single pin combination lock. However, this does not prevent the use of a single pin key lock, or a combined single pin key and combination lock. For the purpose of this specification the term “pin” is used to describe any rod of substantially strong material which operates potentially as a key in a lock system. The pin is a locking pin which is accordingly slid into the lock body where it engages with mechanisms of the lock and is retained in position until released by means appropriate to opening the lock; whilst the term “combination” is used to describe and include a code, whether it be a system of numbers and/or letters, entered by means of push pad or tumbler systems, to release the locking pin and thus open the lock and provide access to the contents of the security container.

Whilst also described in this specification the single pin lock is encased in the container, it should be appreciated this does not limit the use of the lock to only encasement type applications. Typically locks are encased to minimize their vulnerability to interference by unapproved persons. The security container of the present invention benefits from having the lock internal of the container. However, the single pin lock may be manufactured to minimize any vulnerability inherent in currently available locks and as such would not require the lock to be encased for alternative applications.

The benefit of the use of a locking pin as opposed to a traditional key, is that the locking pin may be retained in place in the lock at all times and be engaged or disengaged from the lock to secure or open the lock as required, without the need for yet another separate key which needs to be made accessible, or may be lost. Such a system also has advantages over traditional padlocks, which may be opened via the use of bolt cutters, hacksaw blades and so forth.

The benefit of a combination lock is that it enables the combination of the pin-combination lock to be selected, registered in the lock as required for a particular person to have access to the contents of the security container, but it may then be changed to prevent access to the security container once the purpose of that individual having access to the security container has expired. Having a changeable combination enables access to the interior of the container means and the valuables therein, only by selected individuals for a preferred time duration.

Preferably, the combination lock is located within the container means. Preferably a compartment allowing retention of the combination lock is provided. The compartment may be larger than the combination lock to enable the lock to be more easily installed and removed, or to be exchanged with a larger lock if required. Further, to enable the combination of the lock to be changed as required, the lock may be removed from its compartment, the combination reselected and the combination lock is then returned to its compartment in the security container.

Accordingly, at least one packing member may be used between the combination lock and the body of the container means to ensure that the lock is firmly held in position within the compartment. Given the means to effect a change of the combination of the lock may be simply the removal and recalibration of the combination, it may be preferable that the packing member is only removable via the use of a specialist tool. Otherwise, the potential exists for someone who has been provided with access to the security container recalibrating the combination without approval. Thus access to the security container may then be denied to those who need to access it.

Firm retention of the lock is also important to ensure the locking pin can be aligned with and inserted into the complementary aperture in the combination lock itself. Movement of the combination lock may also cause the pin to become bent and reduce both the effectiveness and the life of the pin-combination lock.

The door of the security container therefore preferably includes an aperture to enable the locking pin to pass through the door and into the combination lock, in order to secure the door in its closed and locked position. However, without the benefits of the features of this invention this would otherwise potentially provide a weak point of the security container system. If the pin does not sit tightly against the door, the potential exists for a hacksaw blade to be passed between the door and the head of the locking pin and be used to cut the pin. Alternatively, if the aperture is too big, lateral movement of the locking pin may occur. The locking pin must be appropriately aligned with the combination lock to ensure appropriate locking of the security container. Lateral movement of the pin makes the alignment process less direct and may cause wear in the shaft of the pin.

Therefore, to address both of these problems which may exist in prior art systems, the present invention preferably includes an alignment means. The alignment means is configured to ensure the locking pin may only enter the combination lock in one orientation and with little allowance for lateral movement of the pin. The alignment means also includes an indentation which means that no portion of the shaft of the locking pin adjacent the door aperture, is exposed to the potential of being cut with a hacksaw blade or similar. Accordingly, the lower portion of the head of the locking pin is recessed into the alignment means. This operates to frustrate any attempts at unlawful or unapproved entry to the container.

In addition to the alignment means, the inside surface of door of the security container may be configured to provide a recess or groove into which a portion of the combination lock may also slide to further improve retention of the lock in an appropriate alignment. Preferably as a further security measure, the pin is preferably designed to include a collapsing portion. Accordingly, if unapproved persons attempt to gain access to the contents of the container by trying to force out or break the pin with a gripping tool, the pin is designed to collapse.

To enable the security container to operate effectively, the pin-combination lock preferably allows a variety of combination options to be used to open the security container as allowed. In preferred embodiments of the present invention a tumbler combination is used. However, this does not limit the use of other combination systems, provided they are compatible with the overall concept of a pin-combination lock as herein described.

There is preferably provision in the lock encasement to a means by which the combination of the lock may be changed. For example, a key or screw may be required to be released. The combination tumblers may then be reset to a new entry combination. Once this has been achieved, the screw or key is returned to its original positions and the new combination is set. Various systems for changing the combination are however available and may be used with, or adapted for use with, the single pin combination lock of the present invention.

As previously discussed, the security container may include two separate compartments and as such will require two separate single pin combination locks to enable access to the separate compartments independently. Alternatively, the same pin-combination lock may be provided with twin tumblers and twin pins, so the one locking system is available for use to lock two separate, but adjacent container means.

Also as previously discussed, the security container may be spaced from the surface of the external structure of the building. This may be required where there is a need to access the combination tumblers, or key pad, from the side of the container.

To prevent ingress of rain into the combination tumblers or pad, a pivoting cover may be attached to the security container to cover that combination feature. The cover would also serve to obscure the combination lock feature from being easily seen.

For the purposes of this specification the security container is made of strong, durable stainless steel. The finish on the door of the container may be adapted to complement the style, colour or aesthetics of the building's exterior or interior surface finish. In addition, the door of the security container may be substantially flat, contoured, smooth, textured, any combination of the above, and so forth to match the exterior cladding of the building in which it is installed. There are no limitations other than those imposed for practical, aesthetic, or economic reasons on the size dimensions, profile, shape and so forth of the security container.

With reference to the present invention the security container herein described has preferable application in new buildings, or in existing buildings where there may be some installation adaptations to be made to the building to retain the container. However, typically any building, or situation where there is a need for a security container for valuables may potentially benefit from the invention.

According to another aspect of the present invention, there is provided a method of manufacturing a security container, said security container including at least one container means having an interior for storing valuables therein, said container means having at least one opening thereinto, a closure means covering said at least one opening into the container means, and locking means to secure the closure means over the opening, said security container being configured to be fitted into a recess within a surface and the security container further including retention means, said retention means including bracing means, said bracing means characterised by effecting a brace relative to one or more permanent structural features associated with the surface to impede forced removal of the security container from said recess.

According to another aspect of the present invention, there is provided a method of a bracing a security container relative to the structural features of a building in a substantially substantially tamper-proof manner, said security container including at least one container means having an interior for storing valuables therein, said container means having at least one opening thereinto, a closure means covering said at least one opening into the container means, and locking means to secure the closure means over the opening, said security container being configured to be fitted into a recess within a surface and the security container further including retention means, said retention means including bracing means, said bracing means characterised by effecting a brace relative to one or more permanent structural features associated with the surface to impede forced removal of the security container from said recess.

According to another aspect of the present invention, there is provided a method of a locking a security container using locking means, said locking means including a single pin lock, said security container including at least one container means having an interior for storing valuables therein, said container means having at least one opening thereinto, a closure means covering said at least one opening into the container means, and said locking means being used to secure the closure means over the opening, said security container being configured to be fitted into a recess within a surface and the security container further including retention means, said retention means including moveable bracing means, said bracing means characterised by effecting a brace relative to one or more permanent structural features associated with the surface to impede forced removal of the security container from said recess.

Variations to the dimensions of the security container may be desirable depending on the contents required to be secured therein. Regard would of course be had to effecting the desired dimensions, such as increased height or width whilst maintaining an aesthetic external appearance and even an appearance which still conformed to the configuration/patterns of the exterior cladding, so as to enable the security container to be relatively camouflaged.

The present invention is differentiated from many existing products by virtue of its retention means, bracing means and its locking means.

In addition, it should also be appreciated that given the emphasis on security, the present invention may be interconnected with the building's security alarm system, so in the event that the security container should be tampered with, the building's alarm system would be activated. There is a range of alarm systems available in the market and prior art. The present invention may be adapted for use with said alarm systems. However, it will be appreciated by a person skilled in the art, that the adaptations and interconnections required may vary between alarm systems and whilst known to a person skilled in the art, such detail of prior art alarm systems is not the ambit of the present specification.

It should be appreciated that the present invention lends itself to more than one application. Hence, the invention may be adapted through a change to one or more, or a combination, of any location, building structural features, dimensions, security compartments, locking systems, alarmed systems, and so forth. As can be appreciated variations to and from the above described embodiments may be made without deviating from the scope of the present invention.

It should further be appreciated a variety of different embodiments, uses, and applications of the present invention therefore exist, even within the ambit of the above described security container system. An embodiment of the present invention will now be given by way of example only, to help better describe and define the present invention. However, describing the specified embodiment should not be seen as limiting the scope of this invention.

Where the invention of security means is applied to the latching system of container doors and the like, it should be appreciated that basic principles of the security means are commonly applied.

According to one aspect of the present invention there is provided security means for latching apparatus, said security means including container means, hasp means and locking means, the locking means including a body and a locking pin, the container means being adapted to receive the body of the locking means and retaining same in an orientation to receive the locking pin, the locking pin being adapted to cooperate with the hasp means and at least one portion of the latching apparatus, said container means being further adapted to co-operate with attachment means capable of attaching the security means in the vicinity of the latching apparatus, said security means being characterised by access to the body of the locking means and the pin of the locking means when locked being minimised by the arrangement of the container means, the latching apparatus and the hasp means.

Preferably the container means includes two opposed, spaced apart, parallel and substantially planar surfaces defining a front and a back surface, with at least two permanent surfaces substantially at right angles to the front and the back surfaces forming the sides of the container means, and at least two additional surfaces defining a top and a bottom each including apertures capable of receiving portions of the locking apparatus.

Preferably the container means is adapted to receive the body of the locking means. In the present invention the locking means is a single pin key and/or combination lock. The interior of the container means includes multiple bulkheads including apertures configured to the shape of the body of the lock. The bulkheads therefore not only serve to strengthen the container means, but also act as guides and retaining means to ensure the lock when inserted into the container means is firmly held in place to minimise movement of the lock. The arrangement of each bulkhead inside the container means is substantially at right-angles to the side walls of the container means and as such the bulkheads also serve as partitioning means.

Given that the locking means is preferably of the single pin variety, it is also important for the container means to include apertures which enable the locking pin to enter the lock body retained inside the container means, as well as enabling the key hole or combination means to be accessed to lock and unlock the lock. The position of the apertures is therefore defined by the configuration of the lock itself.

However, as can be appreciated the entry or exit of the locking pin into the lock body, or of the lock body into the container means can be at any location on the encasing container means. The orientation of the security means on the surface to which it is attached may also be variable. The preferred orientation may in turn be dictated for example, by the required access to the key or combination point for locking and unlocking the lock, may be dictated by the configuration of the structure itself which limits the container means to a particular orientation, or may be dictated by the configuration of the latching apparatus. Other limitations may also be present which affects the orientation of the container means and/or the entry points in the container means for either or both the locking pin and the lock body.

The container means is preferably attached to the structure associated with the latching means. If the latching means is on a cargo vehicle or container, the latching means and hence the securing means are associated with the access door. Where the latching means is on a gate, a portion of either or both the latching means and the security means may be attached to the gate, the supporting framework, or an adjacent structure.

It is preferable to attach the container means to the structure without the attachment means themselves being exposed to tampering. Therefore, it is preferable that the container means cover or include thereinside the means of attaching the security means to the structure. However, typical attachment means such as coach bolts, screws and the like need to be easily accessible for fitting the container means to the structure in the first instance.

To address this problem, the container means of the present invention co-operates with an attachment bracket. The attachment bracket includes at least one aperture for receiving attachment means to secure the attachment bracket to the structure the security means is to be used with. At least one coach bolt or other form of attachment means passes through the aperture in the attachment bracket and secures the attachment bracket to the structure. However, to ensure the container means is able to cover the heads of the attachment means, the container means is preferably slideable relative to the attachment bracket. Accordingly, the container means may slide up or down relative to the attachment bracket to expose the attachment aperture. The bolt or similar is fitted through the attachment aperture and into the structure and tightened. The container means is then slid back to the original place and covers the head of the bolt. Provision of a stop means on either or both the container means or the attachment bracket prevents the container means from sliding off the attachment bracket when the attachment bracket and co-operating container means are attached to a structure.

The attachment bracket is substantially elongate. The dimensions of the attachment bracket however, preferably equate to the length of the container means, with allowance for the thickness of portions of the latching apparatus secured by the security means and to accommodate other features of the security means, such as the hasp means and the locking pin arrangement.

Given that the attachment bracket is substantially elongate two or more attachment means, such as a coach bolt or similar may be used. Where two attachment means are preferred they may each be located at opposite distal ends of the attachment bracket. As such, the one attachment means may be inaccessible once the security means is affixed to the structure as it is preferably covered by the container means. The second attachment means may be used to attach the hasp means to the attachment bracket. The hasp means may be designed in a similar manner as the container means such that it too is able to cover the head of the attachment means once the security means is affixed to the structure. In such an embodiment the length of the attachment bracket may need to make allowance for the hasp means to be moved out of the way of the handle, to enable the latched handle to be unlatched and vice versa.

In some embodiments however, where the security means is designed to replace existing structures, on cargo vehicle or container doors, the placement of the attachment means may be dictated by existing apertures in the walls of the structure. Accordingly, the head of the upper attachment means may be exposed. Nevertheless, the configuration of the present invention enables security of the latching means to be uncompromised.

For example, even if an unauthorised attempt was made to access the contents of a truck, container, enclosed area, by use of a gas axe or other cutting tool to attempt to cut the exposed head of the attachment bolt associated with the hasp means, access will still be prevented by virtue of the remaining portions of the security means. For example, the locking pin will still remain in place in the lock body. Further, the hasp means may be additionally configured to be unable to rotate, be lifted off or removed from its close association with the locking pin, even though the bolt attaching it through the attachment bracket has been cut. Thus the locking means still secures the latching apparatus in a closed and locked arrangement.

In some instances the attachment means that attaches the hasp means to the attachment bracket may be separate from an additional hidden attachment means in the vicinity of the hasp means, that attaches the attachment bracket to the structure.

Where the present invention is used in relation to the latching means on a truck door or container door allowances have to be made for the structural thickness. The walls of these structures may vary in thickness and strength depending on the materials they are made from, the stresses they face during transport and the contents they house inside. For example, some trucks have standard thickness metal doors. The attachment bracket with container means may therefore be attached via use of a standard coach bolt or the like through the door structure. However, where insulated trucks are concerned the thickness of the wall and the internal materials used may limited such direct bolting. In fact, it may be necessary to include a longer bolt shaft, with a tension plate on the internal face of the door to ensure appropriate attachment of the bracket and the container means.

As previously mentioned, in preferred embodiments of the present invention the hasp means is also attached to the attachment bracket. Preferably the hasp means is located at the opposite distal end of the attachment bracket to the container means. Preferably the hasp means is operable between a position enabling the handle of the latching means to be opened, and a position to restrict opening of the handle of the latching means. In one preferred embodiment the hasp means is rotatable. In other embodiments the hasp means may also be slidable, or may pivot in order to operate between these two positions.

The hasp means also preferably includes a stop. The stop is configured such that when the hasp means is moved to a position to restrict opening of the handle of the latching means the aperture of the hasp means is substantially aligned with the portion of the body of the lock that receives the locking pin. Thus, this configuration improves the ease with which the locking pin is aligned with and inserted into the lock body.

The hasp means preferably includes a body portion and an attachment portion. The body portion includes an aperture capable of receiving the locking pin of the locking means therethrough. The attachment portion is associated with attachment of the hasp means to the attachment bracket and/or the structure. The aperture of the hasp means is preferably designed to have minimal tolerances. Ensuring snug co-operation between the aperture and the locking pin minimises leverage opportunities in unauthorised attempts to damage the security means and gain access to the truck, container, or area contents.

Either or both the hasp means and the container means may also include provision for the attachment of a security seal. As previously mentioned, a security seal does not prevent attempts to tamper with the security means, but rather alerts to unauthorised or incidental attempts to open the security means.

Preferably the hasp means is raised to enable the handle of the latching means to be moved relative to the receiving portion of the latching means. On the other hand, when the handle is in contact with the receiving portion, the hasp means is moved to its retaining position. In this position the hasp means is available to receive the locking pin of the locking means. Accordingly the hasp is preferably configured to be adapted to receive the pin is a substantially snug fit.

Preferably the head of the locking pin is configured to complement the shape of the hasp aperture such that when inserted through the hasp aperture, the head of the locking pin is flush with the surface of the hasp means and provides no access to enable a hacksaw blade to reach or cut the shaft of the locking pin.

In other preferred embodiments however, the body of the hasp means, at least adjacent the locking pin aperture, may be raised above the head of the locking pin, such that the head of the locking pin is recessed when the shaft of the locking pin is inserted through the hasp aperture.

Preferably the locking pin is configured to be received into the body of the locking means in a particular arrangement. The configuration of the head of the locking pin to complement the surface configuration of the hasp means enables the locking pin to always be inserted through the hasp aperture and into the body of the lock appropriately.

Before passing into the lock body, the shaft of the locking pin may also pass through apertures in either or both the handle of the latching means and the receiving portion of the latching means. Again the configuration of the apertures ensures a snug fit and minimises access to the shaft of the locking pin via a hacksaw blade or the like. The front and the sides of the container means also extend around the hasp-pin-latch connection to minimise accessibility. The lock body may also be indented in the container means to prevent protrusion of the lock from the container means which might otherwise attract attempts to damage the lock, and/or cause the lock to be vulnerable to the accumulation of road dirt in the locking mechanism thereby interfering with the functioning of the lock.

In addition, where the securing means is to be used on trucks or other road vehicles, the container means may also include a bottom to be push-fitted, or similar, to reduce entry of road dirt into the body of the lock which may interfere with the operation of the lock. Alternatively, a cap may simply be placed over the end of the lock itself.

According to another aspect of the present invention, there is provided a method of manufacturing a security means for latching apparatus, said security means including container means, hasp means and locking means, the locking means including a body and a locking pin, the container means being adapted to receive the body of the locking means and retaining same in an orientation to receive the locking pin, the locking pin being adapted to co-operate with the hasp means and at least one portion of the latching apparatus, said container means being further adapted to co-operate with attachment means capable of attaching the security means in the vicinity of the latching apparatus, said security means being characterised by access to the body of the locking means and the pin of the locking means when locked being minimised by the arrangement of the container means, the latching apparatus and the hasp means.

According to another aspect of the present invention, there is provided a method of a locking security means for latching apparatus using locking means, said locking means including a single pin lock, said security means including container means, hasp means and locking means, the locking means including a body and a locking pin, the container means being adapted to receive the body of the locking means and retaining same in an orientation to receive the locking pin, the locking pin being adapted to co-operate with the hasp means and at least one portion of the latching apparatus, said container means being further adapted to co-operate with attachment means capable of attaching the security means in the vicinity of the latching apparatus, said security means being characterised by access to the body of the locking means and the pin of the locking means when locked being minimised by the arrangement of the container means, the latching apparatus and the hasp means.

The present invention is differentiated from many existing products by virtue of its attachment means, its hasp means and its locking means. Although variations to the dimensions of the security means may be desirable depending on the latching apparatus with which it is to be used.

According to one aspect of the present invention there is provided security means for latching apparatus, said security means including container means and locking means, the locking means including a locking pin co-operable with a lock body, the container means being adapted to receive the lock body of the locking means and retaining same in an orientation to receive the locking pin, the locking pin being adapted to co-operate with at least one portion of the latching apparatus, said container means being further adapted to enclose at least one of a portion of the latching apparatus, said security means being characterised by access to the body of the locking means and the pin of the locking means when locked being minimised by the arrangement of the container means relative either or both the latching apparatus and the locking means.

According to another other aspect of the present invention there is provided security means for latching apparatus, said security means including container means adapted to enclose sealing means in the vicinity of the latching apparatus.

Preferably the container means includes at least one substantially planar surface defining at least a front surface, with at least two permanent surfaces substantially at right angles to the front surface forming the sides of the container means. The container means is therefore substantially U-shaped in top plan view. The front and the sides of the container means are preferably configured to extend around the hasp/pin/latch of the enclosure closure means to minimise accessibility thereto by unauthorised personnel.

In one embodiment the container means co-operates with a removable lid surface to which a single locking pin is integrally fixed. The lid surface is substantially recessed into the body of the container means when the locking pin is locked into the lock body and the security means is in operation. In use, the lock body is retained in an appropriate position within the container means and relative to the locking pin, by guide means.

In the present invention there may be included multiple guide means. For example, the guide means may include as required, but not be simply limited to, means to guide any one of the lid surface in place in the container means, the lock in place within the container means, or the locking pin in-line with the lock.

Preferably the container means is adapted to receive the body of the locking means, by sliding the locking means within the guide means to a position where the lock body is available to co-operate with the locking pin. In the present invention the locking means is a single pin key and/or changeable combination lock. The interior of the container means includes at least one guide means, or bulkhead including aperture(s) configured to the shape of the body of the lock. The guide means/bulkheads therefore, may serve to either or both strengthen the container means and act as guides to ensure the lock when inserted into the container means is firmly held in place to minimise movement of the lock and enable substantially trouble -free alignment of the locking pin with the lock body.

The arrangement of the bulkhead(s) inside the container means may be either substantially at right-angles to the side walls of the container means and as such the bulkheads also serve as partitioning means, or be substantially parallel to the walls of the container means and conform at least in part to the structural configurations of the lock.

In another embodiment, the lid may be removable, or fixed but does not include a locking pin. Rather in these latter embodiments the lid may include guide means and/or socket means into which the bar or rod of a single (or multiple) bolt means is slid. In such embodiments, which use a bolt locking means as opposed to a traditional padlock, the bar or rod forms part of a locking mechanism and is operably moved by a key, a knob, or similar.

Given that the locking means is of the single pin variety, it is also important for the container means to be configured to enable the locking pin to enter the lock body retained inside the container means, or the locking pin/rod/bar to cooperate with a socket means. In addition, the key hole or combination means needs to be accessed to lock and unlock the lock. The position of the apertures/sockets is therefore defined by the configuration of the lock itself.

However, as can be appreciated the entry or exit of the locking pin into the lock body, bolt socket, or of the lock body into the container means can be at any location on the encasing container means. The orientation of the security means on the surface to which it is attached may also be variable. The preferred orientation may in turn be dictated for example, by the required access to the key or combination point for locking and unlocking the lock, may be dictated by the configuration of the structure itself which limits the container means to a particular orientation, or may be dictated by the configuration of the latching apparatus. Other limitations may also be present which affects the orientation of the container means and/or the entry points in the container means for either or both the locking pin/bolt and the lock body.

The container means is preferably removably attached to the structure associated with the latching means. If the latching means is on a cargo vehicle or container, the latching means and hence the securing means may be applied to the access door. Where the latching means is on a gate, a portion if not all of the latching means will be encased/enclosed by the security means which in turn may be removably attached to the gate, the supporting framework, or an adjacent structure by co-operation of the security means with the latching means.

It is preferable that the container means is removably attachable to the structure without any attachment means themselves being exposed to tampering. The removable security means enables this to be achieved without having to rely on the attachment means and security issues associated with the fixed security means systems, where it is preferable that the container means cover or include thereinside the means of attaching the security means to the structure. In fixed security means systems, typical attachment means such as coach bolts, screws and the like need to be used for fitting the container means and the security means to the structure in the first instance.

The container means of the removable security means is simply designed to fit over the latching apparatus, but is dimensioned with allowance for the thickness of portions of the latching apparatus secured by the security means and to accommodate other features of the security means, such as hasp means, the locking pin arrangement, the lock. The design of the security means is such as to provide at least two levels of protection to the contents of the enclosure.

For example, the design of the security means is such that even if an unauthourised attempt was made to damage the security means to gain access to the contents of a truck, container, or an enclosed area (such as by using a gas axe or other cutting tool to attempt to cut into the body of the container means), access will still be prevented by virtue of the remaining portions of the security means. For example, whilst the container means may be damaged in part, the locking pin will still remain in place in the lock body and so the locked latching means will still retain a level of security.

Selecting the material from which the security means is manufactured can further assist in the deterrent effect of the security means. For example, manufacturing the security means and all its component parts thereof from stainless steel would require an unauthorised party to avail themselves of special cutting tools as opposed to simply a gas axe, or a hacksaw.

Having the latching means and its attachment components also manufactured from stainless steel would further enhance the security feature of this invention. Accordingly, the present invention extends also to improving the features/components of the latching apparatus and its attachment to the structure. For example, a slidable cover similar in operation to and attachment of the container means of the security means, may be used to cover vulnerable portions of the latching apparatus and its components.

In various embodiments, the configuration of the container means and its location relative to the point of attachment of the handle/opening mechanism of the latching means may in itself operate as an obstacle to prevent damage to the latching apparatus and/or its attachment to the structure, in unauthorised attempts to access the contents of the container, truck, area.

Further, in situations where high levels of security are required, it is preferable that the locking means itself not be vulnerable. Accordingly, in such security situations the preferred lock is security proof in that it is not possible to drill the lock in an attempt to damage the lock and open it. However, if the requirement was for improved security without the added expense of a tamperproof locking means, then a less expensive lock may be used and the security is provided by the security means.

Again in certain situations where the level of security required is very important, it is a preferred design feature of the locking means that where a single pin key lock is used the key can not be removed from the lock unless the locking pin is in place and secured. This provides two benefits in that the operator knows that the lock is secure if the key can be removed, yet the operator can not misplace the key when the lock is opened. Again, as this option includes the use of more expensive locking systems, a less expensive lock may be used which reflects the level of security required and the additional security is provided by the security means.

Either or both the locking means and the container means may also include provision for the attachment of a security seal. As previously mentioned, a security seal does not prevent attempts to tamper with the security means, but rather alerts to unauthorised, nuisance or incidental attempts to open the security means. The container means of the removable security means is preferably configured to enclose the security seal, thereby ensuring that the seal is protected from nuisance damage. Coverage of the seal also means that if the seal is damaged, there would be a limited number of authorised personnel who would have access to the seal and thus it would be a less complex matter to try to track down that particular individual responsible for damaging the seal. This form of seal protection enhances the security aspect associated with the contents of an enclosure.

Preferably the locking pin is configured to be received into or through the body of the locking means in a particular arrangement, dependant on whether the locking means is of the padlock type, or the pin or bolt type.

The shaft of the locking pin may also pass through apertures in one or more of the handle of the latching means, the receiving portion of the latching means, a hasp, an aperture in abutting plates and so forth.

Preferably, the lock body may be indented in the container means to prevent protrusion of the lock from the container means which might otherwise attract attempts to damage the lock, cause the lock to be vulnerable to the accumulation of dirt in the locking mechanism, or expose the lock to weather conditions, all of which may thereby negatively impact on the functioning of the lock.

In addition, where the securing means is to be used on trucks or other road vehicles, the container means may also include a bottom to be push fitted, or similar, to reduce entry of road dirt into the body of the lock which may interfere with the operation of the lock. Alternatively, a cap may simply be placed over the end of the lock itself. The cap may be an optional extra to be applied as the situation of use dictates.

As may be appreciated, the body of the container means may be adapted to receive any shape of handle of a latching means. Such adaptation may simply be by virtue of cutting a different profile out of the sides of the container means to ensure the handle fits snugly against the receiving portion of the latching apparatus. The configuration of the container means is chosen to ensure the locking pin may pass through apertures in the latching apparatus and yet be in close proximity to the lock body or locking pin socket in the container means (dependent on the locking system employed), to effect a snug interconnection.

The advantages of the security means of the present invention when used on vehicle doors or cargo container doors include the ability to transport goods from one area to another via truck, or container. A single pin lock enables the dispatching person to lock the lock with a key and/or combination code. The contents of the truck or container would then not be accessible until it arrives at its destination where another individual may access the contents by use of a key and/or combination code. In some instances, the combination access code may not be advised until arrival of the truck or container at its destination and may be obtained via phone call or written/coded message. The combination may then be changed for use with another cargo. The combination is selectable and changeable to enable access to the interior of the container and the contents therein, only by selected individuals for a preferred time duration.

Similar advantages are also evident when the security means is applied to a standard door, gate, or opening which enables access to an enclosure only by approved personnel.

Preferably the distance the container means of the security means extends from the surface against which it is secured is controlled, particularly with regard to the back of the truck or container, so as to not impact on such things as the ability to stack or handle the containers without damaging the security means.

Preferably, the security means is configured to complement the features of the surface to which it is attached. In preferred embodiments the container means, is manufactured from stainless steel which has been laser cut to the preferred configuration. The preferred thickness of the stainless steel is 1.5 ml to 3 ml, but other thicknesses may be used. Further, other materials and manufacturing techniques may be employed without deviating from the scope of the present invention. As can be appreciated the level of sophistication in materials and manufacturing processes may range from a sophisticated laser cutting system of stainless steel, to casting the security means. A person skilled in the art would appreciate the benefits of the various materials used and the alternative methods of manufacture as they relate to any particular application of the present invention.

For the purpose of this specification, latching apparatus shall include, but not be limited to any fastening for a gate or door or the like which is used to bar access to an area/enclosure. The latching apparatus may include a bar (straight or otherwise) or similar moving element that may be slid, lowered, rotated, pivoted and so forth into a receiving portion such as a groove, hole, hasp, eye and so forth in order to effect retention of the door, gate, screen or the like in a closed position. The bar or the receiving portion may be attached to any one of the door, gate and so forth, or to the surrounding structure or to an adjacent frame or the like. It is also an option of the present invention that the bar/pin/bolt of the latching apparatus may in fact also serve as the locking pin for the locking apparatus.

For the purpose of this specification the term “hasp means” is used to describe and shall include any means which is able to receive a portion of a locking means and/or co-operates with a portion of the latching means and the locking means in such a manner as to maintain the latching means either or both closed and secured/locked. The hasp means is preferably capable of operating between a fastening and an unfastening position. To effect such movement the hasp means may be capable of pivoting, rotating, sliding and so forth. This definition is to be interpreted broadly and should not be limited only to the described features herein.

For the purpose of the embodiments described in this specification, the locking means is additional means for securely affixing the latching means in a closed position and in an improved substantially tamper-proof manner to address the previously mentioned problems of prior art systems in response to which the present invention has been designed. This does however not preclude the adaptation of a feature of the latching apparatus serving also as part of the locking means. As has been discussed above where the bolt/pin/rod of a latching system may operate as the locking pin of the locking means.

Therefore, to secure the latching apparatus in a closed mode the latching apparatus either or both co-operates with and includes locking means. The locking means is used to prevent access to the contents of the container, area, enclosure and so forth.

In preferred embodiments of the present invention as previously mentioned, the locking means includes a single pin lock. Whilst a single pin key lock may be employed in preferred embodiments, this does not preclude the use of a single pin changeable combination lock, or a combined single pin key and changeable combination lock. The invention therefore extends to the use of padlocks, bolt locks and so forth.

For the purpose of describing the present invention in this specification the lock may be substantially the same term as, or an adapted form oft, the single pin lock described in the applicant's New Zealand Patent Application No. 528386. As therefore defined, the word “pin” is used to describe any rod of substantially strong material which operates potentially as a key in a lock system. The pin is a locking pin which is accordingly slid into the lock body where it engages with mechanisms of the lock and is retained in position until released by means appropriate to opening the lock. Where the single pin lock includes a combination means for releasing the locking pin of the lock, the word “combination” is used to describe and include a code, whether it be a system of numbers and/or letters, entered by means of push pad or tumbler systems. Use of the correct combination releases the locking pin and thus opens the lock and provides access to the contents of the container, area, and so forth.

Where the lock is a bolt lock the bar or rod that forms part of the locking mechanism may be released for movement by either a key or combination system, and may be moved by a knob-push-pull system, for example. As can be appreciated various forms of locking systems may be used of adapted for use with the present invention, without deviating from the scope of the invention.

Whilst also described in this specification that the single pin lock is encased in the container means, it should be appreciated this does not limit the use of the lock to only encasement type applications. Typically locks are encased to minimise their vulnerability to interference by unapproved persons. The security means of the present invention benefits from having the lock internal of the container means. However, the single pin lock may be manufactured to minimise any vulnerability inherent in currently available locks and as such would not require the lock to be encased for alternative applications.

The benefit of the use of a locking pin with a combination option as opposed to a traditional key, is that the locking pin may be retained in place in the lock at all times and be engaged or disengaged from the lock to secure or open the lock as required, without the need for yet another separate key which needs to be made accessible, or may be lost. Such a system also has advantages over traditional padlocks, which may be opened via the use of bolt cutters, hacksaw blades and so forth.

Another benefit of a changeable combination lock is that it enables the combination of the pin-changeable combination lock to be selected, registered in the lock as required for a particular person to have access to the contents of the security container, but it may then be changed to prevent access once the purpose of that individual having access has expired. Having a changeable combination enables access to the interior of a truck, container or area and the contents thereof, only by selected individuals for a preferred time duration.

In preferred embodiments of the present invention a single pin key lock is used. However, this does not limit the use of a single pin changeable combination lock, a single pin key and changeable combination lock, or other keyed or combination systems, provided they are compatible with the overall concept of the single pin lock as herein described for use with the security means.

Further, where a single pin combination is used provision is made to enable the combination of the lock to be changed as required. The lock may therefore be removed from the container means, the combination reselected and the changeable combination lock is then returned to its compartment in the container means. Therefore, where the locking means used includes a combination system, there is preferably provision in the lock body itself to a means by which the combination of the lock may be changed. For example, a key or screw may be required to be released. The combination tumblers may then be reset to a new entry combination. Once this has been achieved, the screw or key is returned to its original positions and the new combination is set. Various systems for changing the combination are however available and may be used with, or adapted for use with, a single pin changeable combination lock option of the present invention.

As also mentioned previously, firm retention of the lock is also important to ensure the locking pin can be aligned with and inserted into the complementary aperture in the body of the lock itself. Movement of the body of the lock may in some prior art systems cause the pin to become bent and reduce both the effectiveness and the life of the lock. Lateral movement of the pin makes the alignment process less direct and may cause wear in the shaft of the pin.

Preferably, the body of the lock is located within the container means. Preferably a compartment allowing retention of the lock is provided. As previously described this may be achieved via the inclusion of bulkheads which include or are formed to provide apertures configured to complement the shape of the lock body. The bulkhead apertures may be adapted to enable a larger or smaller lock to be used if required.

Further, to address problems which may exist in prior art systems, the present invention preferably uses any combination of one or more of the configuration of the head of the locking pin, the lid of the container means, a locator structure/socket, or other internal guide means, as an alignment means. The alignment means is configured to ensure the locking pin may only enter the body of the lock, or the bolt socket as applicable, in one orientation and with little allowance for lateral movement of the pin.

In changeable combination lock systems, an additional push plate may be included internally against which the lock body may be pushed. This is required to effect operation of internal spring mechanisms of the lock to enable ejection of the changeable combination lock from the container means when the lock is “opened” and as required to remove the changeable combination lock from the container to enable the combination codes to be changed.

With reference to the present invention the security means for latching apparatus herein described has preferable application in transportation industries, such as on trucks or containers. However, the security means may be adapted for use in any situation where there is a need for security of a container, area or enclosure.

According to another aspect of the present invention, there is provided a method of manufacturing a security means for latching apparatus, said security means including container means and locking means, the locking means including a body and a locking pin, the container means being adapted to receive the body of the locking means and retaining same in an orientation to receive the locking pin, the locking pin being adapted to co-operate with at least one portion of the latching apparatus, said container means being further adapted to enclose sealing means in the vicinity of the latching apparatus, said security means being characterised by access to the body of the locking means and the pin of the locking means when locked being minimised by the arrangement of the container means relative to the latching apparatus.

According to another aspect of the present invention, there is provided a method of a locking security means for latching apparatus using locking means, said locking means including a single pin lock, said security means including container means and locking means, the locking means including a body and a locking pin, the container means being adapted to receive the body of the locking means and retaining same in an orientation to receive the locking pin, the locking pin being adapted to co-operate with at least one portion of the latching apparatus, said container means being further adapted to enclose sealing means in the vicinity of the latching apparatus, said security means being characterised by access to the body of the locking means and the pin of the locking means when locked being minimised by the arrangement of the container means relative to the latching apparatus.

The present invention is differentiated from many existing products by virtue of its container means, its locking means and the ability to secure seal means. Although variations to the dimensions of the security means may be desirable depending on the latching apparatus with which it is to be used.

In addition, it should also be appreciated that given the emphasis on security, the present invention may be interconnected with a vehicle's or building's security alarm system, so in the event that the security means or the latching apparatus should be tampered with, the alarm system would be activated. There is a range of alarm systems available in the market and prior art. The present invention may be adapted for use with said alarm systems.

However, it will be appreciated by a person skilled in the art, that the adaptations and interconnections required may vary between alarm systems and whilst known to a person skilled in the art, such detail of prior art alarm systems is not the ambit of the present specification.

It should be appreciated that the present invention lends itself to more than one application. It should further be appreciated a variety of different embodiments, uses, and applications of the present invention therefore exist, even within the ambit of the above described security means system. An embodiment of the present invention will now be given by way of example only, to help better describe and define the present invention.

However, describing the specified embodiment should not be seen as limiting the scope of this invention.

### BACKGROUND ART

A number of locking systems are available in the prior art to either secure a vehicle against theft or to prevent removal of a vehicle which has been detained.

Such systems include steering wheel or wheel locks and braces. However, there are a number of disadvantages associated with the various prior art systems available. Often such systems can be extremely cumbersome and heavy. They are not typically designed for the average person to retain in the vehicle and to apply it to the vehicle as required. Such examples include wheel clams attached to the wheels of vehicles parked illegally, and requiring the owner of the vehicle to pay a fine before the vehicle can be released.

Other systems such as wheel braces for attaching to wheels, may have limitations in the locking mechanisms, which may be compromised by the used of bolt cutters or hacksaws. This is also the case with many versions of the steering wheel locking/bracing systems.

Yet other systems may include features, such as spikes designed to puncture and deflate the tyre if the vehicle is moved. Whilst this is a deterrent to stealing the vehicle, it is counterproductive to the owner of the vehicle, who would prefer the security of the vehicle to be maintained without damage being inflicted by the very apparatus the owner is using to protect the vehicle.

While the present invention has a number of potentially realisable applications, it is in relation to problems associated with existing systems that the present invention was developed. More specifically, it was with the problems associated with the lack of a readily available alternative system for effecting improved security for vehicles as a whole, as well as a system that could be easily installed, that the present invention was developed.

It would be useful therefore, to have security means providing a system for securing containers that:
f) Could have the benefits of being fitted to a vehicle as required; yet
g) Could be used with any appropriate single or tandem wheeled vehicles, including cars, trailers, bikes, trucks and the like, having wheels of varying diameters; yet
h) Included a locking system that provided a substantially tamperproof alternative to existing locking systems; and
i) Was a less cumbersome security means; and yet
j) Could include a locking system which enabled only authorised personnel to remove the security means.

It would therefore be advantageous to have an invention that offered at least some if not all of the advantages of the above proposed security container. It is therefore an object of the present invention to consider the above problems and provide at least one solution which addresses a plurality of these problems.

Ideally the present invention will also provide a system which allows for a substantially trouble free installation system.

It is therefore a further object of the present invention to at least provide the public with a useful choice or alternative system.

Further aspects and advantages of the present invention will become apparent from the ensuing description which is given by way of example only. It should be appreciated that variations to the described embodiments are possible and would fall within the scope of the present invention.

A security container may be defined as container provided with locking means for storing valuables. A security container is a precaution taken to ensure against theft of the articles contained within the security container.

The security container of the present application is envisaged to be used for securely storing vehicle keys, particularly in businesses involved in the motor industry. Accordingly, the term security container of the present specification is directed to use of the security container fixed externally of a vehicle. However, money and other things of value to the owner may also be stored and the present description should not be seen as limiting this specification.

For the purpose of describing the present invention the security container provides a temporary place to hold vehicle keys, such as in situations where an individual may need access to a locked vehicle. Motor vehicle dealers, car rental providers, vehicle repairs and maintenance providers and long-haul transport companies all would benefit from use of the security container. The security container for vehicles provides a fixed option on the actual vehicle that enables the keys for the vehicle to be accessible to the relevant authorised individual(s). The present system provides a secure and convenient solution to problems of key access.

Alternative security containers are available which may be attached to the exterior of a vehicle. Whilst designed to be a somewhat permanent fixture, the design limitations of these various prior art devices, do not in effect afford optimum security, nor do they provided for an effective, permanent, substantially tamper-proof security container. It is with the above mentioned problems of prior art systems that the present invention has been designed. In addition, changing practice in the vehicle industry often means that services are contracted, whether they be transportation, repair and maintenance, delivery of vehicles and so forth. The onus is now on the contracted service provider to ensure the security of the vehicle and/or its contents. It is therefore in relation to this fundamental change to the motor vehicle support service industry that the present invention is also directed to.

According to one aspect of the present invention there is provided a security container, said security container including a body, said body having at least one opening thereinto, and said body adapted to receive container means therein for storing objects, said container means in a slidable arrangement relative to said body and operable between an opened and a closed position, said container means when in a closed position thereby closing said at least one opening into the body, pivotable latching means for maintaining the container means in a closed position, said pivotable latching means maintained in latched connection with the container means via locking means, said locking means being received into a recess within the body of the security container and removable therefrom to effect release of the latching means from the container means to effect opening thereof, said security container being configured to further include retention means, said retention means securing the body in a fixed arrangement relative to a structural feature associated with a surface to impede forced removal of the security container from said surface.

According to another aspect of the present invention there is provided a security container substantially as described above wherein the body includes two opposed and spaced apart parallel planar surfaces for defining a top and a bottom surface, at least two permanent surfaces substantially at right angles to the top and bottom surfaces forming the enclosing sides of the body, and at least one exposed surface comprising an opening and being configured to provide entry of the container means to the body.

According to another aspect of the present invention there is provided a security container substantially as described above wherein the container means includes at least three permanent surfaces arranged substantially U-shaped forming bottom, front and back surfaces of the container means, said front surface being configured to close off the entry of the body into which the container means is slidably inserted and said back surface adapted to engaged with the pivotable latching means when the container means is inserted into the body.

According to another aspect of the present invention there is provided a security container substantially as described above wherein the container means includes hook means to maintain the object held within the container means in a preferred position.

According to another aspect of the present invention there is provided a security container substantially as described above wherein the object includes keys, money and so forth.

According to another aspect of the present invention there is provided a security container substantially as described above wherein the locking means used to secure the container means within the body of the security container includes a single pin lock.

According to another aspect of the present invention there is provided a security container substantially as described above wherein the single pin lock is a single pin changeable combination lock.

According to another aspect of the present invention there is provided a security container substantially as described above wherein the single pin of the single pin changeable combination lock is fixed to an interior surface of the body and the body of the single pin changeable combination lock slides onto the fixed pin to effect a locked position of either or both the lock and the container means within the body.

According to another aspect of the present invention there is provided a security container substantially as described above wherein the locking means is enclosed by the body, or compartment therein.

According to another aspect of the present invention there is provided a security container substantially as described above wherein a portion of the locking means is adapted to interact with a portion of the latching means and thereby prevent pivoting of the latching means from a position where the latching means is engaged with the container means to a position where the latching means is released from the container means, thereby enabling the container means to slide out of the body.

According to another aspect of the present invention there is provided a security container substantially as described above wherein the combination of the single pin changeable combination lock is selectable and changeable to enable access to the interior of the container means and the object(s) therein, only by selected authorised individuals for a preferred time duration.

According to another aspect of the present invention there is provided a security container substantially as described above wherein the retention means, includes fixing means, such as screws, bolts, nails.

According to another aspect of the present invention there is provided a security container substantially as described above wherein the retention means affixes the body of the security container to an external portion of a vehicle, including the vehicle chassis.

According to another aspect of the present invention there is provided a security container substantially as described above wherein the retention means is adapted to impede forced removal of the installed security container from said vehicle.

According to another aspect of the present invention there is provided a security container substantially as described above wherein the at least one container means includes switching and/or deactivation/activation means for a vehicle immobilising system.

According to another aspect of the present invention there is provided a security container substantially as described above wherein the vehicle immobilising system is powered by an energy source, including at least one battery.

According to another aspect of the present invention there is provided a security container substantially as described above wherein the at least one container means includes switching and/or deactivation/activation means for a vehicle alarm system.

According to another aspect of the present invention there is provided a security container substantially as described above wherein the vehicle alarm system is powered by an energy source, including at least one battery.

According to another aspect of the present invention there is provided a security container substantially as described above wherein the at least one container means includes an on-off switching means for a vehicle's battery system.

Whilst the present invention is described herein with particular reference to the features and use of an external substantially tamper-proof security container for keys and the like, it should be appreciated that the invention may also be applicable to and/or be adapted for use in other situations where items are required to be made available only to certain authorised people at certain times, or security of valuables for particular periods is desirable in particular circumstances such as when vehicle owners or drivers are away from the vehicle.

In one preferred embodiment of the present invention, the security container includes at least one container means in the form of a slideable drawer, having an interior for storing keys therein. The drawer has at least a front and rear wall. The drawer also has a base.

The front wall is dimensioned to complement the opening of the body through which the drawer slides. Accordingly, the front wall has a height and a width that effectively closes off the opening of the body of the security container when the drawer is closed.

The rear wall is similarly dimensioned in terms of its width, to fit within the body. The height of the rear wall is however dependent on its interaction with the pivotable latching means which maintains the drawer in a substantially firm and closed position when the locking means of the security container is in place and locked.

In addition, the rear wall may be configured to include an aperture or similar for a switching means to be accessible. The switching means is adapted to be connected to a vehicle immobilising system and is preferably powered by an energy source, such as at least one battery of providing an energy supply of at least from 3 volts to 36 volts.

Preferably, when the vehicle driver has to leave the vehicle unattended, the vehicle keys may be placed inside the vehicle security container and the switching means set to activate an immobilising system to prevent the vehicle from being hot-wired. The immobilising system may only be deactivated by access to the security container and by switching off the immobilising system from that point.

To further reduce the likelihood of the vehicle being stolen, a vehicle alarm system may also be included which may be adapted to be set off if the security container is tampered with, or if attempts are made to move the vehicle. The battery supply to the vehicle immobilizing system may also be used to supply power to the vehicle alarm system. Again, where the vehicle alarm system has been set to reduce the likelihood of the vehicle being stolen, by towing or moving the vehicle on to another transport vehicle and the like, activation of the alarm can only be reversed by deactivating the alarm system set in the vehicle security container.

The base of the drawer is again of a width that approximates the interior dimensions of the body. Accordingly, the drawer is free to slide in to the body, but snugly fits in place once inserted. The length of the base determines the distance by which the drawer extends in to the body of the security container. As the security container body also holds the locking means, the length of the drawer is such as to allow the drawer to substantially abut the area where the locking means is located.

As the security container is preferably configured to be used for the temporary storage of objects such as keys, the interior face of the front wall of the drawer may include a hook or similar system onto which a key or set of keys may be hung. Having the keys so placed means that they are more readily accessible when the drawer is opened, rather than might be the case if they were simply loosely placed in the drawer. However, other systems for maintaining the contents in an accessible orientation may also be employed.

In preferred embodiments the body of the security container is substantially a receptacle created by and/or including two opposed and spaced apart parallel planar surfaces for defining a top and a bottom surface, three permanent surfaces substantially at right angles to the top and bottom surfaces forming the enclosing sides of the container, and at least one exposed surface comprising an opening and being configured to provide access to the interior of the body for the container means. A further opening is included in an adjacent side surface to allow the locking means to be inserted therethrough.

Whilst the body of the security container of preferred embodiments is substantially a square or rectangular compartment, it should also be appreciated that the body may take other configurations, including a substantially cylindrical body forming the enclosing sides, top and bottom of the container means, and at least one exposed surface comprising an opening and being configured to provide access to the interior of the body. As can be appreciated the dimensions of the security container is variable, but preferably dictated by the preferred placement of the security container in use.

The configuration of the security container is preferably dictated by the surface structure onto which the security container is installed. Preferably, it is desirable that the security container be as inconspicuous as possible, or be aesthetically compatible with the surface.

In preferred embodiments the security container is configured to be fitted onto a vehicle. Preferably the security container is fitted to the chassis of the vehicle, to enable the security container to be fitted firmly and permanently to the vehicle whilst being substantially inconspicuous, yet readily accessible.

Preferably, the security container is retained in position by retention means. The retention means in preferred embodiments includes at least one plate means. The plate means is preferably permanently affixed to the vehicle, such as by welding or such other suitable means. However, it may be desirable that the security container be removable in some instances. Therefore, the plate may also be removed. Alternatively, the plate may stay in position on the vehicle and another plate attached to another vehicle, or another place on the same vehicle, may allow the security container to be relocated. Preferred fixing of the plate relative to the vehicle is intended to impede attempts to loosen or prise off the plate means in an attempt to loosen or damage the retention means as a whole or in part and thereby remove the security container. Whilst a plate means may be attached to either side of a preferred location on the chassis of the vehicle—in effect sandwiching the chassis portion between the plate means, this arrangement should only be considered where it is impossible to feed a pry bar or the like between the plate adjacent to the body of the security container. The intention of the present invention is to limit opportunities for weak points or access to areas where the integrity of the security container or its attachment may be compromised.

The body of the security means is preferably fitted to abut against the opposite side of the chassis surface to where a single plate means may be attached. The plate means may be welded or fixed to the chassis by appropriate screw-threaded means or other systems. If a plate means is included adjacent the body of the security container that plate means may be welded/fixed to the security container also.

The plate means is substantially planar and includes at least one aperture which may partially or fully tranverse the thickness of the plate means. The aperture is preferably threaded in order to receive a complementarily threaded shaft of appropriate fixing means—such as a bolt shaft, for example.

The fixing means is characterised by being screwed through an appropriately positioned (and preferably threaded) aperture in a wall of the body of the security container. It is then screwed through the threaded apertures of one or more plate means and through an aperture in the vehicle structure. In some situations the aperture in the vehicle structure may also be threaded to improve the retention of the security container. However, it is important that in such embodiment the shaft of the fixing means is threaded true and does not become mis-aligned which may affect the ability to tightly abut the plate and the security container to the vehicle structure. Any gaps between the adjacent surfaces should be avoided to ensure optimum security against attempts to remove the security container from its attached position.

In this regard also, the head of the fixing means is preferably retained in the interior of the body of the security container and may be substantially flush with the interior surface. The end of the fixing means is either retained within the width of the most distant plate means, or be substantially flush with the outer surface of that plate means. This arrangement enables substantially permanent fixing of the security container to the vehicle, minimises the likelihood of vibrations affecting the threaded system as multiple threaded points and welded or fixed plate means retain the fixing means in place, and substantially impedes forced removal of the security container from the vehicle. The fixing means may be unscrewed from within the body of the security container. Alternatively, there is the option of welding the head of the fixing means in place to prevent removal.

To further operate against the vibrations of the vehicle impacting on the secure attachment of the container, in some embodiments the shaft of the bolt (or of similar fixing means) may project slightly through the plate means and a nylon nut or similar, be attached thereto.

In preferred embodiments of the present invention the fixing means may be attached to one or more of the sides, top, rear or bottom surfaces of the security container as relevant to its attachment to the preferred location on the vehicle.

The present system provides benefits over prior art systems where, at least one aperture is included in the plate through which a shaft of a bolt may pass and the threaded end of the bolt is located inside the container where a wing nut is used to tighten the plate against movement relative to the container. A vehicle when moving generates substantial vibrations which may impact on the ability of this system maintaining firm retention of the security container on the vehicle exterior. In addition, it minimises the likelihood of an individual who may obtain an access code, simply being able to undo a wingnut and remove the security container from the vehicle. The present system is also designed to have minimal tolerances to ensure the security container as a whole does not rattle during movement of the vehicle. Having a wing nut, or similar substantial protrusion in the interior of the body would require allowance for that protrusion and may impact on the snug fit of the component parts of the security container.

The fixing means may be any suitable anchor means. However the attachment of the plate means to either or both the external surface of the container and to the framework of the vehicle provides a deterrent against attempts to pry the container off the vehicle. It is such a retention feature that serves to provide improved retention of the security container on a vehicle, over prior art security container systems.

The present invention is designed to provide a permanently fitted, substantially tamper-proof, security container, primarily for storing valuables such as keys, externally of a vehicle and which is accessible only by selected authorized individuals and to prevent access to those valuables by intruders, or the like. Therefore, provision may be made for the surfaces of the body of the container to include further apertures through which such additional fixing means can threaded and secured into adjacent structural features of the vehicle.

Once the security container is installed on the vehicle, the opening(s) of the security container is preferably closed by the insertion of the container means, or drawer as previously described. The container means effectively also operates as a cover/door into the security container and is operable to be opened and closed as required to access the contents of the security container.

The container means is configured to slide into the body through an opened end of the security container. The fit of the container means relative to the body is substantially enough to allow the drawer to slide opened and closed, but allows little leeway for a tool or pry bar to pry the drawer from the body of the security container. Further, the drawer when inserted into the body is indented from the outer edge of the body. This serves a number of functions. Firstly, as described above, it allows little leeway for a tool or pry bar to pry the drawer from the body. Secondly, it reduces the effect of road grime and so forth having direct access into the body and the drawer. Thirdly, it enables a cover or cap means to be used to further close off the entry of road dirt and grime, water and so forth into the drawer and/or the body.

In preferred embodiments the cap means is a moulded push fit cap, manufactured from any suitable material, such as rubber, plastics materials, plastic-glass combinations, metal with rubber components for sealing, and so forth. However, any variation to the cap shape, location over or inset into the body, or the materials from which it is made are possible within the ambit of the present invention.

Whilst hinged door systems, or other closure systems are not discussed in details herein, it should be appreciated that other means for securing and operating a drawer or door system of the security container may be used, or adapted for use, with the invention. However, the emphasis is at all times on creating a substantially tamper-proof system. Hence, the need is to ensure the drawer/door fits snugly and tightly and can not be removed by simply interfering with hinges or the like.

To further secure the security container in a closed mode the security container includes locking means. The locking means is used to secure the container means within the body and prevent access to the contents of the security container.

In preferred embodiments of the present invention, the locking means includes a single pin lock and more preferably a single pin changeable combination lock. For the purpose of this specification the term “pin” is used to describe any rod of substantially strong material which operates potentially as a key in a lock system. The pin is a locking pin which is accordingly slid into the lock body where it engages with mechanisms of the lock and is retained in position until released by means appropriate to opening the lock; whilst the term “combination” is used to describe and include a code, whether it be a system of numbers and/or letters, entered by means of push pad or tumbler systems, to release the locking pin and thus open the lock and provide access to the contents of the security container.

Whilst also described in this specification the single pin lock is encased in the container, it should be appreciated this does not limit the use of the lock to only encasement type applications. Typically locks are encased to minimise their vulnerability to interference by unapproved persons. The security container of the present invention benefits from having the lock internal of the container. However, the single pin lock may be manufactured to minimise any vulnerability inherent in currently available locks and as such might not require the lock to be encased for alternative applications.

The benefit of the use of a locking pin as opposed to a traditional key, is that the locking pin may be retained in place in the lock at all times and be engaged or disengaged from the lock to secure or open the lock as required, without the need for yet another separate key which needs to be made accessible, or may be lost. Such a system also has advantages over traditional padlocks, which may be opened via the use of bolt cutters, hacksaw blades and so forth.

The benefit of a combination lock is that it enables the combination of the pin-combination lock to be selected, registered in the lock as required for a particular person to have access to the contents of the security container, but it may then be changed to prevent access to the security container once the purpose of that individual having access to the security container has expired. Having a changeable combination enables access to the interior of the container means and the valuables therein, only by selected authorized individuals for a preferred time duration.

Preferably, the combination lock is located within the body of the security container. Preferably, a compartment allowing positioning of the combination lock is provided. The compartment may be larger than the combination lock to enable the lock to be more easily installed and removed, or to be exchanged with a larger lock if required, or to enable a cap to be fitted over the combination tumblers etc of the lock which is accessible yet may require covering whilst the vehicle is on the road to minimise ingress of water and dirt into the tumblers. The cover would also serve to obscure the combination lock feature from being easily seen.

The compartment and the position of the lock are such that only the tumbler portion of the lock is accessible on the exterior of the security container. Therefore, to enable the combination of the lock to be changed as required, the lock may be removed from its compartment, the combination reselected and the combination lock is then returned to its compartment in the security container.

Given the means to effect a change of the combination of the lock may be simply the removal and recalibration of the combination, it may be preferable that the features of the lock itself are utilised to enable the lock to be accessible and removed from the security container for such a purpose. Therefore, the internal spring mechanism of the lock which allows the locking pin to be released when the lock is unlocked, is used to assist removal of the lock from the container. Pressure applied to a portion of the exposed face of the lock effects operation of the lock's internal spring mechanism and pushes the lock partially out of the security container to enable an individual to grip the lock and then remove it. In other embodiments locking means without internal spring mechanisms may be used. In these embodiments a spring means may be included on the shaft of the single pin, to provide the spring mechanism to eject the lock from the body of the security container.

Removal of the lock is also essential to the ability to open the container means. For, in preferred embodiments of the present invention, the locking means includes a bracing portion which acts against an adjacent end of the pivotable latching means. When the locking means is in place, the bracing portion abuts the end of the pivotable latching means preventing movement thereof. When the lock is removed, so is the retaining pressure on the end of the latching means and the latching means is free to pivot.

By inserting a finger through the opening in the body of the security container provided when the lock has been removed, the individual can apply pressure to the rear wall of the container means. By pushing the container means in this manner the latching means which is used to hold the container means in place (when the container means has been inserted into the body) pivots upwards, releasing its containment hold on the rear wall of the container means and enabling the container means to slide open to access the keys or such like contained therein.

When the keys are returned to the container means and/or the container means is to be closed, the container means is slid back into the body where it pushes against the front end of the latching means and the latching means pivots up. The container means then slides in further and the latching means pivots down and latches again onto the rear wall of the container means. To secure the container means, the locking means is then inserted into the body through the locking means opening. The locking means engages with the fixed pin of the lock and braces against the adjacent end of the pivoting latching means. By pushing the lock in place on the fixed single pin, the lock becomes locked, the pivoting latching means becomes fixed and the tumblers are spun to prevent access to the security container.

The locking pin must be appropriately aligned with the combination lock to ensure appropriate locking of the security container. Lateral movement of the pin makes the alignment process less direct and may cause wear in the shaft of the pin. Accordingly, at least one alignment means or bulkhead acting as positional guides may be included within the body of the security container to ensure that the lock is appropriately located and held in position within the compartment and guided to engage with the single locking pin.

Further, as mentioned previously, the locking pin is fixed to an internal wall of the body. The alignment means is configured to ensure the locking pin may only enter the combination lock in one orientation and with little allowance for lateral movement of the pin. As the lock is substantially enclosed by the body, no portion of the shaft of the locking pin is exposed to the potential of being cut with a hacksaw blade or similar. This operates to frustrate any attempts at unlawful or unapproved entry to the container.

In the present invention the arrangement of the locking means within the body of the security container, along with the drawer being substantially indented in to the body of the container, prevents any lateral pressure being applied to the locking means. Any pressure is simply applied to the body. In addition, it is the latch end of the latching means that retains the drawer in a closed position and this is maintained by pressure applied to the opposite end of the latching means by the locking means when inserted in to the body. Therefore, pressure applied externally to the body would do little to impact on the integrity of the locking system of the security container.

To enable the security container to operate effectively, the pin-combination lock preferably allows a variety of combination options to be used to open the security container as allowed. In preferred embodiments of the present invention a tumbler combination is used. However, this does not limit the use of other combination systems, provided they are compatible with the overall concept of a pin-combination lock as herein described.

There is preferably provision in the lock encasement to a means by which the combination of the lock may be changed. For example, a key or screw may be required to be released. The combination tumblers may then be reset to a new entry combination. Once this has been achieved the screw or key is returned to its original positions and the new combination is set. Various systems for changing the combination are however available and may be used with, or adapted for use with, the single pin changeable combination lock of the present invention.

For the purposes of this specification the security container is made of strong, durable materials. Stainless steel is one preferred material, however any suitable material may be used. The finish on the body of the container may be adapted to complement the style, colour or aesthetics of the vehicle's exterior surface finish. There are no limitations other than those imposed for practical, aesthetic, or economic reasons on the size dimensions, profile, shape and so forth of the security container.

According to another aspect of the present invention, there is provided a method of manufacturing a security container, said security container including a body, said body having at least one opening thereinto, and said body adapted to receive container means therein for storing objects, said container means in a slidable arrangement relative to said body and operable between an opened and a closed position, said container means when in a closed position thereby closing said at least one opening into the body, a pivotable latching means for maintaining the container means in a closed position, said pivotable latching means maintained in latched connection with the container means via locking means, said locking means being received into a recess within the body of the security container and removable therefrom to effect release of the latching means from the container means to effect opening thereof, said security container being configured to further include retention means, said retention means securing the body in a fixed arrangement relative to a structural feature associated with a surface to impede forced removal of the security container from said surface.

According to another aspect of the present invention, there is provided a method of a bracing a security container relative to the structural features of a vehicle in a substantially tamper-proof manner, said security container including a body, said body having at least one opening thereinto, and said body adapted to receive container means therein for storing objects, said container means in a slidable arrangement relative to said body and operable between an opened and a closed position, said container means when in a closed position thereby closing said at least one opening into the body, a pivotable latching means for maintaining the container means in a closed position, said pivotable latching means maintained in latched connection with the container means via locking means, said locking means being received into a recess within the body of the security container and removable therefrom to effect release of the latching means from the container means to effect opening thereof, said security container being configured to further include retention means, said retention means securing the body in a fixed arrangement relative to a structural feature associated with a surface to impede forced removal of the security container from said surface.

Preferably, the security container is located on the chassis of the vehicle near warmth generated by the vehicle's engine, to minimise dampness that may accumulate due to its location on the outside of the vehicle where it may be exposed to the effects of road water and the like.

According to another aspect of the present invention, there is provided a method of a locking a security container using locking means, said locking means including a single pin lock, said security container including a body, said body having at least one opening thereinto, and said body adapted to receive container means therein for storing objects, said container means in a slidable arrangement relative to said body and operable between an opened and a closed position, said container means when in a closed position thereby closing said at least one opening into the body, a pivotable latching means for maintaining the container means in a closed position, said pivotable latching means maintained in latched connection with the container means via locking means, said locking means being received into a recess within the body of the security container and removable therefrom to effect release of the latching means from the container means to effect opening thereof, said security container being configured to further include retention means, said retention means securing the body in a fixed arrangement relative to a structural feature associated with a surface to impede forced removal of the security container from said surface.

According to another aspect of the present invention, there is provided a method of adapting a security container to include at least switching means for at least one of a vehicle alarm system, a vehicle immobilising system, a vehicle ignition system said security container including a body, said body having at least one opening thereinto, and said body adapted to receive container means therein for storing objects, said container means in a slidable arrangement relative to said body and operable between an opened and a closed position, said container means when in a closed position thereby closing said at least one opening into the body, a pivotable latching means for maintaining the container means in a closed position, said pivotable latching means maintained in latched connection with the container means via locking means, said locking means being received into a recess within the body of the security container and removable therefrom to effect release of the latching means from the container means to effect opening thereof, said security container being configured to further include retention means, said retention means securing the body in a fixed arrangement relative to a structural feature associated with a surface to impede forced removal of the security container from said surface.

Sometimes, irrespective of the security of the keys, the vehicles may still be stolen if they are able to be hot-wired. To reduce the likelihood of this situation arising, there is a need to further immobilise the vehicle. Systems typically designed for securing keys, do not typically consider the issue of an immobilising switch means for the vehicle as well. In addition, the inclusion of battery on-off systems for isolating vehicles such as ground-working equipment or boats, are often overlooked, as are motion detecting alarm activation/deactivation systems which all combine or may be used individually to prevent a vehicle being stolen.

To minimise the vehicle being broken into and started without the vehicle keys, the security container may also preferably include provision for at least one of a vehicle immobiliser system/switch, an on-off battery switch, an alarm deactivator/activator switch. The only way the switch may be activated or deactivated is by accessing the interior of the security container.

Where power sources are required to power the immobilising or alarm systems the power may be provided by battery(s). Alternatively, or additionally as the situation may require, any electrical cabling to transfer power to the switching means may be fed through the back of the security container where it is not available to being interfered with. The switching means may be supported by the bracing means of the security container, or be housed in relation to a dedicated bracket means.

Variations to the dimensions of the security container may be desirable depending on the contents required to be secured therein. Regard would of course be had to effecting the desired dimensions, such as increased height or width whilst maintaining an aesthetic external appearance and even an appearance which still conformed to the vehicle, so as to enable the security container to be relatively camouflaged.

The present invention is differentiated from many existing products by virtue of at least its retention means and its locking means.

Further, the present invention provides convenient authorised access to the contents of the security container, using a changeable combination lock system. The invention is designed to meet the changing motor vehicle practices for both suppliers of services and the user of those services in all areas of vehicle operation.

An example of such use is evident in the trucking industry. Trucks are leased as much as they are owned. Many trucks are on the road 24 hours a day, seven days a week. Each truck is required to be mechanically serviced at set mileages, such as 20,000 kilometres. In addition, there may be need of the services in respect of body repair trades people, for tyre replacement or for a change of driver It may be that whether the truck is leased or owned, the truck needs to be available for servicing, including pick-up and delivery back by the servicing agent. This may lead to insecure practices where keys are left in accessible places for the servicing agent to collect the truck at times when the driver or owner are not available to pass on the keys directly.

The present invention provides for secure containment of the vehicle keys. The security container is a robust system which makes access to the contents of the container difficult for unauthorised individuals. Authorised personnel may obtain access by knowing the code combination, or by having a means to give or obtain the code via a security telephone call.

In addition, it should also be appreciated that given the emphasis on security, the present invention may be interconnected with the vehicle's security alarm system, so in the event that the security container should be tampered with, the vehicle's alarm system would be activated. There is a range of alarm systems available in the market and prior art. The present invention may be adapted for use with said alarm systems. However, it will be appreciated by a person skilled in the art, that the adaptations and interconnections required may vary between alarm systems and whilst known to a person skilled in the art, such detail of prior art alarm systems is not the ambit of the present specification.

It should be appreciated that the present invention lends itself to more than one application. Hence, the invention may be adapted through a change to one or more, or a combination, of any location, vehicle structural feature, dimensions, security compartments, alarmed systems, and so forth. As can be appreciated variations to and from the above described embodiments may be made without deviating from the scope of the present invention.

It should further be appreciated a variety of different embodiments, uses, and applications of the present invention therefore exist, even within the ambit of the above described security container system. An embodiment of the present invention will now be given by way of example only, to help better describe and define the present invention. However, describing the specified embodiment should not be seen as limiting the scope of this invention.

In yet another embodiment for the purpose of describing the present invention the security means shall be referred to as a shackle protector. However, as previously discussed, the invention can be applied to any appropriate locking or affixing/retaining system where improved security would be beneficial, including staples, U-bolts, pins and the like. As such, depending on the apparatus to which the security means is applied, the shackle protector may be either a temporary option or a more permanent option. The present system is designed to provide a secure and convenient solution to problems of forced access, to padlocked (or comparative systems) areas.

A number of padlocks exist in the prior art. As previously described, a padlock is typically a detachable lock which has a hinged or swivel shackle that can be passed through the staple of a hasp or the links in a chain and then snapped shut. The present applicant has developed a range of single pin padlocking systems for use in security applications. The present invention extends to both the typical U-shaped shackle of a padlock and to the single pin options which have been developed, as well as to the various other related affixing and retaining means which serve the same purpose in securing an area, or the contents of an enclosure.

Also for the purpose of the present invention the term locking means shall include any means of locking via a padlock. However, the term is not limited to this definition. The term shall also extend to include any affixing and/or retaining apparatus such as a staple, a U-bolt, a pin, and the like.

According to one aspect of the present invention there is provided security means, said security means including a body, said body being adapted to accommodate a portion of the locking apparatus with which the security means is used and characterized by the security means providing a protective barrier limiting access to the portion of the locking apparatus accommodated thereby.

According to another aspect of the present invention there is provided security means substantially as described above wherein the body of the security means is substantially U-shaped in cross section.

According to another aspect of the present invention there is provided security means substantially as described above wherein the security means may be adapted for at least partial insertion into the body of the locking apparatus or surface with which the locking apparatus is used.

According to another aspect of the present invention there is provided security means substantially as described above wherein the security means optionally includes retaining portions to maintain the portion of the locking apparatus held within the security means in a preferred position.

According to another aspect of the present invention there is provided security means substantially as described above wherein the locking apparatus is a padlock and the security means accommodates the shackle of the padlock.

According to another aspect of the present invention there is provided security means substantially as described above wherein the locking apparatus is a single pin padlock and the security means accommodates the single pin of the padlock.

According to another aspect of the present invention there is provided security means substantially as described above wherein the locking apparatus includes at least a U-bolt, a staple or the like and the security means accommodates the body of the U-bolt, staple, or the like, within it.

Whilst the present invention is described herein with particular reference to the features and use of a shackle protector for the shackle of a padlock and the like, it should be appreciated that the invention may also be applicable to and/or be adapted for use in other situations.

In one preferred embodiment of the present invention, the security means, or shackle protector is configured to be substantially U-shaped, having a base and two sides extending from the base in a substantially perpendicular plane. The U-shaped shackle protector is adapted to fit within the internal arch formed by a padlock shackle. The internal base of the U-shaped shackle protector is positioned relative to the internal face of the padlock shackle, whilst the internal surface of each side of the U-shaped shackle protector is positioned relative to the front and rear face respectively, of the padlock shackle.

The dimensions of the shackle protector in terms of length, depth of the U-shaped channel or height of the sides of the shackle protector are determined by the dimensions of the padlock shackle. The sides of the shackle protector preferably extend to accommodate the shackle there within, yet in a close relationship.

Preferably, the distance between the internal surface of the shackle protector and the shackle itself is minimal to limit the ability to insert any apparatus to attempt to pry the shackle up out of the shackle protector or the padlock body.

In addition, the shackle protector is preferably made of cast stainless steel or titanium, chosen for strength and the inability to cut either with bolt cutters or hacksaw blades and the like. However, any suitably strong, durable material made be used.

Where the shackle protector is made from titanium the shackle protector may be thinner and also rounded to more appropriately complement the shape of the shackle. Where the shackle protector is made of cast stainless steel, the U-shape is substantially squarer and the body of the shackle protector may be thicker. Using cast stainless requires the appropriate stainless steel mix to be determined for maximum strength yet limited brittleness.

In one embodiment of the present invention, the shackle protector has open distal ends, such that the shackle protector is substantially U-shaped along its length. However, in other embodiments, one or both distal ends of the shackle protector may include a stop, or a foot. The stop/foot includes an aperture therethrough able to accommodate the shape of the shackle, such that an end of the shackle is substantially inserted through the stop. To achieve this, the padlock may require dismantling. Therefore, where the shackle protector is sold with a padlock, this embodiment may be preferred. Alternatively, where the shackle protector is retrofitted to a padlock, the embodiment without a stop may be the preferred option, although this is not exclusively the case, as the padlock may be taken to a lock smith and have the shackle protector fitted as required.

Apart from assisting to retain the shackle protector in place on the shackle, the stop/foot may also have advantages in preventing the shackle being vulnerable to cutting by a hacksaw blade at the point of entry of the shackle in to the lock body. To further minimize the likelihood of such tampering, the lock body may be modified to include an indentation adapted to accommodate the stop/foot. Alternatively, the padlock body may be adapted to include a raised complementarily configured portion with which the stop interacts to further secure the point of entry of the shackle in to the lock body (or surface, where the shackle protector is being used with alternative securing systems such as staple apparatus or U-bolt systems and the like).

The present invention is designed to provide a substantially tamper-proof, security means for a padlock or similar locking/retaining apparatus, thereby securing access to an area only by selected authorized individuals and to prevent access to the contents of the area by intruders, or the like.

The benefit of the use of the security means as opposed to a traditional padlock alone, is that the security means provides added security to the padlock (whether an expensive of cheaper version) over the use of traditional padlocks alone, which may be opened via the use of bolt cutters, hacksaw blades and so forth.

According to another aspect of the present invention, there is provided a method of manufacturing security means, said security means including a body, said body being adapted to accommodate a portion of the locking apparatus with which the security means is used and characterized by the security means providing a protective barrier limiting access to the portion of the locking apparatus accommodated thereby, said method including the steps of:
a) Casting a substantially U-shaped body of the security means, adapted to complement the shape of the portion of the locking means to be accommodated; and
b) Fitting the security means to the portion of the locking means to be accommodated.

According to another aspect of the present invention, there is provided a method of permanently adapting existing locking apparatus using security means said security means including a body, said body being adapted to accommodate a portion of the locking apparatus with which the security means is used and characterized by the security means providing a protective barrier limiting access to the portion of the locking apparatus accommodated thereby, said method including the steps of:
a) Dismantling the locking apparatus; and
b) Fitting the security means to the portion of the locking apparatus to be accommodated; and
c) Reassembling the locking apparatus to retain the security means thereon.

According to another aspect of the present invention, there is provided a method of temporarily adapting existing locking apparatus using security means said security means including a body, said body being adapted to accommodate a portion of the locking apparatus with which the security means is used and characterized by the security means providing a protective barrier limiting access to the portion of the locking apparatus accommodated thereby, said method including the steps of:
a) Fitting the security means to the portion of the locking apparatus to be accommodated, as and when required.

Variations to the dimensions of the security means may be desirable depending on the locking apparatus with which it is to be used. Regard would of course be had to effecting the desired dimensions, such as increased height or width whilst maintaining a durable, strong and substantially tamperproof means.

The present invention is differentiated from many existing products by virtue of at least its means of being retained in place on the shackle of the padlock, without the need for securing ties, chains or the like, which can be cut.

Whilst some varying embodiments of the present invention have been described, it should further be appreciated different embodiments, uses, and applications of the present invention also exist. An embodiment of the present invention will now be given by way of example only, to help better describe and define the present invention. However, describing the specified embodiment should not be seen as limiting the scope of this invention.

In yet another embodiment of the present invention where the security means is adapted as a security means for vehicles, in its operation it is an immobilising apparatus and as such can be used as a personal anti-theft wheel lock, or for parking control purposes.

The vehicle immobilising apparatus is configured to preferably fit all sizes of wheel—from those as small as a bicycle wheel or as large as a typical wheel/tyre on a truck. The invention may be used with trailers, cars and the like.

If preferred more than one vehicle immobilising apparatus can be used and applied—for example to the front and rear wheels of a vehicle. This is achieved as the apparatus is easy to store and handle.

According to one aspect of the present invention there is provided security means for securing and immobilising a vehicle against theft or removal, said security means includes a body, said body includes two interconnected, but spatially distanced bracing portions, the bracing portions being arranged at right angles to each other and each dimensioned to accommodate the width of a wheel, at least one of said bracing portions being adapted to receive locking apparatus.

According to another aspect of the present invention there is provided security means substantially as described above wherein the at least two bracing portions are each substantially U-shaped.

According to another aspect of the present invention there is provided security means substantially as described above wherein the locking apparatus includes a locking bar and a lock capable of receiving an appropriately configured portion of the locking bar therewithin.

According to another aspect of the present invention there is provided security means substantially as described above wherein the locking apparatus used to secure the security means includes a single pin lock.

According to another aspect of the present invention there is provided security means substantially as described above wherein the single pin lock is a single pin changeable combination lock.

According to another aspect of the present invention there is provided security means substantially as described above wherein the combination lock is retained within a receptacle relative to a portion of the first bracing means and the pin of the single pin changeable combination lock slides into the lock to effect a locked position of either or both the lock and the security means.

According to another aspect of the present invention there is provided a security container substantially as described above wherein a portion of the locking bar is adapted to interact with a portion of the bracing means and thereby prevent removal of the bracing means from a position where the bracing means is engaged with a wheel of a vehicle to a position where the locking bar is released from the bracing means, thereby enabling the security means to be removed from the wheel of the vehicle.

According to another aspect of the present invention there is provided security means substantially as described above wherein the combination of the single pin changeable combination lock is selectable and changeable to enable installation and removal of the security means, only by selected authorised individuals and/or for a preferred time duration.

According to another aspect of the present invention there is provided security means substantially as described above wherein the locking apparatus may include a single pin keyed locking apparatus.

According to another aspect of the present invention there is provided security means substantially as described above wherein the security means includes alarm means for alerting unauthorized removal of the vehicle or security means therefrom.

According to another aspect of the present invention there is provided security means substantially as described above wherein the alarm system is powered by an energy source, including at least one battery.

Preferably the immobilising apparatus includes a body which is comprised of several interacting parts. The body therefore includes at least two bracing portions. Each bracing portion is substantially U-shaped, although the configuration of the bracing portion is not limited to only this shape. A first bracing portion is configured to match the radius of the wheel with which the apparatus will be used. On installation the first bracing portion is fitted to sit over the top of the wheel and the sides of the U-shaped bracing apparatus extends down the side of the wheel to the centre of the wheel. Accordingly, there is the side member which is exposed on the exterior side surface of the wheel and the side member which is adjacent the interior side surface of the wheel.

The second bracing portion includes at least two extendable portions, an inner and outer portion, co-operating in a telescopic arrangement. The inner second bracing portion is adjacent to, is attached to and co-operates with the first bracing portion. The outer second bracing portion co-operates with the inner second bracing portion in a telescopic arrangement. Accordingly, the second bracing portion may be adjusted to accommodate the radius of a single wheel, or be extended to accommodate the radii of two adjacent wheels. The second bracing portion, as with the first bracing portion is configured to fit around the wheel. When installed in relation to the wheels, the second bracing portion is positioned in a plane substantially perpendicular to the plane of arrangement of the first bracing portion.

Either or both the inner and outer second bracing portions may include a stop means which is configured to limit the extension of the telescopic arrangement. In addition, either or both the inner and outer second bracing portions may include adjustment means in the form of a ratchet or other suitable means to enable the outer second bracing portion to be extended on to the distance required to accommodate the radius of a second wheel, or to adjust the second bracing portion to accommodate varyingly dimensioned wheels.

Preferably, the immobilising apparatus is made of metal and more preferably, the metal is stainless steel, due to its hard wearing durability and the difficulty involved in attempts to cut the stainless steel with bolt cutters or hacksaws.

The vehicle immobilising apparatus includes a preferred locking apparatus. The locking apparatus is preferably a single pin locking system. The single pin locking may be a single pin combination lock or a single pin keyed lock. The locking system is preferably a padlock arrangement into which the single pin is inserted instead of the double pin, or U-shaped shackle of typical padlocks. Nevertheless, the use of a single pin lock, does not mean that a standard padlocking system, or the use of a double pin option could not be adapted further for use with the invention.

For the purpose of this specification the term “pin” is used to describe any rod of substantially strong material which operates potentially as a key in a lock system. The pin is a locking pin which is accordingly slid into the lock body where it engages with mechanisms of the lock and is retained in position until released by means appropriate to opening the lock; whilst the term “combination” is used to describe and include a code, whether it be a system of numbers and/or letters, entered by means of push pad or tumbler systems, to release the locking pin and thus open the lock and provide access to the contents of the security container. The benefit of the use of a locking pin as opposed to a traditional key, is that the locking pin may be retained in place in the lock at all times and be engaged or disengaged from the lock to secure or open the lock as required, without the need for yet another separate key which needs to be made accessible, or may be lost. Such a system also has advantages over traditional padlocks, which may be opened via the use of bolt cutters, hacksaw blades and so forth.

Given the means to effect a change of the combination of the lock may be simply the removal and recalibration of the combination, it may be preferable that the features of the lock itself are utilised to enable the lock to be accessible and removed from the security container for such a purpose. Therefore, the internal spring mechanism of the lock which allows the locking pin to be released when the lock is unlocked, is used to assist removal of the lock from the container. Pressure applied to a portion of the exposed face of the lock effects operation of the lock's internal spring mechanism and pushes the lock partially out of the security container to enable an individual to grip the lock and then remove it. In other embodiments locking means without internal spring mechanisms may be used. In these embodiments a spring means may be included on the shaft of the single pin, to provide the spring mechanism to eject the lock from the body of the security container.

Preferably, the combination lock is located within a compartment allowing positioning of the combination lock. The compartment may be larger than the combination lock to enable the lock to be more easily installed and removed, or to be exchanged with a larger lock if required, or to enable a cap to be fitted to minimise ingress of water and dirt into the padlock area.

The side member of the first bracing portion, which is adjacent the interior side surface of the wheel, preferably includes a compartment or receptacle into which a padlock is able to be inserted. The receptacle may be configured to the shape of the padlock, or include insertable bulkheads which enables different padlocks of different shapes to be used with the invention. The receptacle apart from providing a means of retaining the padlock in an appropriate alignment during insertion of the locking pin, also serves to protect the padlock from dirt, weather effects and attempts that may be made to damage the padlock, if it were otherwise exposed.

Whilst described in this specification the single pin lock is encased in the container, it should be appreciated this does not limit the use of the lock to only encasement type applications. Typically locks are encased to minimise their vulnerability to interference by unapproved persons. The security container of the present invention benefits from having the lock internal of the container. However, the single pin lock may be manufactured to minimise any vulnerability inherent in currently available locks and as such might not require the lock to be encased for alternative applications.

In some preferred embodiments the padlock may include cap means as a moulded push fit cap, manufactured from any suitable material, such as rubber, plastics materials, plastic-glass combinations, metal with rubber components for sealing, to provide a sealed off arrangement when the padlock is in the locked position within the padlock retaining receptacle.

The advantage of the use of such locking apparatus, particularly the combination option, is that it allows for the removal of the immobilising apparatus by approved personnel only, yet allows the apparatus to be used by a range of individuals who can key in their own combination to allow removal of the immobilising apparatus by the particular individual alone. Further, where multiple immobilising apparatus are used on the one vehicle, the combination lock option enables each apparatus to be “keyed” alike.

In preferred embodiments, the first bracing portion includes apertures located towards the outer distal ends of the side member of the U-shaped first bracing portion. The aperture in the side member which is exposed on the exterior side surface of the wheel is proportionally larger than the aperture in the side member which is adjacent the interior side surface of the wheel. The larger aperture on the side member adjacent the exterior side surface of the wheel enables a locking bar to be inserted therethrough.

The locking bar is substantially elongate, having two distal ends. The inner distal end passes through the centre of the wheel and includes an extension in the shape of a pin—which serves as the locking pin of the locking apparatus. The aperture in the side member which is adjacent the interior side surface of the wheel is adapted to enable the locking pin extension to pass therethrough and into the padlock. The outer distal end is configured to include a cap. The cap is dimensioned to be bigger than the width of the locking bar, and as such serves to provide a pressure point and grip to enable the locking bar to be inserted through the wheel and the locking pin extension pressed home into the padlock of the locking apparatus.

Further, the keyed entry or combination tumblers of the lock may be included on or indented into the cap of the locking bar.

To facilitate guiding the locking pin of the locking bar through the aperture on the side member adjacent the interior side surface of the wheel and into the padlock, the side member which is adjacent the interior side surface of the wheel also includes alignment or guide means.

The locking pin must be appropriately aligned with the lock to ensure appropriate locking of the immobilising apparatus. Lateral movement of the pin may make the alignment process less direct and may cause wear in the shaft of the pin. Accordingly, at least one alignment/guide means acts as positional guides to ensure that the pin is appropriately guided to engage with the lock.

The locking bar may also serve as a pivoting means when the immobilising apparatus is not installed on a vehicle. In this regard, the locking bar enables the first bracing portion to be folded down relative to the second bracing portion, for ease of storage and carrying.

The immobilising apparatus is therefore, simple to operate, is secured with a push lock and is easily installed and removed in seconds. It is built from solid stainless steel or other solid metal, which may be powder coated for added protection from the weather, as opposed to steel tubing, the integrity of which may be compromised by unauthorized persons using bolt cutters or hacksaws.

In some embodiments, for further deterrent effect, the immobilising apparatus may include a motion detection alarm, which is activated in the event attempts are made to move the vehicle while the immobilising apparatus is present.

According to one aspect of the present invention, there is provided a method of manufacturing security means for securing and immobilising a vehicle against theft or removal, said security means includes a body, said body including two interconnected, but spatially distanced bracing portions, the bracing portions being arranged at right angles to each other in operation and each dimensioned to accommodate the width of a wheel, at least one of said bracing portions being adapted to receive locking apparatus.

According to another aspect of the present invention, there is provided a method of securing a vehicle against unauthorized removal via the use of security means for securing and immobilising said vehicle, said security means includes a body, said body includes two interconnected, but spatially distanced bracing portions, the bracing portions being arranged at right angles to each other and each dimensioned to accommodate the width of a wheel, at least one of said bracing portions being adapted to receive locking apparatus.

According to another aspect of the present invention, there is provided a method of a locking security means for securing and immobilising a vehicle against theft or removal, said security means includes a body, said body includes two interconnected, but spatially distanced bracing portions, the bracing portions being arranged at right angles to each other and each dimensioned to accommodate the width of a wheel, at least one of said bracing portions being adapted to receive locking apparatus.

Variations to the dimensions of the security means may be desirable depending on the vehicle wheels with which it is to be used. Regard would of course be had to effecting the desired dimensions, such as increased height or width.

The present invention is differentiated from many existing products by virtue of at least its locking means.

The present invention provides for secure containment of the vehicle. The security means is a robust system which makes removal of the vehicle difficult for unauthorised individuals. Authorised personnel may obtain access by knowing the code combination, or by having a key, or by providing others with the code via a security telephone call.

In addition, it should also be appreciated that given the emphasis on security, the present invention may be interconnected with the vehicle's security alarm system, so in the event that the security means should be tampered with, the vehicle's alarm system would be activated. There is a range of alarm systems available in the market and prior art. The present invention may be adapted for use with said alarm systems. However, it will be appreciated by a person skilled in the art that the adaptations and interconnections required may vary between alarm systems and whilst known to a person skilled in the art, such detail of prior art alarm systems is not within the ambit of the present specification.

It should further be appreciated a variety of different embodiments, uses, and applications of the present invention therefore exist, even within the ambit of the above described security system. An embodiment of the present invention will now be given by way of example only, to help better describe and define the present invention. However, describing the specified embodiment should not be seen as limiting the scope of this invention.

In yet a further embodiment of the present invention, where it is used for securing containers, a container may be defined as container provided with enclosing means for storing or transporting articles/goods. Locks are typically installed on containers to ensure against theft of the articles contained within the container. However, whilst locks may be a deterrent to accessing the contents of a container, they do nothing to prevent removal of the entire container, contents and all. Given the cost involved with not only the goods inside the container, but of the container itself, there is a clear need to apply security means that operate to minimize or prevent the theft of containers per se.

The security means of the present application is envisaged to be used for securing the container against theft. The security means provides a temporary fixed option on the actual container that provides a secure and convenient solution.

It is with the above mentioned problems of the industry and the lack of appropriate prior art systems in mind, that the present invention has been designed. Where the onus is on the contracted service provider to ensure the security of the container and/or its contents when delivered, it is also in relation to the needs of this industry that the present invention is also directed to.

As the present application includes a security means adapted for use with such containers, it envisaged the present description as it relates to the use of the security means with cartage containers, is but one application of the security means. Accordingly, the security means may be used with, or adapted for use with a range of security containers, cartage containers or cartage systems, enclosed areas and so forth.

According to one aspect of the present invention there is provided security means, said security means including locking apparatus said locking apparatus having a body and at least one locking pin adapted to engage with said body, said security means also including frame means and associated therewith bracing means, said body of the locking apparatus adapted to co-operate with said bracing means to splay the bracing means such that the bracing means brace against the interior of the surface with which the security means is used, to tighten the security means relative to said surface when the locking apparatus is engaged and locked.

According to one aspect of the present invention there is provided security means for use as an anti-theft device for cartage containers, said security container including a body, said body having engagement means adapted to co-operate with structural features of a container to block access to lifting apertures of the container, and said security means also including locking means, said locking means being received into a recess within the body of the security means and removable therefrom to effect release of the engagement means from the container to effect the ability to transport the container via the use of lifting apparatus.

According to another aspect of the present invention there is provided security means substantially as described above wherein the engagement means includes hook means to maintain the security means within the lifting apertures of the container and in addition block the lifting apertures to prevent access thereto by lifting apparatus.

According to another aspect of the present invention there is provided security means substantially as described above wherein the locking apparatus of the security means includes a padlock.

According to another aspect of the present invention there is provided security means substantially as described above wherein the padlock is a changeable combination lock.

According to another aspect of the present invention there is provided security means substantially as described above wherein the locking means includes a single pin of a single pin changeable combination lock, such that the single pin is fixed to an interior surface of the frame of the security means and the body of the single pin changeable combination lock slides onto the fixed pin to effect a locked position of either or both the lock and the security means within the body and/or relative to the container.

According to another aspect of the present invention there is provided a security means substantially as described above wherein the locking means includes a single pin of a single pin key lock, such that the single pin is fixed to an interior surface of the frame of the security means and the body of the single pin key lock slides onto the fixed pin to effect a locked position of either or both the lock and the security means within the body and/or relative to the container.

According to another aspect of the present invention there is provided a security means substantially as described above wherein locking means is enclosed by the frame of the security means.

According to another aspect of the present invention there is provided a security means substantially as described above wherein a portion of the locking means is adapted to interact with a portion of the container.

According to another aspect of the present invention there is provided a security means substantially as described above wherein a portion of the locking means is adapted to interact with an outer portion of the security means positioned adjacent and parallel to a wall of the container.

According to another aspect of the present invention there is provided a security means substantially as described above wherein a portion of the locking means is adapted to interact with exterior plate means of the security means.

According to another aspect of the present invention there is provided a security means substantially as described above wherein the exterior plate means of the security means positioned adjacent and parallel to a wall of the container is recessed to accommodate an exposed portion of the locking apparatus, but to inset it within the outer portion.

According to another aspect of the present invention there is provided a security means substantially as described above wherein the combination of the lock is selectable and changeable to enable release of the security means from the container, only by selected authorised individuals at a preferred time.

According to another aspect of the present invention there is provided a security container substantially as described above wherein the bracing means, includes at least a spring splaying system, a cam splaying system, a disc splaying system.

According to another aspect of the present invention, there is provided security means substantially as described above, wherein the frame of the security means includes an engaging portion to engage with a portion of the locking apparatus, to minimize movement thereof, or ability to force the locking apparatus out of the security means when the locking apparatus is locked.

According to another aspect of the present invention, there is provided security means substantially as described above wherein the security means optionally includes a securing plate.

According to another aspect of the present invention, there is provided security means substantially as described above wherein the securing plate is adapted to engage with a portion of the security means and/or an internal surface of the container.

According to another aspect of the present invention, there is provided security means substantially as described above wherein said securing plate is adapted to engage with the security means by at least one of a tapered, screw-threaded, bayonet—configured.

According to another aspect of the present invention, there is provided security means substantially as described above wherein said securing plate includes an aperture adapted to accommodate a tool or the user's fingers to rotate the securing plate and tighten it against the portion of the security means, or internal surface of the container.

According to another aspect of the present invention, there is provided security means substantially as described above wherein when said securing plate is secured in place, the aperture is adapted to receive the lock body of the locking apparatus to secure the locking apparatus in place within the security means.

Whilst the present invention is described herein with particular reference to the features and use of an external substantially tamper-proof security means for preventing access by lifting apparatus to the lifting apertures of a container, it should be appreciated that the invention may also be applicable to and/or be adapted for use in other situations where required.

In one preferred embodiment of the present invention, the security means includes at least one engagement means. The engagement means is in the form of a substantially planar, right-angled faceplate which fits on to a corner of a container. The arrangement is such that one portion of the right angled face plate is positioned against the exterior of one wall of the container, whilst the other portion of the right-angled face plate is positioned against the exterior surface of the adjacent, abutting wall of the container.

At one end of the right angled plate and on the interior surface thereof there is included at least one hook means. In one preferred embodiment there are two hook means. It should be appreciated however, that the number, configuration and placement of the hook means may vary as required to be inserted in through the lifting aperture(s) of a cartage container.

The hook means are adapted to fit through the lifting apertures of the container and effectively engage or grip against the interior surface of a wall of the container.

To secure the engagement means in place and to prevent removal of them from the lifting aperture of the container, the opposite distal end of the right-angled plate includes an aperture adapted to receive locking apparatus of the security means.

The aperture preferably includes a recessed portion such that when the body of the locking apparatus is inserted therethrough, the external exposed end of the lock body is indented relative to the plate to minimize the ability to use a pry tool on the lock.

The locking apparatus of one embodiment of the present application includes a padlock. The padlock may include a standard U-shaped shackle, or be include an adapted single pin system. In the former, the shackle remains in association with the padlock, in the latter the single pin is preferably adapted to be secured within the security means and engages the padlock body only when the locking apparatus is secured locked.

The security means of preferred embodiments includes a frame. The frame of the security means is adapted to be located relative to an internal or interior surface of the container. The frame is adapted to include at least bracing means, guide means, at least one engaging portion, and in some embodiments pivotable closure means.

The guide means and the engaging portion(s) of the frame are adapted to cooperate with the locking apparatus. For example, the guide means is used to guide the padlock/lock body to the correct alignment within the security means. Where the locking system is a single pin system, the guide means serves to align the single pin with the lock body to enable the lock to be locked.

At least one engaging portion is adapted to engage with a portion of either or both the lock shackle or pin and the lock body, to minimize movement of the lock when in place and locked.

The bracing means of preferred embodiments includes splaying apparatus. For example, the splaying apparatus may be a spring, cam or disc system. In operation, during locking of the security means, the splaying apparatus co-operates with the lock body. As the lock body is inserted through the aperture in the right-angled plate portion, the width of the lock body applies pressure to spring formed arms, cams or to discs which are attached to the frame. The number, type and arrangement of the splaying apparatus may vary between embodiments or applications. However, in operation, the splaying apparatus is adapted to splay against the internal or interior surface of the structure (container) with which the securing means is used. The splaying apparatus thereby exerts tension against the interior or internal surface and effectively contributes to clamping the security means in place when the locking apparatus is secured in a closed position.

Accordingly, when the security means is in place on a container, the engagement means of the right-angled plate is secured through the lifting apertures of the container. The internal or interior portions of the security means are positioned relative to the aperture on the opposite distal end of the right-angled plate and as such are thereby in place to receive the lock body inserted therethrough. The lock body when inserted is guided by the guiding apparatus of the frame to ensure it appropriately engages with the locking pin or the shackle. The lock body is then forced against the frame of the security means to apply pressure to push the shackle/pin of the lock into the lock body to effect the locked arrangement. In doing so, the splaying apparatus are forced outwards and against the interior or internal surface of the container wall. The engaging portion of the frame is positioned relative to the shackle, pin or lock body and thus minimizes any movement of the lock body within the security means. The external portion of the lock body includes the combination or keyed access point, but this region is indented due to provision of a recessed aperture of the right-angled plate, to minimize attempt to pry out the lock body.

In embodiments, such at that described with reference to the application of the security means to a container as a container anti-theft device, the internal components of the security means—being the frame, splaying apparatus and so forth, are encased in container means. Preferably the container means is made of strong, durable materials, such as stainless steel which contributes to the tamperproof quality of the security means. A similar arrangement may be employed where the security means is applied to a gate, door, or other access point to an area. Where the security means is used in applications such as in safes, security containers, and the like, the internal components of the security means may be encased in container means, or may be simply fitted to the back of the door or opening means.

In yet another preferred embodiment of the present invention, the security means optionally includes a securing plate. The securing plate is adapted to engage with a portion of the security means and/or an internal surface of the container and may be at least one of a tapered, screw-threaded, bayonet—configured to enable such engagement.

Preferably, the securing plate includes an aperture adapted to accommodate a tool or the user's fingers to rotate the securing plate and tighten it against the portion of the security means, or internal surface of the container.

When said securing plate is secured in place, the aperture is adapted to receive the lock body of the locking apparatus to secure the locking apparatus in place within the security means.

In preferred embodiments of the present invention, the locking means includes a padlock or a single pin lock and more preferably a combination lock. However, keyed locking systems are also relevant and may be used.

Preferably, as the combination (or key entry) portion of the lock is located externally of the container a cap may be fitted over the combination tumblers etc to minimise ingress of water and dirt into the tumblers/key aperture. The cover would also serve to obscure the combination lock feature from being easily seen.

The compartment and the position of the lock are such that only the tumbler portion of the lock is accessible on the exterior of the security container. Therefore, to enable the combination of the lock to be changed as required, the lock may be removed from its compartment, the combination reselected and the combination lock is then returned to its compartment in the security container.

Given the means to effect a change of the combination of the lock may be simply the removal and recalibration of the combination, it again may be preferable that the features of the lock itself are utilised to enable the lock to be accessible and removed from the security container for such a purpose. Therefore, the internal spring mechanism of the lock which allows the locking pin/shackle to be released when the lock is unlocked, is used to assist removal of the lock from the container. Pressure applied to a portion of the exposed face of the lock effects operation of the lock's internal spring mechanism and pushes the lock partially out of the security means to enable an individual to grip the lock and then remove it.

In other embodiments locking means without internal spring mechanisms may be used. In these embodiments a spring means may be included on the shaft of the single pin, to provide the spring mechanism to eject the lock from the body of the security container.

Removal of the lock is also essential to the ability to open the security means. For, in preferred embodiments of the present invention, the security means includes bracing means which acts against the interior surface of the container wall. When the locking means is in place, the bracing portion abuts the interior of the container preventing movement of the security means as a whole. When the lock is removed, so is the retaining pressure on the interior surface of the container wall.

In the alternative embodiment described herein, release of the security means is further effected by inserting a finger or tool through the aperture in the right angled plate and the securing plate when the lock has been removed. The individual can then unscrew or loosen the securing plate, releasing its containment hold on the rear/interior wall of the container and enabling the security means to be opened/removed.

The locking pin must be appropriately aligned with the combination lock to ensure appropriate locking of the security container. Lateral movement of the pin makes the alignment process less direct and may cause wear in the shaft of the pin. Accordingly, at least one alignment means or bulkhead acting as positional guides may be included within the security means to ensure that the lock is appropriately located and held in position and guided to engage with the single locking pin.

In the embodiment described in which a full shackle and padlock are employed, the padlock may be inserted any way up. Whilst this ability may be demonstrated with a single fixed pin scenario, allowance may need to be made that where the locking pin is fixed to the internal frame of the body, alignment means may need to be configured to ensure the locking pin may only enter the combination lock in one orientation and with little allowance for lateral movement of the pin.

In all embodiments however, a realizable benefit of the present invention is that as the lock is substantially enclosed, no portion of the shaft of the locking pin, or the padlock shackle, is exposed to the potential of being cut with a hacksaw blade or similar. This operates to frustrate any attempts at unlawful or unapproved removal of or entry to the container.

In the present invention the arrangement of the security means within containing means, along with the lock being substantially indented, prevents any lateral pressure being applied to the locking means. Any pressure is simply applied to the external body, or the right-angled plate. In addition, it is the splayed locking means that retains the security means in a closed position and this is maintained by pressure applied by the splaying apparatus when the locking means when inserted in to the body. Therefore, pressure applied externally would do little to impact on the integrity of the locking system of the security means.

There is preferably provision in the lock encasement to a means by which the combination of the lock may be changed. For example, a key or screw may be required to be released. The combination tumblers may then be reset to a new entry combination. Once this has been achieved, the screw or key is returned to its original positions and the new combination is set. Various systems for changing the combination are however available and may be used with, or adapted for use with, the single pin changeable combination lock of the present invention.

As previously discussed, the security means is made of strong, durable materials, such as stainless steel. However, the finish on the container and exposed features of the security means, such as the colour, texture and so forth may be varied. There are also no limitations other than those imposed for practical, aesthetic, or economic reasons on the size dimensions, profile, shape and so forth of the security container.

It is also relevant to note that where the security means is to be used in relation to cartage containers, the security means is adapted to be fitted to both right, and/or left-handed corners of the container.

In addition, where the above description relates to the use of the security means for existing containers, it should be appreciated that security means may be customised to specific container designs and be permanently, instead of temporarily fitted. In the case of a permanently fitted option, the security means includes and internal pivoting portion, which essentially closes off the lifting apertures of the container when the lock is in place, yet can pivot open when the lock is removed and thereby make the lifting apertures available. The latter embodiment obviates the need to fit the security means to the container every time it is require. Rather, as a permanently fitted option, the only requirement is the insertion of the lock body.

According to another aspect of the present invention, there is provided a method of manufacturing security means, said security means including locking apparatus said locking apparatus having a body and at least one locking pin adapted to engage with said body, said security means also including frame means and associated therewith bracing means, said body of the locking apparatus adapted to cooperate with said bracing means to splay the bracing means such that the bracing means brace against the interior of the surface with which the security means is used, to tighten the security means relative to said surface when the locking apparatus is engaged and locked.

According to another aspect of the present invention, there is provided a method of providing security to a container using security means as an anti-theft device for cartage containers, said security container including a body, said body having engagement means adapted to co-operate with structural features of a container to block access to lifting apertures of the container, and said security means also including locking means, said locking means being received into a recess within the body of the security means and removable therefrom to effect release of the engagement means from the container to effect the ability to transport the container via the use of lifting apparatus.

According to one embodiment of the present invention there is provided locking apparatus for use with security means.

Variations to the dimensions of the security means may be desirable depending on the container with which the invention is used and whether the security means is to be fitted to a left-hand or right hand position for access to the lifting apertures adjacent the corner of a container. Regard would of course be bad to effecting the desired dimensions, such as increased height or width.

The present invention is differentiated from many existing products by virtue of at least its engagement means and its locking means. The present invention provides for secure containment of a container. The security means is a robust system which makes transportation of the container difficult for unauthorised individuals. Authorised personnel may obtain access by knowing the code combination, having a key, or by having a means to give or obtain the code via a security telephone call.

It should be appreciated that the present invention whether as the security means, or even in relation to the locking apparatus alone, lends itself to more than one application. Hence, the invention may be adapted through a change to one or more, or a combination, of any container structural feature, dimensions, security compartments, and so forth. As can be appreciated variations to and from the above described embodiments may be made without deviating from the scope of the present invention. The invention may also be adapted to include or co-operate in conjunction with an alarm system which may be triggered if attempts are made to tamper with the security means, or attempt movement of the container.

It should further be appreciated a variety of different embodiments, uses, and applications of the present invention therefore exist, even within the ambit of the above described security container system.

An embodiment of the present invention will now be given by way of example only, to help better describe and define the present invention. However, describing the specified embodiment should not be seen as limiting the scope of this invention.

### BRIEF DESCRIPTION OF DRAWINGS

Further aspects of the present invention will become apparent from the following description, given by way of example only and with reference to the accompanying drawings in which:

FIG. 1 is a side perspective view of the security container with the door removed in accordance with one preferred embodiment of the present invention; and

FIG. 2 is a top view of the security container of FIG. 1 in accordance with that preferred embodiment of the present invention, but with the door in place; and

FIG. 3 is a front view of the security container of FIG. 1 in accordance with that preferred embodiment of the present invention, but with the door removed; and

FIG. 4 is a right hand side view showing the locking system of FIG. 1 incorporated within the security container, along with two forms of bracing means in accordance with a preferred embodiment of the present invention; and

FIG. 5a is a side view of the door of the security container of FIG. 1 in accordance with that preferred embodiment of the present invention; and

FIG. 5b is a front view of the door of the security container of FIG. 1 in accordance with that preferred embodiment of the present invention; and

FIG. 6 is a front view of the security means for latching apparatus with the handle of the latching apparatus secured in accordance with one preferred embodiment of the present invention; and

FIG. 7 is a top plan view of security means for latching apparatus of FIG. 6 in accordance with that preferred embodiment of the present invention; and

FIG. 8 is a bottom plan view of security means for latching apparatus of FIG. 6 in accordance with that preferred embodiment; and

FIG. 9 is a longitudinal cross-sectional side view showing the locking system of FIG. 6 incorporated within the containing means, along with the pin of the locking means secured into the body of the locking means in accordance with a preferred embodiment of the present invention; and

FIG. 10 is a side plan view of the security means for latching apparatus of the embodiment of FIG. 6 in accordance with that preferred embodiment of the present invention; and

FIG. 11 is a back view of the security means for latching apparatus with the handle of the latching apparatus secured in accordance with one preferred embodiment of the present invention; and

FIG. 12 is a side perspective view of security means for latching apparatus of FIG. 11 in accordance with that preferred embodiment of the present invention; and

FIG. 13 is a bottom perspective view of security means for latching apparatus of FIG. 11 in accordance with that preferred embodiment; and

FIG. 14 is a back view showing the locking system of FIG. 11 incorporated within the containing means, along with the pin of the locking means secured into the body of the locking means in accordance with a preferred embodiment of the present invention; and

FIG. 15 is a back view of the security means for latching apparatus of another embodiment without a profile cut into the container means to accommodate a handle and such like of the latching means as illustrated in FIG. 11.

FIG. 16 is a top perspective view of the security means for latching apparatus of the embodiment of FIG. 15, in accordance with that preferred embodiment of the present invention; and

FIG. 17 is a diagrammatic view of another embodiment of the security means for latching apparatus having a single through bolt locking system including one or more of a socket to receive the bolt, a bolt guide means, a locking aperture, as falls within the ambit of the present invention; and

FIG. 18 is a cross-sectional longitudinal side view of the security container in accordance with one preferred embodiment of the present invention; and

FIG. 19 is a side view of the container means, or drawer, of FIG. 18 in accordance with that preferred embodiment of the present invention; and

FIG. 20 is a cross-sectional end view of the security container of FIG. 18 in accordance with that preferred embodiment of the present invention; and

FIGS. 21a, b are cross-sectional views of the security container drawer and the security container, including switching means for any one or more of a vehicle alarm system, a vehicle immobilising system, a vehicle ignition system, in accordance with another preferred embodiment of the present invention; and

FIG. 22a-c are side views of the security means in various stages of a padlock being opened, in accordance with one preferred embodiment of the present invention; and

FIG. 23a-d are a cross-sectional view, a bottom view, a front view and a side view of the security means, respectively, of FIG. 22 in accordance with that preferred embodiment of the present invention; and

FIG. 24a-c are side views of the security means in various stages of a padlock being opened, in accordance with another preferred embodiment of the present invention; and

FIGS. 25a-d are a cross-sectional view, a bottom view, a front view and a side view of the security means, respectively, of FIG. 24 in accordance with that preferred embodiment of the present invention; and

FIG. 26a-c are alternative views of the security means in accordance with other preferred embodiments of the present invention; and

FIG. 27 is an exploded perspective view of the security means in accordance with one preferred embodiment of the present invention; and

FIG. 28 is an assembled perspective view of the security means of FIG. 27 in accordance with that preferred embodiment of the present invention; and

FIG. 29a-c are a top plan view, a side view and a front end view, respectively, of the security means of FIG. 27 in accordance with that preferred embodiment of the present invention; and

FIG. 30 is a top plan view of the security means in accordance with one preferred embodiment of the present invention; and

FIG. 31 is a rear plan view of the security means of FIG. 30 in accordance with that preferred embodiment of the present invention; and

FIG. 32 is a side view of the security container of FIG. 30 in accordance with that preferred embodiment of the present invention.

### BEST MODES FOR CARRYING OUT THE INVENTION

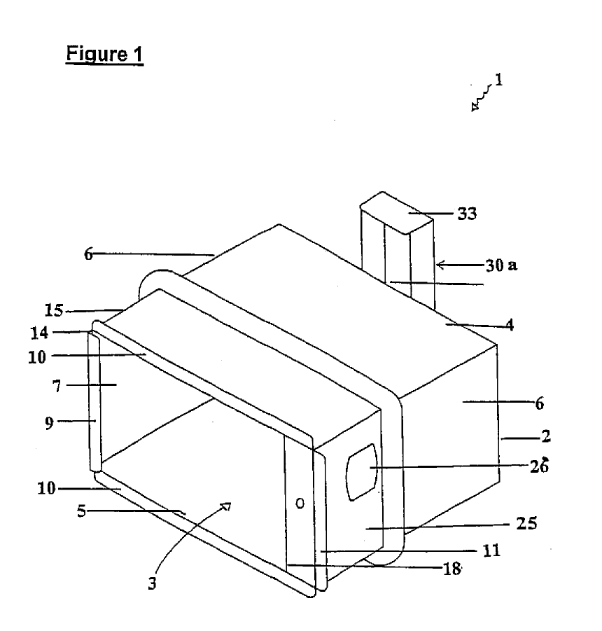

With reference to the diagrams (FIGS. 1 to 5b) by way of example only, there is provided a permanently fitted security container (generally indicated by arrow (1)). Whilst in this description the permanently fitted security container is described and referenced for use with keys primarily, it should be appreciated this invention may have applications outside this field and be used for other valuables including money, access codes and so forth.

The security container includes at least one container means 2 having an interior 3 for storing valuables therein. The interior 3 of the container means is defined by two opposed and spaced apart parallel planar surfaces which form a top surface 4 and a bottom surface 5, at least two permanent surfaces substantially at right angles to the top and bottom surfaces forming the enclosing sides 6 of the container means, and at least one exposed surface comprising an opening 7 and being configured to provide access to the interior 3 of the container means 2. Whilst the container means 2 of the preferred embodiment described herein is substantially a rectangular compartment, it should also be appreciated that the container means may take other configurations.

Whilst the embodiment as shown in FIGS. 1 to 5b illustrate one opening 7, it should be appreciated that in other embodiments there may be more than one opening to enable access to the contents of the security container from either or both the exterior and the interior of a building, or access to two compartments from the either or both the exterior and the interior of a building.

The container means has a removable closure means 8 covering the opening 7 into the container means 2. The closure means 8 is configured to engage with the edges 9, 10 and 11 of the container means 2 adjacent to the opening 7. The closure means 8 is capable of operating between an opened and a closed orientation.

In the illustrated embodiment, the closure means is a sliding door 8. The door is configured to be substantially planar and include around at least two of its sides a U-shaped bend 12 into which a portion of the exposed edges 10 of the container means slides. The front leading end of the door 13 (as it is closing the opening) is substantially flat, but slides into a U-shaped track 14 created by a portion of a side wall 15 of the container means 2. The fit of the door relative to the container means is substantially tight enough to allow the door to slide opened and closed, but allows little leeway for a tool or pry bar to pry the door from the container means.

Locking means 16 are included to secure the closure means 8 over the opening 7. The preferred locking means includes a pin-combination lock, generally indicated by arrow 17. The combination of the pin-combination lock is selectable and changeable to enable access to the interior of the container means and the valuables therein, only by selected individuals for a preferred time duration, after which the combination to access the container can be changed.

In the illustrated embodiment the combination lock 17 is an independent lock located within a compartment 18 inside the container means interior 3. To enable the combination of the lock to be changed as required, the lock 17 is removable from its compartment 18, the combination reselected and the combination lock is then returned to its compartment 18 in the security container 1.

Firm retention of the lock is important to ensure the locking pin 19 of the pin-combination lock 17 can be aligned with and inserted into the complementary aperture 20 in the combination lock 17 itself Movement of the combination lock may cause the pin 19 to become bent and reduce both the effectiveness and the life of the pin-combination lock. Therefore, at least one packing member 21 may be used between the combination lock and the body of the container means 2 to ensure the lock 17 is firmly held in position within the compartment 18. Removal of the packing member 21 to enable removal of the lock 17 may be achieved via the use of a specialist tool.

The door of the security container preferably includes an aperture 22 to enable the locking pin 19 of the pin-combination lock to pass through the door 8 and into the combination lock, in order to secure the door 8 in its closed and locked position. Affixed to the door 8 in a permanent arrangement is alignment means 23 configured to ensure the locking pin 19 may only enter the combination lock in one orientation and with little allowance for lateral movement of the pin 19. The alignment means also includes an indentation 24 which means that no portion of the shaft of the locking pin 19 adjacent the door aperture 22, is exposed to the potential of being cut with a hacksaw blade or similar. Accordingly, the lower portion of the head of the locking pin is recessed into the alignment means 23.

To enable the security container to operate effectively, the pin-combination lock preferably allows a variety of combination options to be used to open the security container, as allowed. In the illustrated example a tumbler combination is used. However, this does not limit the use of other combination systems, provided they are compatible with the overall concept of a pin-combination lock as herein described.

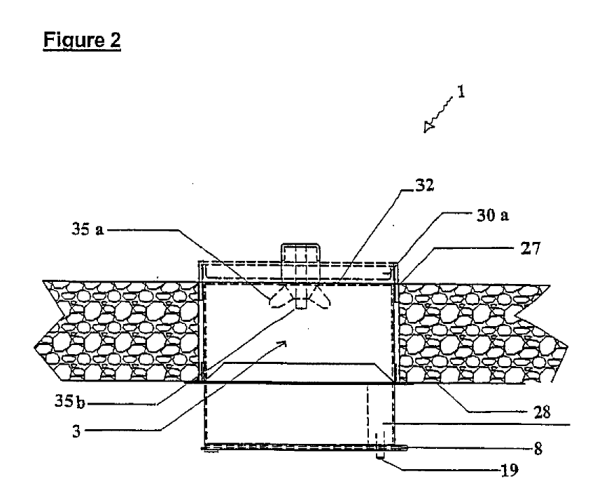

To access the combination tumblers from the side 25 of the container, the security container may be spaced from the surface of the external structure of the building as shown in FIGS. 1 and 2 and an aperture 26 is included through which the tumblers of the combination lock are accessible for selection to open the lock and access the container.

Whilst not shown, a pivoting cover may be attached to the security container to cover that combination feature and to prevent ingress of rain into the combination tumblers. The cover would also serve to obscure the combination lock feature from being easily seen.

The security container herein described has preferable application in new buildings, or in existing buildings where there may be some installation adaptations to be made to the building to retain the container. However, typically any building, or situation where there is a need for a security container for valuables may potentially benefit from the invention. The security container as illustrated is therefore configured to be fitted into a recess 27 within a surface 28.

Accordingly, the security container further includes retention means. In turn, the retention means includes bracing means 30 and fixing means 31, such as screws, bolts, nails. The bracing means 30 operate to effect a brace relative to one or more permanent structural features associated with the surface or building structure to impede forced removal of the security container from the recess 27. The bracing means may be moveable, such as rotatable as for the bracing means 30a, or be a plate bracing means 30b as illustrated in FIG. 4.

The plate bracing means 30b is substantially angled as a right angled plate bracing means. One portion of the right angled plate is configured to cooperate with the means for attaching the plate to the container. Accordingly, at least one aperture is included in the plate through which a shaft of a bolt may pass. The threaded end of the bolt is located inside the container and a wing nut is used to tighten the plate against movement relative to the container.

The opposite portion of the right angled plate is contoured to include a raised portion. Included in the raised portion is at least one aperture to enable the shaft of retaining means such as an anchor pin 31 to pass through the plate aperture.

The bracing plate is also configured to include gripping anchor portions on the face of the plate adjacent to the structural framework on which the bracing means is positioned (not shown) The bracing plate also may include sections which when hit by a hammer or the like enables the gripping anchor portions and/or the anchor pins 31 to be driven into the framework (of the wall) against which it is sitting. The gripping anchor portions bind into the structural framework and negate the ability for free movement of the plate and the container to which it is attached.

The anchor pin 31 may be any suitable pinning or retaining means. However the attachment of the bracing means to the container and to the framework of the building provides a brace against attempts to pry the container out of the wall.

The additional fixing means 31 further assist with retention of the security container as required, to limit lateral movement and so forth. In the illustrated embodiment FIG. 4, the fixing means is an anchor pin, such as screws, bolts, nails, as are available in the prior art. Provision may be made for the surfaces of the container means to include apertures through which such additional fixing means can threaded and secured into adjacent structural features, such as the wooden framing members of the building, or adjacent bricks, and the like.

The moveable bracing means 30a is moveable and operates between a storage position as Shown in FIG. 2 to enable insertion of the security container into the recess 27, and a bracing position as shown in FIGS. 1, 3 and 4 after insertion of the security container into the recess for effecting a brace against one or more permanent structural features associated with the surface, or with specifically installed engaging members, to impede forced removal of the installed security container from the recess.

In this described embodiment of the present invention the bracing means are attached to the rear surface 32 of the security container means 2. Whilst a number of options of forms of bracing means has previously been described, the option illustrated in the accompanying figures incorporates a pivoting tyne arrangement 30a and a plate bracing means 30b.

The tyne bracing means 30a lies substantially adjacent and parallel to the surface to which it is affixed before insertion of the security container into the recess 27. The dimensions of the tyne are slightly longer than the surface to which it is attached. The tyne also includes gripping means 33 at each of its distal ends. The gripping means of this embodiment are substantially angular portions 33 extending substantially perpendicular from the planar surface of the remaining body 34 of the tyne.

When the security container is positioned within the recess 27, the tyne 30 is pivoted clockwise or anti-clockwise, through an arc of up to 90 degrees, such that the distal ends of the tyne extend above and below the rear, top and bottom surface of the container means to which it is attached. The degree of pivoting required is dependent on the structural features surrounding the security container.

Pivoting of the tynes may be controlled from within the container means and such control is only available when the security container is open. The tynes are operated via the use of adjustment means 35 which, in the present example includes a wing nut 35a and a bolt 35b. The wing nut is loosened and the bolt gripped by the fingers and turned as required to move the tyne's distal ends into position.

The bracing tynes are designed to pass behind such building structures as the timber framing, or adjacent bricks, and brace against these structures to impede removal of the security container from the recess when the container is locked. Preferably, the bracing means co-operate with at least two members of the building frame, or portions of the building cladding. In some instances there may be a need to drill or cut grooves or channels into the framing and such like to receive the tynes.

Alternatively, engaging members as previously mentioned, may be specifically installed to ensure there are appropriate bracing surfaces available. This may be a preferred option where the structural frameworks of the building does not provide adequate, enough, or available bracing surfaces. It is such a bracing feature that serves to provide improved retention of the security container in the recess, over prior art security container systems.

When the security container is fitted into a recess within a surface, the security container is preferably configured to complement the features of the surface. As can be appreciated the dimensions of the container means is variable, but preferably dictated by the preferred placement of the security container in use. Accordingly, any recess cut or prepared for the security container is preferably equivalent to the height dimensions of the exterior cladding and the depth dimensions of the building's structural walls.

For example, the security container may be the dimensions of a standard brick and be installed into the building's exterior by removal of a brick from the wall of the building, which is replaced by the security container in a snug fit. Where the exterior cladding is comprised of wooden or artificial weather boards, the security container may be the dimensions of height of the weatherboard and be installed into the building's exterior by cutting out a piece of weatherboard to the required dimensions and installing the security container into the recess created.

To more particularly ensure the security container complements the features of the surface into which the security container is installed, the external configuration of the security container may be designed to reflect the features of the surface. For example, the structural shape of the door of the security container may be made to actually look like a brick, a piece of weatherboard, a stucco surface effect, or whatever may be required. Whilst the cost of physically configuring the external surfaces of the security container is an option, a cheaper alternative may be the use of painted features which mimic the surrounding surface features in terms of pattern, colour, finish, effect.

Whilst the present invention may be differentiated from many existing products by virtue of either or both its retention means and its locking means, the method of manufacture of the security container from rectangular stainless steel sections or as a punch moulded unit also improves the strength of the container, as there are minimal or no welded joints which have the potential to weaken the structure. Further, the container is durable and weather resistant.

In addition, whilst not illustrated in the attached figures, given the emphasis on security, the present invention may be interconnected with the building's security alarm system, so in the event that the security container should be tampered with, the building's alarm system would be activated.

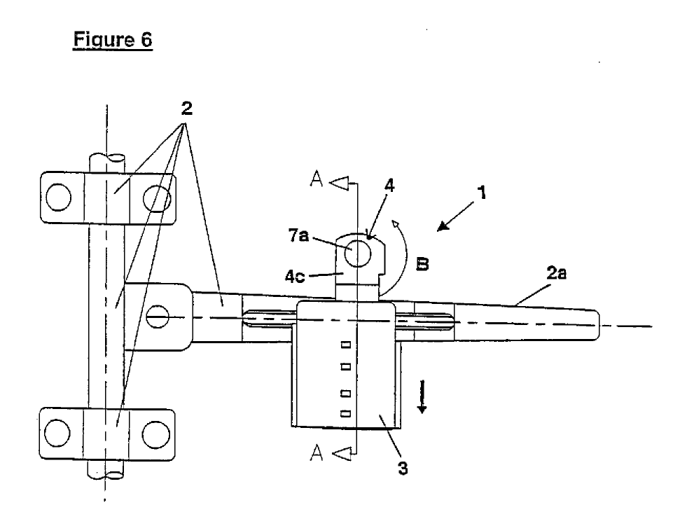

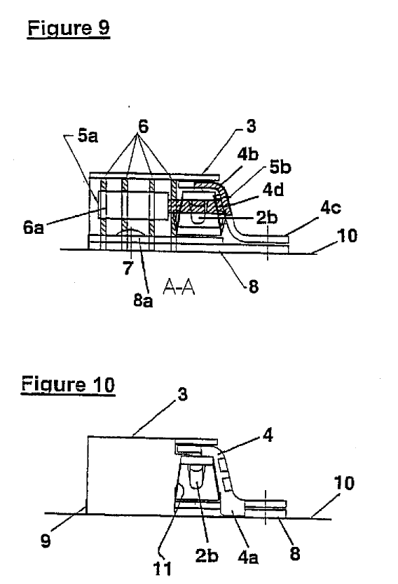

It should be appreciated that the present invention lends itself to more than one application. Hence, the invention may be adapted through a change to one or more, or a combination, of any location, building structural features, dimensions, security compartments, locking systems, alarmed systems, and so forth. As can be appreciated a variety of different embodiments, uses, and applications of the present invention therefore exist, even within the ambit of the above described security container system. With reference to the diagrams (FIGS. 6 to 10) by way of example only, there is provided security means (generally indicated by arrow (1)) for latching apparatus (generally indicated by arrow (2)).

Whilst in this description the security means is described with reference to securing latching means of trucks or containers primarily, it should be appreciated this invention may have applications outside this field and be used for other securing latching means for areas, enclosures, buildings, farm paddocks and so forth.

FIGS. 6 to 10 illustrate one embodiment of the security means for latching apparatus. The security means 1 includes container means 3, hasp means 4 and locking means 5.

The latching apparatus in the attached figures is a lifting handle 2a and a latching receiving portion 2b, of a door latch for a truck or cargo container.

The locking means 5 is a single pin lock which includes a lock body 5a and a locking pin 5b. The locking means illustrated is a single pin key lock. Although, a single pin combination lock, a single pin key and combination lock, or other keyed or combination systems, may be used provided they are compatible with the overall concept of the single pin lock as herein described for use with the security means.

The locking pin 5b of the locking means 5 is adapted to co-operate with the hasp means 4 and at least one portion of the latching apparatus 2. The security means is characterised by access to the lock body 5a and the locking pin 5b when locked being minimised by the arrangement of the container means 3, the latching apparatus 2 and the hasp means 4.

The container means includes two opposed, spaced apart, parallel and substantially planar surfaces defining a front and a back surface 3a and 3b respectively, with at least two permanent surfaces substantially at right angles to the front and the back surfaces forming the sides 3c of the container means, and at least two additional surfaces defining a top 3d and a bottom 3e each including apertures capable of receiving portions of the locking apparatus.

The container means 3 is adapted to receive the lock body 5a and retain it in an orientation to receive the locking pin 5b. This is achieved by the inclusion of spaced apart bulkheads 6 which serve to strengthen the container means. The bulkheads 6 include apertures 6a configured to complement the shape of the lock body. In some instances the apertures may be configured to enable the lock body to only be inserted in the right way. The arrangement of each bulkhead inside the container means is substantially at right-angles to the side walls 3c of the container means and as such the bulkheads also serve as partitioning means.

Given that the locking means 5 is of the single pin variety, the container means to include apertures which enable the locking pin to enter the lock body retained inside the container means, as well as enabling the key hole or combination means to be accessed to lock and unlock the lock. The position of the apertures is therefore defined by the configuration of the lock itself.

The container means 3 is also adapted to co-operate with attachment means 7 capable of attaching the security means 1 in the vicinity of the latching apparatus 2 and attached to the structure associated with the latching means. Accordingly, the container means co-operates with an attachment bracket 8. The attachment bracket includes at least one aperture for receiving attachment means 7 to secure the attachment bracket to the structure the security means is to be used with. A coach bolt 7 is illustrated for example. The coach bolt 7 passes through the aperture 8a in the attachment bracket and secures the attachment bracket to the structure. However, to ensure the container means 3 is able to cover the heads of the coach bolt, the container means is able to slide relative to the attachment bracket. The container means is adapted to cooperate with the attachment bracket to allow this sliding movement to occur.

In the illustrated embodiment the container means 3 slides down relative to the attachment bracket 8 to expose the attachment aperture 8a. The bolt or similar is fitted through the attachment aperture and into the structure and tightened. The container means is then slid back to the original place and covers the head of the bolt. A stop means 9 on either or both the container means 3 or the attachment bracket 8 prevents the container means from sliding off the attachment bracket when the attachment bracket and co-operating container means are attached to a structure.

Where the present invention is used in relation to the latching means on a truck door or container door allowances have to be made for the structural thickness. The attachment bracket with container means may therefore be attached via use of a standard coach bolt or the like through the door structure. However, where insulated trucks are concerned the thickness of the wail and the internal materials used may limited such direct bolting. In fact, it may be necessary to include a longer bolt shaft, with a tension plate on the internal face of the door to ensure appropriate attachment of the bracket and the container means.

The attachment bracket 8 in the illustrated embodiment is substantially elongate. Therefore, two attachment means 7 are used, each located at opposite distal ends of the attachment bracket. As such, the one attachment means 7 may be inaccessible once the security means is affixed to the structure as it is preferably covered by the container means. The second attachment means 7a may be used to attach the hasp means 4 to the attachment bracket 8.

The hasp means 4 as illustrated rotates to allow for the hasp means to be moved out of the way of the latching apparatus handle 2a, to enable the latched handle to be unlatched and vice versa. In the illustrated embodiment the hasp means is rotatable. The hasp means also preferably includes a stop 4a. The stop is configured such that when the hasp means is moved to a position to restrict opening of the handle 2a of the latching means the aperture of the hasp means is substantially aligned with the portion of the lock body that receives the locking pin. Thus, this configuration improves the ease with which the locking pin is aligned with and inserted into the lock body.

The hasp means preferably includes a body portion 4b and an attachment portion 4c. The body portion includes an aperture 4d capable of receiving the locking pin 5b of the locking means therethrough. The attachment portion 4c is associated with attachment of the hasp means 4 to the attachment bracket 8 and/or the structure 10. The aperture of the hasp means is preferably designed to have minimal tolerances ensuring snug co-operation between the aperture and the locking pin. In the illustrated example, the head 5c of the locking pin 5b is configured to complement the shape of the hasp aperture 4d such that when inserted through the hasp aperture, the head of the locking pin is flush with the surface of the hasp means and provides no access to enable a hacksaw blade to reach or cut the shaft of the locking pin. The configuration of the head 5c of the locking pin is also used as an alignment means to ensure the locking pin may only enter the body of the lock in one orientation and with little allowance for lateral movement of the pin.

The hasp means 4 also includes provision for the attachment of a security seal. Whilst a security seal does not prevent attempts to tamper with the security means, it can alerts to unauthorised or incidental attempts to open the security means.

Before passing into the lock body, the shaft of the locking pin may also pass through apertures in either or both the handle of the latching means and the receiving portion of the latching means. Again the configuration of the apertures ensures a snug fit and minimises access to the shaft of the locking pin via a hacksaw blade or the like.

The front 3a and the sides 3c of the container means also extend around the hasp-pin-latch connection to minimise accessibility. The lock body is also indented in the container means to prevent protrusion of the lock from the container means which might otherwise attract attempts to damage the lock, and/or cause the lock to be vulnerable to the accumulation of road dirt in the locking mechanism thereby interfering with the functioning of the lock. Where the securing means is used on trucks or other road vehicles, the container means may also include a bottom to be push fitted, or similar, to reduce entry of road dirt into the body of the lock which may interfere with the operation of the lock. Alternatively, a cap may simply be placed over the end of the lock itself (not shown).

The body of the container means may be adapted to receive any shape of handle 2a of a latching means by virtue of cutting a different profile 11 out of the sides 3c of the container means to ensure the handle fits snugly against the receiving portion of the latching apparatus.

With reference to the present invention the security means for latching apparatus herein described has preferable application in transportation industries, such as on trucks or containers. However, the security means may be adapted for use in any situation where there is a need for security of a container, area or enclosure. A variety of different embodiments, uses, and applications of the present invention therefore exist, even within the ambit of the above described security means system.

Variations to the dimensions of the security means may also be desirable depending on the latching apparatus with which it is to be used. However, the present invention is differentiated from many existing products by virtue of its container means and attachment bracket inter-relationship, its hasp means and its locking means.

In addition, whilst not illustrated in the attached figures, given the emphasis on security, the present invention may be interconnected with a vehicle's or building's security alarm system, so in the event that the security means or the latching apparatus should be tampered with, the alarm system would be activated.

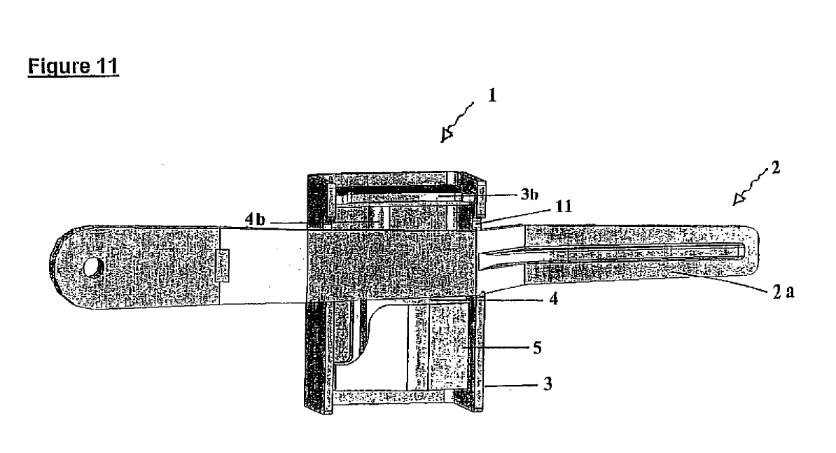

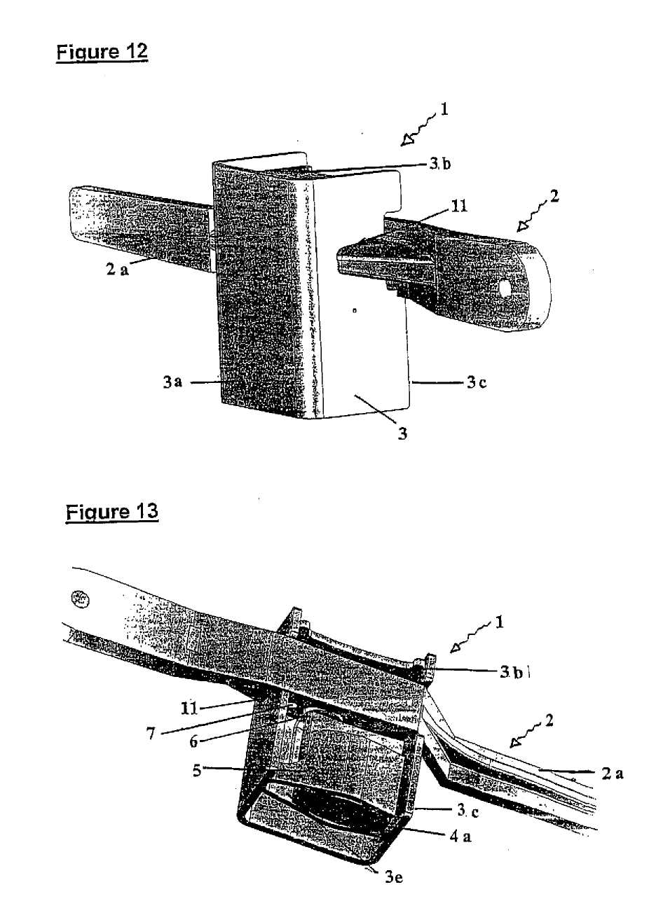

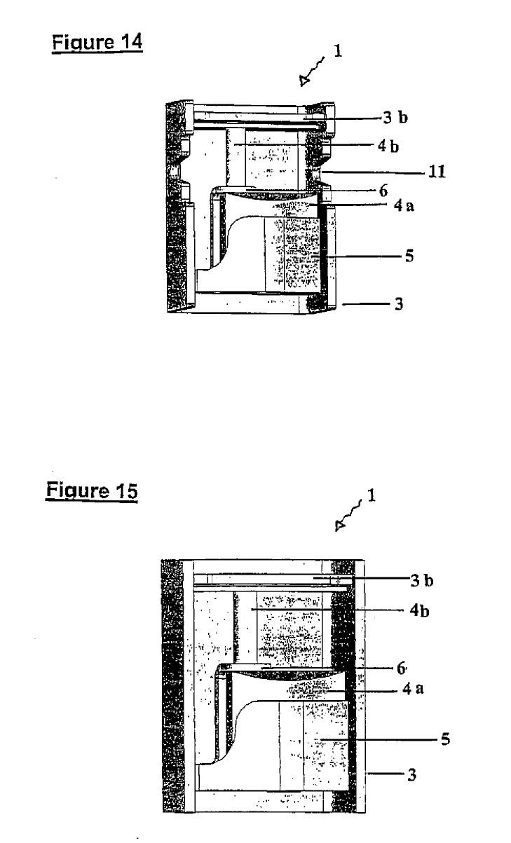

With reference to the diagrams (FIGS. 11 to 17) by way of example only, there is provided security means (generally indicated by arrow (1)) for latching apparatus (generally indicated by arrow (2)).

Whilst in this description the security means is described with reference to securing latching means of trucks or containers primarily, it should be appreciated this invention may have applications outside this field and be used for other securing latching means for areas, enclosures, buildings, farm paddocks and so forth.

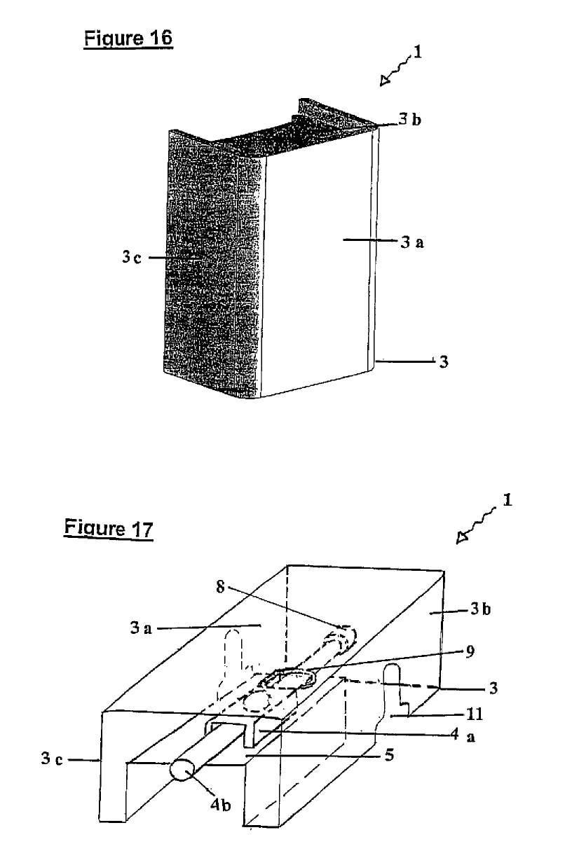

FIGS. 11 to 14 illustrate one embodiment, FIGS. 15 and 16 illustrate an alternative embodiment and FIG. 17 illustrates the use of a push bolt locking system, all of which are variations of the security means for latching apparatus. The security means 1 includes container means 3 and locking means 4, for latching means 2.

The latching apparatus in the attached figures is a lifting handle 2a of the latching receiving portion of a door latch for a truck or cargo container.

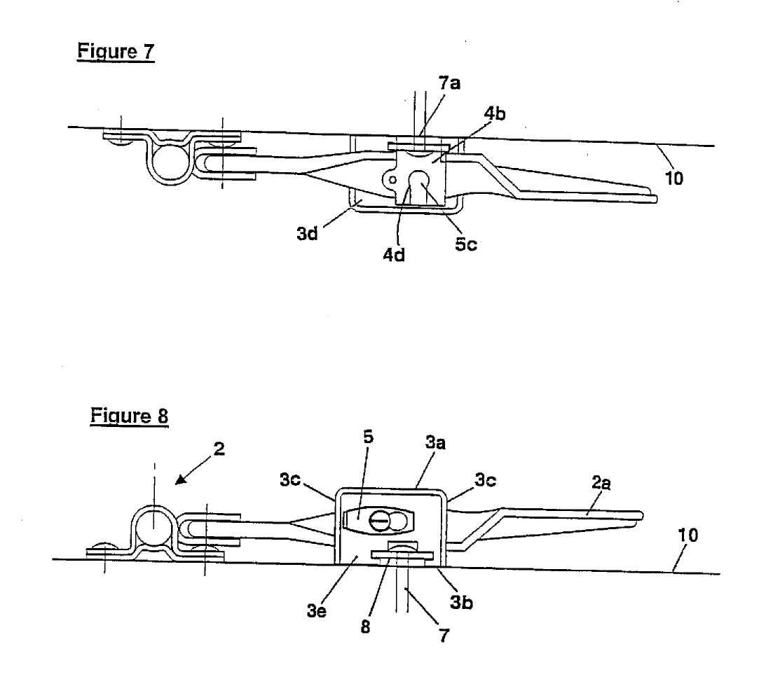

The locking means 4 is a single pin lock which includes a lock body 4a and a locking pin 4b. The locking means illustrated in FIG. 1 to 6 a single pin key lock. Although, a single pin changeable combination lock, a single pin key and changeable combination lock, or other keyed or combination systems, may be used provided they are compatible with the overall concept of the single pin lock as herein described for use with the security means. The locking means 4 of FIG. 7 is a single pin bolt lock.

The locking pin 4b of the locking means 4 is adapted to co-operate with hasp means, plate means and/or at least one portion of the latching apparatus 2. The security means is characterised by access to the lock body 4a and the locking pin 4b when locked being minimised by the arrangement of the container means 3 and the latching apparatus 2.

The container means includes planar surfaces defining a front surface 3a, with at least two permanent surfaces substantially at right angles to the front surface forming the sides 3c of the container means. At least one additional surface defines a removable lid 3b. An opening 3e provides entry to the interior of the container means for the locking apparatus.

The container means 3 is adapted to receive the lock body 4a and retain it in an orientation to receive the locking pin 4b. This is achieved by the inclusion of bulkhead 5 which serve to strengthen the container means. The bulkhead 5 is configured to complement the shape of the lock body. In some instances bulkhead may be configured to enable the lock body to only be inserted in the right way. Given that the locking means 4 is of the single pin variety, the container means also includes guide means 6 (as shown in FIGS. 13-15) which enable the locking pin to enter the lock body retained inside the container means. The position of the guide means is therefore defined by the configuration of the lock itself.

The lid of the embodiment illustrated in FIGS. 11 to 16 includes a fixed single pin attached thereto which is positioned to depend from the interior surface of the lid to be substantially aligned with the portion of the lock body that receives the locking pin. Thus, this configuration improves the ease with which the locking pin is aligned with and inserted into the lock body. The lid of FIG. 17 includes a receiving socket 8 configured to receive the bolt pin of the lock.

In some embodiments of FIG. 17 where the latching apparatus includes a single through bolt locking system there may be included one or more of a receiving socket to receive the bolt, a bolt guide means (illustrated at 9) to guide the bolt, a locking aperture to secure the bolt in a position, as falls within the ambit of the present invention. These variations may be required to accommodate embodiments where the through bolt is of variable length—from a length which reaches the lid, to a length extending a short distance from the lock body. Such variations in the length of the bolt/pin may be required to accommodate differently configured or dimensioned latching apparatus, the available space for the security means, and so forth.

The container means 3 also includes provision for the enclosure of a security seal 7 (as shown in FIG. 13)and thereby enables cheaper seal systems such as crimped wire to be used as opposed to expensive seal systems which are designed to be simply a deterrent. Whilst a security seal does not prevent attempts to tamper with the security means, it can alert to unauthorised or incidental attempts to open the security means. The container means covering the seal obviates nuisance damage to the seal.

Before passing into the lock body, the shaft of the locking pin may also pass through apertures in either or both the handle of the latching means and the receiving portion of the latching means. The configuration of the apertures ensures a snug fit and minimises access to the shaft of the locking pin via a hacksaw blade or the like.

The front 3a and the sides 3c of the container means also extend around the hasp-pin-latch connection to minimise accessibility. The lock body is also indented in the container means to prevent protrusion of the lock from the container means which might otherwise attract attempts to damage the lock, and/or cause the lock to be vulnerable to the accumulation of road dirt in the locking mechanism thereby interfering with the functioning of the lock. Where the securing means is used on trucks or other road vehicles, the container means may also include a bottom to be push fitted or similar, to reduce entry of road dirt into the body of the lock which may interfere with the operation of the lock. Alternatively, a cap may simply be placed over the end of the lock itself (not shown).

The body of the container means may be adapted to receive any shape of handle 2a of a latching means by virtue of cutting a different profile 11 out of the sides 3c of the container means to ensure the handle fits snugly against the receiving portion of the latching apparatus. One profile is illustrated in FIGS. 11-14, and in FIG. 17 to accommodate the shape of the particular handle of the latching apparatus. However, FIGS. 15 and 16 doe not include a profile cut out of the sides of the container means. This embodiment of the present invention is adapted to be used over for example, hasp and staple, bolt, chained, or bracket and plate latching systems.

With reference to the present invention the security means for latching apparatus herein described has preferable application in transportation industries, such as on trucks or containers. However, the security means may be adapted for use in any situation where there is a need for security of a container, area or enclosure. A variety of different embodiments, uses, and applications of the present invention therefore exist, even within the ambit of the above described security means system. Whilst some of these have been described herein, the descriptions are merely examples and do not form the definitive or only options available. Accordingly, it is envisaged a range of variations to the security means is possible, within the ambit of the present application. For example, variations to the dimensions of the security means may be desirable depending on the latching apparatus with which it is to be used.

However, the present invention is differentiated from many existing security means by virtue of its container means, its attachment bracket inter-relationship, its ability to be used in a variety of applications and in its locking means.

In addition, whilst not illustrated in the attached figures, given the emphasis on security, the present invention may, in some applications, be interconnected with an area's, a vehicle's or a building's security alarm system, so in the event that the security means or the latching apparatus should be tampered with, the alarm system would be activated.

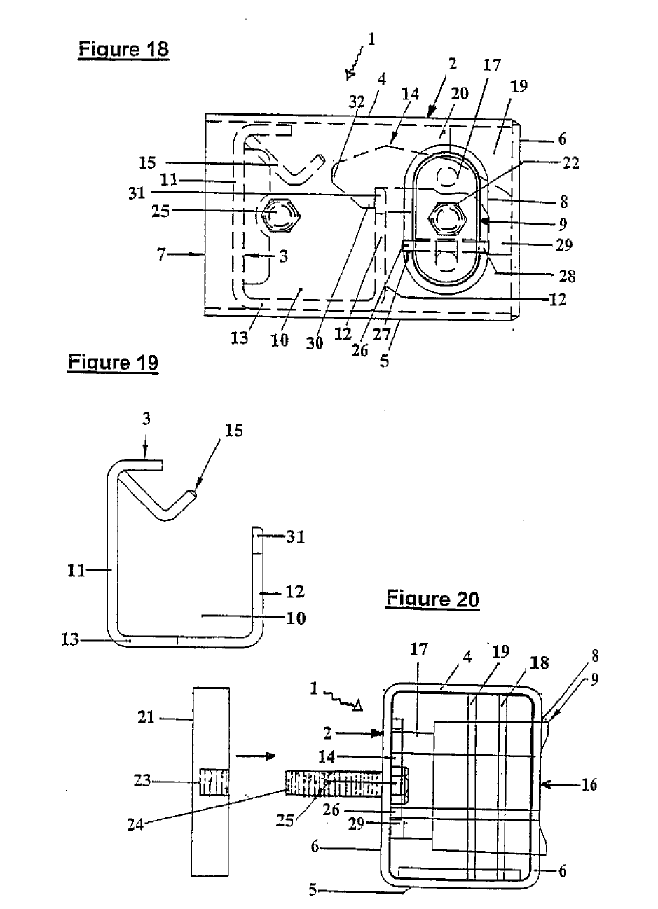

With reference to the diagrams (FIGS. 18 to 20) by way of example only, there is provided a permanently fitted security container (generally indicated by arrow (1)). Whilst in this description the permanently fitted security container is described and referenced for use with keys primarily, it should be appreciated this invention may have applications outside this field and be used for other valuables including money, access codes and so forth.

FIG. 18 illustrates one embodiment of the security container as a longitudinal cross-sectional view. The security container includes a body 2 and container means 3 for storing valuables therein. The body 2 is defined by two opposed and spaced apart parallel planar surfaces which form a top surface 4 and a bottom surface 5, and three permanent surfaces substantially at right angles to the top and bottom surfaces forming the enclosing sides 6 of the container means, and at least one exposed surface comprising an opening 7 and being configured to provide access to the interior of the container means 3. Whilst the body 2 of the preferred embodiment described herein is substantially a rectangular compartment, it should also be appreciated that the container means may take other configurations.

The embodiments as shown in FIGS. 18 to 20 illustrate two openings in the body 2. One 7, allows entry into the body 2 of the container means 3. The second 8, allows entry of the locking means 9. It should be appreciated that in other embodiments there may be more than two openings as may be required to enable access to the contents of the security container 1.

The container means is illustrated as a side view in FIG. 19 as substantially a slidable drawer 3. The container means 3 is configured to operate between an opened orientation, as it would look in FIG. 19 and a closed orientation as shown in FIG. 18. Once the security container is installed on the vehicle, the opening 7 of the security container 1 is preferably closed by the insertion of the container means, or drawer. The container means effectively also operates as a cover/door into the security container.

The container means is configured to slide into the body through an opened end of the security container and is indented from the outer edge of the body. The drawer/door fits snugly and tightly.

Cap means (not shown) is a moulded push fit cap which fits into the indented space and covers the end of the drawer to minimise dirt and water ingress.

The slideable drawer 3 has an interior 10 for storing keys therein. The drawer has at least a front wall 11 and rear wall 12. The drawer also has a base 13. The front wall 11 is dimensioned to complement the opening 7 of the body 2 through which the drawer 3 slides. Accordingly, the front wall has a height and a width that effectively closes off the opening of the body of the security container when the drawer is closed.

The rear wall 12 is similarly dimensioned in terms of its width, to fit within the body. The height of the rear wall is however dependent on its interaction with the pivotable latching means 14 which maintains the drawer in a substantially firm and closed position when the locking means 9 of the security container is in place and locked.

The base 13 of the drawer is again of a width that approximates the interior dimensions of the body 2. Accordingly, the drawer 3 is free to slide in to the body, but snugly fits in place once inserted. The length of the base determines the distance by which the drawer extends in to the body of the security container. As the security container body also holds the locking means, the length of the drawer is such as to allow the drawer to substantially abut the area where the locking means 9 is located.

As the security container is preferably configured to be used for the temporary storage of objects such as keys, the interior face of the front wall 11 of the drawer may include a hook 15 or similar system onto which a key or set of keys may be hung. Having the keys so placed means that they are more readily accessible when the drawer is opened.

Locking means 9 is included to secure the security container 18. The preferred locking means includes a single fixed-pin combination lock 9. The combination (at 16 in FIG. 20) of the pin-combination lock is selectable and changeable to enable access to the interior of the container means and the valuables therein, only by selected authorised individuals for a preferred time duration, after which the combination to access the container can be changed.

Whilst not shown, a cover may be attached to the security container to cover that combination feature and to prevent ingress of rain and dirt into the combination tumblers. The cover would also serve to obscure the combination lock feature from being easily seen.

In the illustrated embodiment, the combination lock 9 is an independent lock located within a compartment inside the body interior. To enable the combination of the lock to be changed as required, the lock is removable from its compartment, the combination reselected and the combination lock is then returned to its compartment in the security container 1.

Firm retention of the lock to ensure the locking pin 17 of the pin-combination lock 9 can be aligned with and inserted into the complementary aperture in the combination lock itself, is achieved via alignment means between the combination lock and the body of the container to ensure the lock 9 is firmly held in position within the compartment. Two alignment means, or bulkheads, are shown in the embodiment illustrated in FIG. 4. One bulkhead 18 completely encircles the locking means 9 and serves as a guide for the locking means. A second bulkhead 19 is positioned below the first bulkhead 18 and distanced from it. The second bulkhead 19 is only a partial alignment means. It includes an entry way 20 to allow an individual to position a finger on the back wall 12 of the container means 3 and push the container means to its opened position.

In addition, there is an additional guide 26 means fitted to the lock 9 which slides into a complementarily configured slot 27 in the two bulkheads 18 and 19. The guide means further positions the lock.

Removal of the lock is essential to the ability to open the container means. The locking means includes a bracing portion 28 which acts against an adjacent end 29 of the pivotable latching means 14. When the locking means 9 is in place, the bracing portion 28 abuts the end 29 of the pivotable latching means preventing movement thereof. When the lock is removed, so is the retaining pressure on the end of the latching means and the latching means 14 is free to pivot.

By inserting a finger through the opening in the body of the security container provided when the lock has been removed, the individual can apply pressure to the rear wall 12 of the container means 3. By pushing the container means 3 in this manner the latch portion 30 of the latching means 14 which is used to hold the container means in place (when the container means has been inserted into the body) pivots upwards, releasing its containment hold on the engagement portion 31 of the rear wall 12 of the container means 3, enabling the container means 3 to slide open to access the keys or such like contained therein

When the keys are returned to the container means and/or the container means is to be closed, the container means 3 is slid back into the body where it pushes against the front end 32 of the latching means 14 and the latching means pivots up. The container means then slides in further and the latching means pivots down and the latch portion 30 latches again onto the engagement portion 31 of the rear wall 12 of the container means 3. To secure the container means, the locking means is then inserted into the body through the locking means opening. The locking means engages with the fixed pin 17 of the lock and the bracing portion 28 of the lock 9 braces against the adjacent end 29 of the pivoting latching means 14. By pushing the lock in place on the fixed single pin, the lock becomes locked, the pivoting latching means becomes fixed and the tumblers are spun to prevent access to the security container.

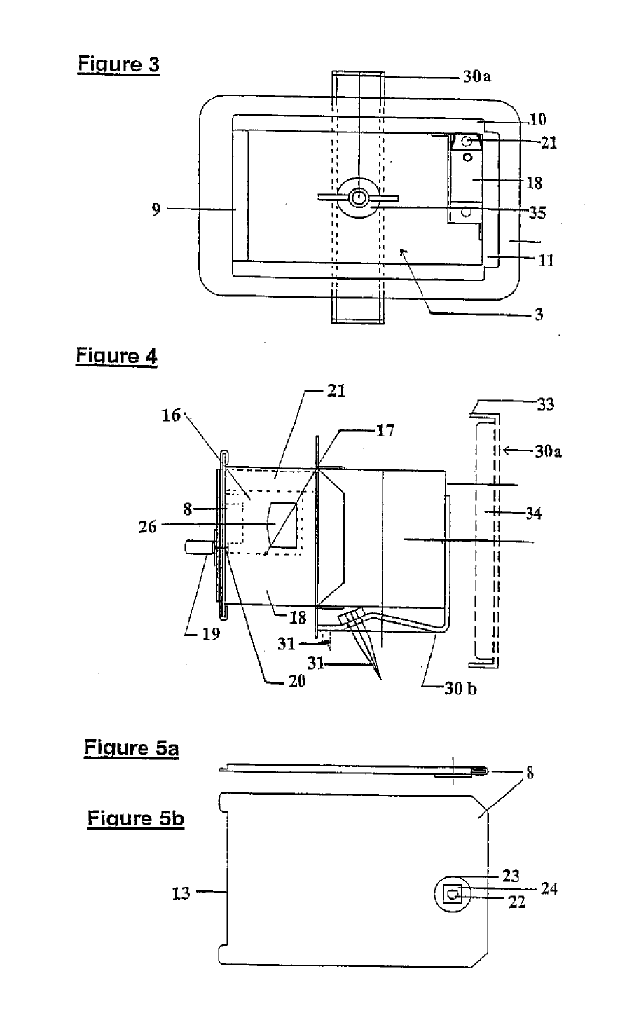

The security container has preferable application to vehicles. Accordingly, the security container further includes retention means. In turn, the retention means includes plate means 21 (shown in FIG. 3) and fixing means 22 (shown in FIG. 5b), such as screws, bolts. The plate means operate to impede forced removal of the security container from the vehicle.

At least one aperture 23 is included in the plate means through which a shaft 24 of a bolt may pass. The head 25 of the bolt is located inside the container and the thread in the aperture of the plate means is used to tighten the container against movement relative to the plate and the vehicle. The plate is fixed adjacent to the structural framework on which the plate means is positioned (not shown). This is preferred to negate the ability for free movement of the plate and the container to which it is attached and secures against attempts to pry the container from the vehicle.

As can be appreciated the dimensions of the container means is variable, but preferably dictated by the preferred placement of the security container in use. To more particularly ensure the security container complements the features of the surface into which the security container is installed, the external configuration of the security container may be designed to reflect the features of the vehicle surface.

Whilst the present invention may be differentiated from many existing products by virtue of either or both its retention means and its locking means, the method of manufacture of the security container from rectangular stainless steel sections or as a punch moulded unit also improves the strength of the container, as there are minimal or no welded joints which have the potential to weaken the structure. Further, the container is durable and weather resistant.

In addition, whilst not illustrated in the attached figures, given the emphasis on security, the present invention may be interconnected with the vehicle's security alarm system, so in the event that the security container should be tampered with, the vehicle's alarm system would be activated.

It should be appreciated that the present invention lends itself to more than one application. Hence, the invention may be adapted through a change to one or more, or a combination, of any location, vehicle structural feature, dimensions, security compartments, locking systems, alarmed systems, and so forth. As can be appreciated a variety of different embodiments, uses, and applications of the present invention therefore exist even within the ambit of the above described security container system.

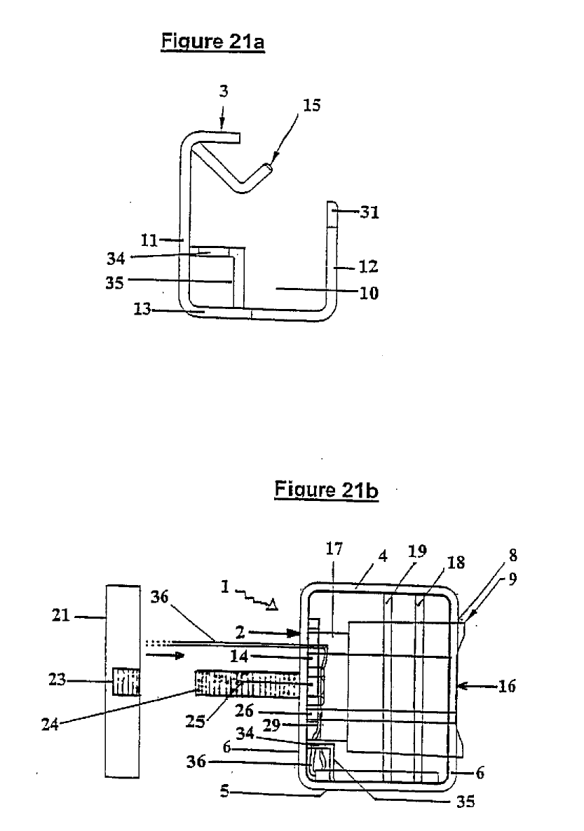

In addition, whilst not fully illustrated in FIGS. 18-21b, given the emphasis on security, the present invention may be interconnected with the vehicle's security alarm system and/or a vehicle's immobilising system and/or the vehicle's battery system, so in the event that the security container or the vehicle should be tampered with, the vehicle's alarm system would be activated, or the vehicle would not be able to be started. FIGS. 21a and b illustrate the adaptation of the security means to include at least switching means (at 34) for the alarm/immobilising system/battery on-off switch. An aperture 33 in the back plate of the drawer allows access to the switch 34 which may be mounted in relation to the bracing means, although the switch is housed in a separate bracket means 35 as in FIGS. 21a and b.

These antitheft systems may be powered using an energy source, such as batteries. The power source may be a single battery of preferred voltage, or a bank of batteries, as required. Any power supply cabling associated with the switching systems may be routed through the back of the container means so as to minimise the likelihood of the cabling being tampered with.

It should be appreciated that the present invention lends itself to more than one application. Hence, the invention may be adapted through a change to one or more, or a combination, of any location, vehicle structural feature, dimensions, security compartments, locking systems, alarmed systems, and so forth. As can be appreciated a variety of different embodiments, uses, and applications of the present invention therefore exist, even within the ambit of the above described security container system.

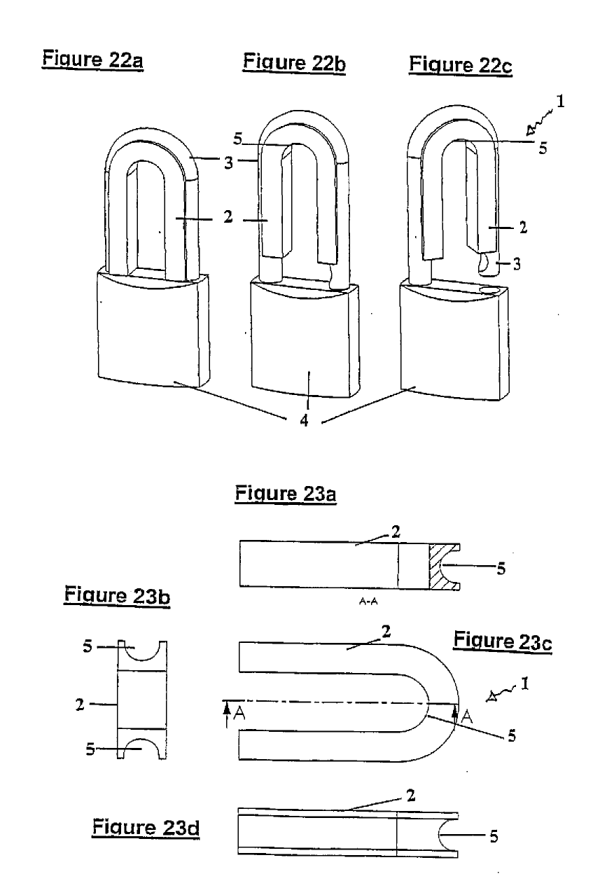

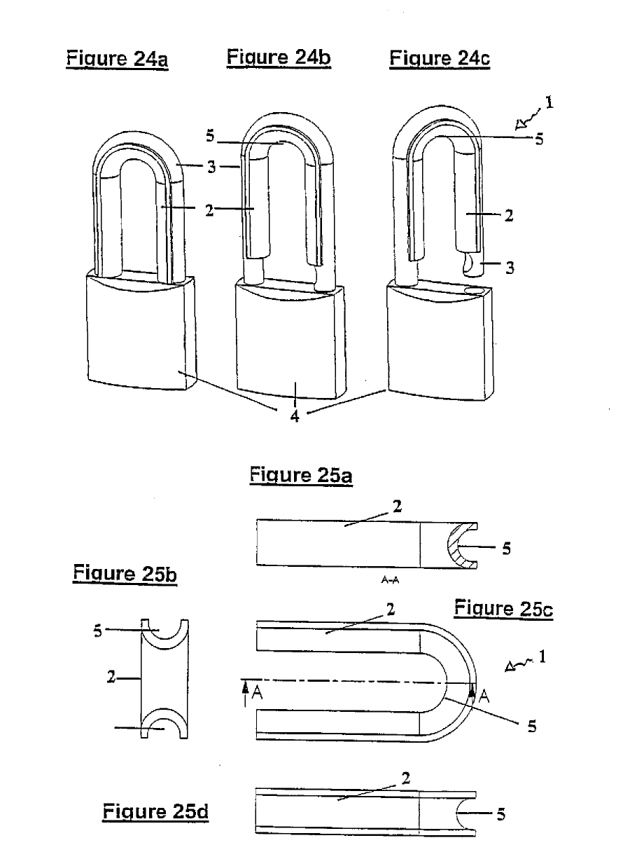

With reference to the diagrams (FIGS. 22a to 26c) by way of example only there is provided a security means (generally indicated by arrow (1)). Whilst in this description the security means is described and referenced for use with padlocks primarily, it should be appreciated this invention may have applications outside this field and be used for, or adapted for use with, other locking or retaining systems where is it desired that the strength of the locking or retaining system be enhance to prevent or minimize unauthorized tampering or access to an area or contents thereof.

FIGS. 22 and 24 illustrate only two possible embodiments of the security means. However, as may be appreciated by any person skilled in the art, variations to the design, applicability and functioning of the shackle protector are possible and should be considered within the ambit of the present application. Accordingly, the locking apparatus in these embodiments includes at least a U-bolt, a staple or the like and the security means accommodates the body of the U-bolt, staple, or the like, within it.

The security means includes a body (2). The body is adapted to accommodate a portion of the locking apparatus with which the security means is used, which in the figures is a shackle (3) or pin of a padlock (4). The security means thereby operates as a shackle protector, shield or guard providing a protective barrier limiting access to the shackle portion of the locking apparatus accommodated thereby.

In the present embodiments, the body (2) of the security means (1) is substantially U-shaped (5) in cross section as illustrated in each of the figures. In addition, in the embodiments shown, the overall shape of the shackle protector from a front view, is also U-shaped (5). The rounded U-shape of the embodiment of FIGS. 22, may be achieved using metals such as titanium, and these in turn may be thinner and lighter, yet retain the desired strength to prevent cutting of the shackle shield by bolt cutters, hacksaws, or the like. The embodiment of FIG. 24 includes a substantially squared U-shaped shackle protector. This may be a preferred embodiment where cast steel is used to produce the shackle protector. However, where the security means is adapted for use with other securing systems and different materials are used in its manufacture, the cross-sectional configuration and the other views of the security means may vary accordingly as required to accommodate the portion of the locking/affixing/retaining system with which it is used.

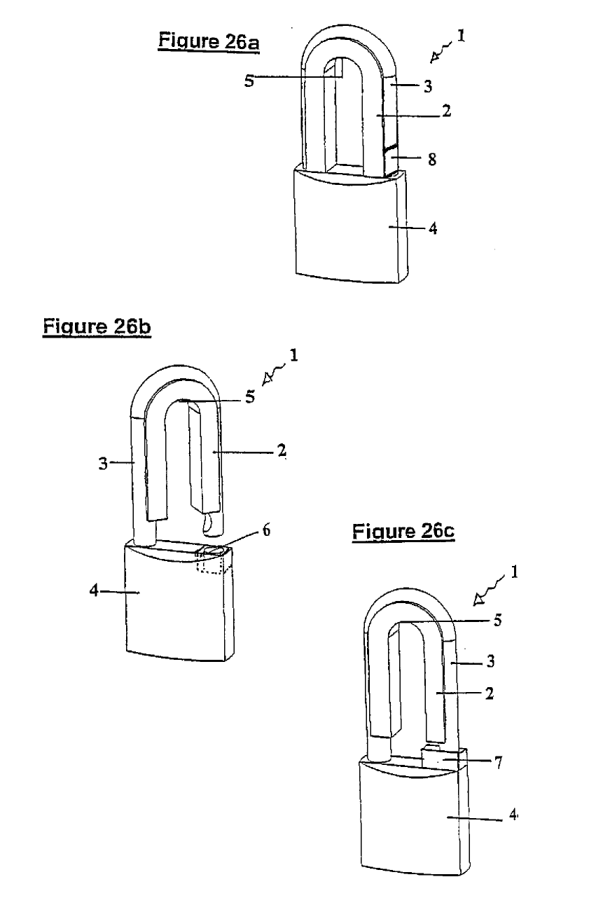

The security means may be adapted for at least partial insertion into the body of the locking apparatus or surface with which the locking apparatus is used, as shown at (6)in FIG. 26b, or the body of the locking apparatus may be adapted to accommodate a portion of the security means as shown at (7) in FIG. 26c. Both of these options may be employed to minimize further attempts at cutting the shackle of the padlock at the point of entry into the lock body.

In addition, the security means may optionally include retaining portions, or foot (8) to maintain the portion of the shackle held within the security means in a preferred position as shown in FIG. 26a. This option may also be employed to minimize further attempts at cutting the shackle of the padlock at the point of entry into the lock body, or act as a guide to feed the shackle into the padlock.

The locking apparatus is a padlock and the security means accommodates the shackle of the padlock, or a single pin padlock and the security means accommodates the single pin of the padlock (although the later option is not illustrated the concept is still applicable).

It should be appreciated that the present invention lends itself to more than one application. Hence, the invention may be adapted through a change to one or more, or a combination, of any structural feature, dimensions, security application, locking systems, and so forth. As can be appreciated a variety of different embodiments, uses, and applications of the present invention therefore exist, even within the ambit of the above described security means system.

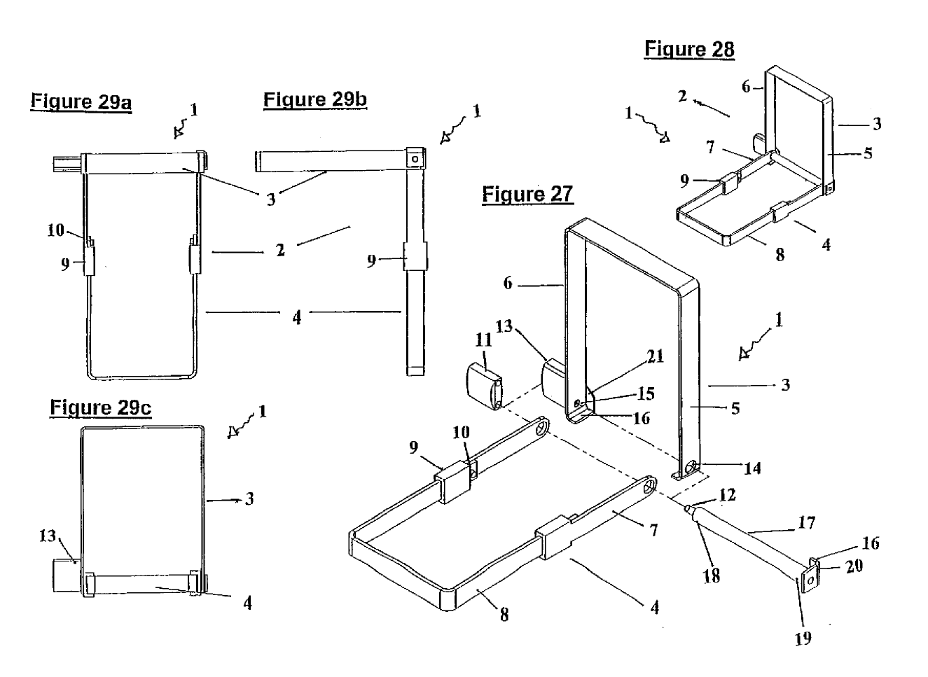

With reference to the diagrams (FIGS. 27 to 29c) by way of example only there is provided a temporarily fitted security means (generally indicated by arrow (1)) for use with vehicle wheels to immobilise the vehicle and impede unauthorised removal of the vehicle. Whilst in this description the security means is described and referenced for use with vehicles primarily, it should be appreciated this invention may have applications outside this field and be used for purposes other than for vehicles.

FIG. 27 illustrates one embodiment of the security means as an exploded perspective view. The security means includes a body (2). The body comprises several parts, including at least two bracing portions. For ease of reference, the two bracing portions shall be called a first bracing portion (3) and a second bracing portion (4).

Each bracing portion is substantially U-shaped, although the configuration of the bracing portion is not limited to only this shape. The first bracing portion (3) is configured to match the radius of the wheel with which the apparatus will be used. On installation the first bracing portion is fitted to sit over the top of the wheel and the sides of the U-shaped bracing apparatus extends down the side of the wheel to the centre of the wheel. Accordingly, there is the side member (5) which is exposed on the exterior side surface of the wheel and the side member (6) which is adjacent the interior side surface of the wheel. The first bracing portion also includes sections (16) designed to protect the point of connection of the second bracing portion to the first bracing portion. Similar protection sections (16) are also evident on the locking bar of the invention.

The second bracing portion (4) includes at least two extendable portions an inner (7) and outer (8) portion, co-operating in a telescopic arrangement as shown at (9). The inner second bracing portion is adjacent to, is attached to and co-operates with the first bracing portion.

The second bracing portion, as with the first bracing portion is configured to fit around the wheel. The second bracing portion may be adjusted to accommodate the radius of a single wheel, or be extended to accommodate the radii of two adjacent wheels. When installed in relation to the wheels, the second bracing portion is positioned in a plane substantially perpendicular to the plane of arrangement of the first bracing portion.

Either or both the inner and outer second bracing portions may include a stop means (10) configured to limit the extension of the telescopic arrangement. In addition, either or both the inner and outer second bracing portions may include adjustment means (not shown) in the form of a ratchet or other suitable means to enable the outer second bracing portion to be extended on to the distance required to accommodate the radius of a second wheel, or to adjust the second bracing portion to accommodate varyingly dimensioned wheels.

The vehicle immobilising apparatus also includes locking apparatus. The locking apparatus is preferably a single pin locking system. The single pin locking may be a single pin combination lock or a single pin keyed lock. The locking system is preferably a padlock (11) arrangement into which the single pin (12) is inserted.

Preferably, the combination lock is located within a compartment (13) allowing positioning of the combination lock. The compartment may be larger than the combination lock to enable the lock to be more easily installed and removed, or to be exchanged with a larger lock if required, or to enable a cap to be fitted to minimise ingress of water and dirt into the padlock area.

The side member of the first bracing portion, which is adjacent the interior side surface of the wheel, preferably includes the compartment or receptacle into which a padlock is able to be inserted. The receptacle may be configured to the shape of the padlock, or include insertable bulkheads (not shown) which enable different padlocks of different shapes to be used with the invention. The receptacle apart from providing a means of retaining the padlock in an appropriate alignment during insertion of the locking pin, also serves to protect the padlock from dirt, weather effects and attempts that may be made to damage the padlock, if it were otherwise exposed.

In preferred embodiments, the first bracing portion includes apertures located towards the outer distal ends of the side member of the U-shaped first bracing portion. The aperture (14) in the side member which is exposed on the exterior side surface of the wheel is proportionally larger than the aperture (I 5) in the side member which is adjacent the interior side surface of the wheel. The larger aperture on the side member adjacent the exterior side surface of the wheel enables a locking bar (17) to be inserted therethrough.

The locking bar is substantially elongate, having two distal ends. The inner distal end (18) passes through the centre of the wheel and includes an extension in the shape of a pin (12) which serves as the locking pin of the locking apparatus. The aperture (15) in the side member which is adjacent the interior side surface of the wheel is adapted to enable the locking pin extension to pass therethrough and into the padlock. The outer distal end (19) of the locking bar is configured to include a cap (20). The cap is dimensioned to be bigger than the width of the locking bar, and as such serves to provide a pressure point and grip to enable the locking bar to be inserted through the wheel and the locking pin extension pressed home into the padlock of the locking apparatus.

Further, the keyed entry or combination tumblers of the lock may be included on or indented into the cap of the locking bar.

To facilitate guiding the locking pin of the locking bar through the aperture on the side member adjacent the interior side surface of the wheel and into the padlock, the side member which is adjacent the interior side surface of the wheel also includes alignment or guide means (2 1).

The locking pin must be appropriately aligned with the lock to ensure appropriate locking of the immobilising apparatus. Lateral movement of the pin may make the alignment process less direct and may cause wear in the shaft of the pin. Accordingly, at least one alignment/guide means acts as positional guides to ensure that the pin is appropriately guided to engage with the lock.

The locking bar may also serve as a pivoting means when the immobilising apparatus is not installed on a vehicle. In this regard, the locking bar enables the first bracing portion to be folded down relative to the second bracing portion, for ease of storage and carrying.

Whilst the present invention may be differentiated from many existing products by virtue of either or both its retention means and its locking means, the method of manufacture of the security container from stainless steel sections also improves the strength of the security means and improves its durability and weather resistance.

In addition, whilst not illustrated in the Figures, given the emphasis on security, the present invention may be interconnected with a security alarm system, so in the event that the security means or the vehicle should be tampered with, the alarm system would be activated.

The potentially realisable benefits of security means are that:
a) It has the benefits of being fitted to a vehicle as required; yet
b) Can be used with any appropriate single or tandem wheeled vehicles, including cars, trailers, bikes, trucks and the like, having wheels of varying diameters; yet
c) Includes a locking system that provides a substantially tamperproof alternative to existing locking systems; and
d) Is a less cumbersome security means than some of the prior art systems of comparable strength and security; and yet
e) Can also include a locking system which enables only authorised personnel to remove the security means.

It should be appreciated that the present invention lends itself to more than one application. Hence, the invention may be adapted through a change to one or more, or a combination, of vehicle structural feature, dimensions, locking systems, alarmed systems, and so forth. As can be appreciated a variety of different embodiments, uses, and applications of the present invention therefore exist even within the ambit of the above described security container system.

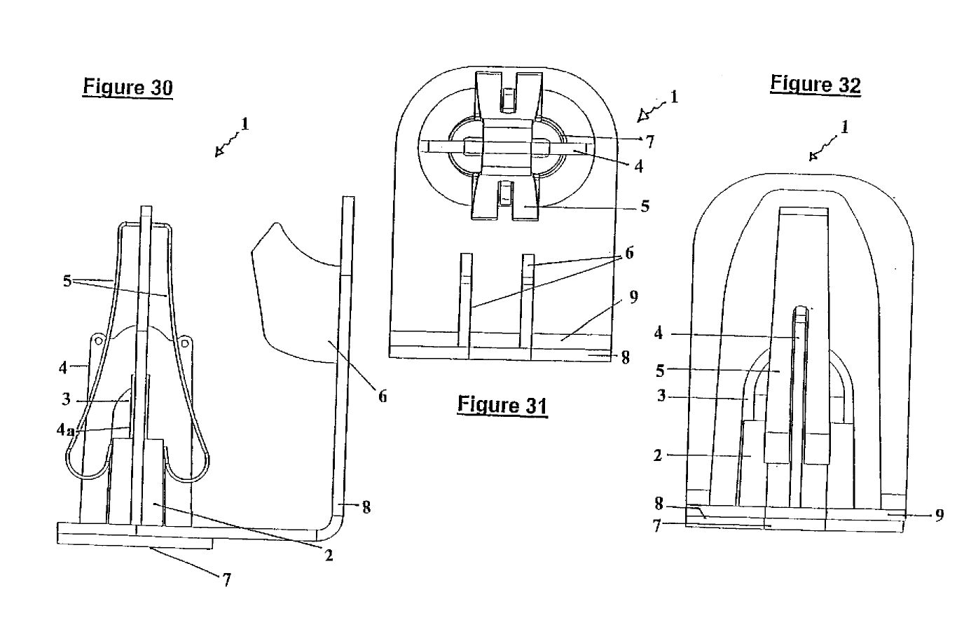

With reference to the diagrams (FIGS. 30 to 32), by way of example only, there is provided a security means (generally indicated by arrow (1)). Whilst in this description the security means is described and referenced for use with cartage containers primarily, it should be appreciated this invention may have applications outside this field and be used for securing other containers, access entry points and the like.

FIG. 30 illustrates one embodiment of the security means (1). The security means includes locking apparatus which has a body (2) and at least one locking pin (3) adapted to engage with the body.

The security means also includes frame means (4) and associated therewith bracing means (5). When inserted for locking, the padlock is enclosed by the frame of the security means. The frame of the security means also includes an engaging portion (4a) to engage with a portion of the locking apparatus, to minimize movement thereof; or ability to force the locking apparatus out of the security means when the locking apparatus is locked.

The body of the locking apparatus is also adapted to co-operate with the bracing means to splay the bracing means such that the bracing means brace against the interior of the surface with which the security means is used, to tighten the security means relative to said surface when the locking apparatus is engaged and locked.

The locking apparatus of the security means includes a padlock which is preferably a changeable combination padlock. The combination of the lock is selectable and changeable to enable release of the security means from the container, only by selected authorised individuals at a preferred time.

The present invention is described herein with reference to security means for use as an anti-theft device for cartage containers (part of container structure illustrated at 9). As such, the security means also includes a body, which has engagement means or hook means (6) adapted to co-operate with structural features of a container to block access to lifting apertures of the container. The locking means is received into a recess (7) within the body of the security means and is removable therefrom to effect release of the engagement means from the container to effect the ability to transport the container via the use of lifting apparatus.

The locking means is adapted to interact with exterior plate means (8) of the security means. The exterior plate means of the security means is typically positioned adjacent and parallel to a wall of the container and has a recessed portion around the aperture therein, to accommodate the exposed portion of the locking apparatus, yet to inset it within the external plate portion.

The bracing means of the embodiment described, includes a spring splaying system. However, any suitable system may be used with or adapted for use with the invention. For example, a cam splaying system, a disc splaying system and so forth, may be used.

In other embodiments, the security means optionally includes a securing plate (not shown), which is adapted to engage with a portion of the security means and/or an internal surface of the container. The securing plate is adapted to engage with the security means by at least one of being tapered, having a screw-threaded or bayonet-type configuration. The securing plate also includes an aperture adapted to accommodate a tool or the user's fingers to rotate the securing plate and tighten it against the portion of the security means, or internal surface of the container. After the securing plate is secured in place, the aperture is adapted to receive the lock body of the locking apparatus to secure the locking apparatus in place within the security means.

In addition, where the above description relates to the use of the security means for existing containers, it should be appreciated that security means may be customized to specific container designs and be permanently, instead of temporarily fitted. In the case of a permanently fitted option, the security means includes an internal moving portion, which essentially closes off the lifting apertures of the container when the lock is in place, yet can open when the lock is removed and thereby make the lifting apertures available. The latter embodiment obviates the need to fit the security means to the container every time it is required. Rather, as a permanently fitted option, the only requirement is the insertion of the lock body.

From the present description, and to a person skilled in the art, it should be appreciated that the present invention lends itself to more than one application. Hence, the invention may be adapted through a change to one or more, or a combination, of any structural feature, dimensions, security compartments, area entry point, alarmed systems, and so forth. As can be appreciated a variety of different embodiments, uses, and applications of the present invention therefore exist, even within the ambit of the above described security container system.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being an authoritative disclosure of the true state of the prior art but rather as referring to considerations in and brought to the mind and attention of the inventor when developing this invention.

Aspects of the present invention have been described by way of example only and it should be appreciated that modifications and additions may be made thereto without departing from the scope thereof as defined in the appended claims.

1. Security means for locking apparatus, said security means including a body, said body being adapted to accommodate a portion of the locking apparatus with which the security means is used; and said security means characterised by said body of the security means being substantially U-shaped in cross section and being substantially uniform in dimension along its length, said body being adapted to provided a protective barrier limiting access to the portion of the locking apparatus accommodated thereby, whilst allowing the protected portion to function through the full range of its operational configurations without being impeded by the security means.

2. Security means as claimed in claim 1 wherein the locking apparatus is a padlock.

3. Security means as claimed in claim 2 wherein the body of the security means is adapted to accommodate a portion of the shackle of the padlock.

4. Security means as claimed in claim 3 wherein the locking apparatus is a single pin padlock and the security means accommodates a portion of the single pin of the padlock.

5. Security means as claimed in claim 4 wherein the shackle of the padlock is substantially U-shaped in configuration and the security means accommodates a portion of the U-shaped shackle.

6. Security means as claimed in claim 1 wherein the locking apparatus includes any one of a U-bolt, a staple, and the body of the security means is adapted to accommodate a portion of the U-bolt or staple.

7. Security means as claimed in claim 1 wherein the security means is adapted for at least partial insertion into the body of the locking apparatus or a surface with which the locking apparatus is used.

8. Security means as claimed in claim 2 wherein the security means includes retaining portions to maintain the portion of the locking apparatus held within the security means in a predetermined position.

9. A method of manufacturing security means for locking apparatus, said security means including a body, said body being adapted to accommodate a portion of the locking apparatus with which the security means is used; and said security means characterised by said body of the security means being substantially U-shaped in cross section and being substantially uniform in dimension along its length, to provided a protective barrier limiting access to the portion of the locking apparatus accommodated thereby, whilst allowing the protected portion to function through the full range of its operational configurations without being impeded by the security means, said method including the steps of:
c) Casting a substantially U-shaped body of the security means, adapted to complement the shape of the portion of the locking means to be accommodated; and
d) Fitting the security means to the portion of the locking means to be accommodated.

10. A method of permanently adapting existing locking apparatus using security means as claimed in claim 1, said security means including a body, said body being adapted to accommodate a portion of the locking apparatus with which the security means is used; and said security means characterised by said body of the security means being substantially U-shaped in cross section and being substantially uniform in dimension along its length, to provided a protective barrier limiting access to the portion of the locking apparatus accommodated thereby, whilst allowing the protected portion to function through the full range of its operational configurations without being impeded by the security means, said method including the steps of:
d) Dismantling the locking apparatus; and
e) Fitting the security means to the portion of the locking apparatus to be accommodated; and
f) Reassembling the locking apparatus to retain the security means thereon.

11. A method of temporarily adapting existing locking apparatus using security means as claimed in claim 1, said security means including a body, said body being adapted to accommodate a portion of the locking apparatus with which the security means is used; and said security means characterised by said body of the security means being substantially U-shaped in cross section and being substantially uniform in dimension along its length, to provided a protective barrier limiting access to the portion of the locking apparatus accommodated thereby, whilst allowing the protected portion to function through the full range of its operational configurations without being impeded by the security means, said method including the steps of:
b) Fitting the security means to the portion of the locking apparatus to be accommodated, as and when required.
